(19) United States
(12) Patent Application Publication
(10) Pub. No.: US 2012/0106862 A1
(43) Pub. Date: May 3, 2012

(54) IMAGE PROCESSING DEVICE, METHOD, AND PROGRAM

(75) Inventor: Kazushi Sato, Kanagawa (JP)

(73) Assignee: Sony Corporation, Tokyo (JP)

(21) Appl. No.: 13/318,413

(22) PCT Filed: May 7, 2010
(86) PCT No.: PCT/JP2010/057787

§ 371 Date: Jan. 11, 2012

(30) Foreign Application Priority Data
May 15, 2009 (JP) 2009-118290

(51) Int. Cl. G06K 9/36

(52) U.S. Cl. 382/233; 382/238; 382/236

(57) ABSTRACT

The present invention relates to an image processing device, method, and program, enabling processing efficiency to be improved.

In the event that a block B1 of a sub macro block SMB0 is a block which is the object of prediction, pixel values of a decoded image are set to be used for pixel values of adjacent pixels included in an upper region U and an upper left region LU, out of templates adjacent to the block B1 of the sub macro block SMB0. On the other hand, pixel values of a prediction image are set to be used for pixel values of adjacent pixels included in left region L, out of templates adjacent to the block B1 of the sub macro block SMB0. The present invention can be applied to an image encoding device performing encoding with the H.264/AVC format, for example.

### TECHNICAL FIELD

The present invention relates to an image processing device, method, and program, and in particular relates to an image processing device, method, and program, capable of performing pipeline processing in prediction processing using an adjacent pixel.

### BACKGROUND ART

In recent years, there have come into widespread use devices which subject an image to compression encoding by employing an encoding system for handling image information as digital signals, and taking advantage of redundancy peculiar to the image information, aiming for transmission and storage of high effective information at that time, to compress the image by orthogonal transform such as discrete cosine transform or the like and motion compensation. Examples of this encoding method include MPEG (Moving Picture Experts Group) and so forth.

In particular, MPEG2 (ISO/IEC 13818-2) is defined as a general-purpose image encoding format, and is a standard encompassing both of interlaced scanning images and sequential-scanning images, and standard resolution images and high definition images. For example, MPEG2 has widely been employed now by broad range of applications for professional usage and for consumer usage. By employing the MPEG2 compression format, a code amount (bit rate) of 4 through 8 Mbps is allocated in the case of an interlaced scanning image of standard resolution having 720×480 pixels, for example. By employing the MPEG2 compression format, a code amount (bit rate) of 18 through 22 Mbps is allocated in the case of an interlaced scanning image of high resolution having 1920×1088 pixels, for example. Thus, high compression rate and excellent image quality can be realized.

With MPEG2, high image quality encoding adapted to broadcasting usage is principally taken as a object, but a lower code amount (bit rate) than the code amount of MPEG1, i.e., an encoding format having a higher compression rate is not handled. Due to personal digital assistants becoming widespread, it has been expected that needs for such an encoding format will increase from now on, and in response to this, the MPEG4 encoding format has been standardized. With regard to an image encoding format, the specification thereof was confirmed as international standard as ISO/IEC 14496-2 in December in 1998.

Further, in recent years, standardization of a standard serving as H.26L (ITU-T Q6/16 VCEG) has progressed with image encoding for television conference usage taken as an object. With H.26L, it has been known that as compared to a conventional encoding format such as MPEG2 or MPEG4, though greater computation amount is requested for encoding and decoding thereof, higher encoding efficiency is realized. Also, currently, as part of activity of MPEG4, standardization for taking advantage of a function that is not supported by H.26L with this H.26L taken as a base to realize higher encoding efficiency has been performed as Joint Model of Enhanced-Compression Video Coding. As for the schedule of standardization, H.264 and MPEG-4 Part10 (Advanced Video Coding, hereafter referred to as H.264/AVC) became an international standard in March, 2003.

Further, as an expansion thereof, standardization of FRExt (Fidelity Range Extension), which includes encoding tools necessary for operations such as RGB, 4:2:2, 4:4:4, and so forth, and MPEG-2 stipulated 8×8DCT and quantization matrices, has been completed in February of 2005. Accordingly, an encoding format capable of expressing well film noise included in movies using H.264/AVC was obtained, and is to be used in a wide range of applications such as Blu-Ray Disc (Registered Trademark).

However, as of recent, there are increased needs for even further high compression encoding, such as to compress images around 4000×2000 pixels, which is fourfold that of Hi-Vision images, or such as to distribute Hi-Vision images in an environment with limited transmission capacity, such as the Internet. Accordingly, the VCEG (=Video Coding Expert Group) under the ITU-T, described above, is continuing study relating to improved encoding efficiency.

One factor that can be given why the H.264/AVC format realizes high coding efficiency as compared to the conventional MPEG2 format or the like is intra prediction processing.

With the H.264/AVC format, there are nine types of 4×4 pixel and 8×8 pixel block-increment and four types of 16×16 pixel macro block-increment prediction modes for luminance signal intra prediction modes in the block increments, and there are four types of 8×8 pixel block-increment prediction modes for color difference signal intra prediction modes. The color difference signal intra prediction mode can be set separately from the luminance signal intra prediction mode.

Also, regarding the luminance signal 4×4 pixel and 8×8 pixel intra prediction modes, one intra prediction mode is defined for each 4×4 pixel and 8×8 pixel luminance signal block. For luminance signal 16×16 pixel intra prediction modes and color difference signal intra prediction modes, one prediction mode is defined for each macro block.

In recent years, a method for further improving the efficiency of intra prediction with the H.264/AVC format is proposed in, for example, NPL 1.

The intra template matching method will be described as the intra prediction method proposed in NPL 1, with reference to FIG. 1. In the example in FIG. 1 are shown a 4×4 pixel current block A on a current frame which is to be encoded, and a predetermined search range E configured only of pixels that have already been encoded, within the current frame.

A template region B configured of pixels that have already been encoded is adjacent to the current block A. For example, in the event of performing encoding processing in raster scan order, the template region B is a region situated to the left and upper side of the current block A, and is a region regarding which a decoded image is stored in the frame memory, as shown in FIG. 1.

With the intra template matching method, matching processing for minimizing a cost function value such as SAD (Sum of Absolute Difference) for example, is performed using the template region B, within the predetermined search range E in the current frame. As a result, a region B′ regarding which the correlation with the pixel values of the template region B is greatest is searched for, and a motion vector as to the current block A is searched with the block A′ corresponding to the searched region B′ as a prediction image for the current block A.

Thus, the motion vector searching processing according to the intra template matching method uses a decoded image for template matching processing. Accordingly, by setting a predetermined search range E beforehand, the same processing as the encoding side can be performed at the decoding side, so there is no need to send motion vector information to the decoding side. Accordingly, the efficiency of intra prediction is improved.

Now, with motion prediction compensation according to the H.264/AVC format, prediction efficiency is improved as follows.

For example, with the MEPG2 format, half-pixel precision motion prediction/compensation processing is performed by linear interpolation processing. On the other hand, with the H.264/AVC format, quarter-pixel precision motion prediction/compensation processing using a 6-tap FIR (Finite Impulse Response Filter) filter is performed.

Also, with the MEPG2 format, in the case of the frame motion compensation mode, motion prediction/compensation processing is performed with 16×16 pixels as an increment. In the case of field motion compensation mode, motion prediction/compensation processing is performed with 16×8 pixels as an increment for each of a first field and second field.

On the other hand, with the H.264/AVC format, motion prediction/compensation processing can be performed with variable block sizes. That is to say, with the H.264/AVC format, one macro block made up of 16×16 pixels can be divided into any partition of 16×16, 16×8, 8×16, or 8×8, with each having independent motion vector information. Also, an 8×8 partition can be divided into any sub partition of 8×8, 8×4, 4×8, or 4×4, with each having independent motion vector information.

However, with the H.264/AVC format, performing the aforementioned quarter-pixel precision and variable-block motion prediction/compensation processing results in massive amounts of motion vector information being generated, which would lead to deterioration in encoding efficiency if encoded as it is.

Accordingly, it has been proposed to suppress deterioration in encoding efficiency by a method of generating prediction motion vector information for the current block which is to be encoded now, by a median operation using motion vector information of an adjacent block.

Now, even with median prediction, the percentage of motion vector information in the image compression information is not small. Accordingly, the inter template matching method described in NPL 2 has been proposed. This method is a method to search, from a decoded image, a region of the image with great correlation as to a decoded image of a template region that is part of the decoded image, as well as being adjacent to a region of the image to be encoded in a predetermined positional relation, and to perform prediction based on the predetermined positional relation with the searched region.

The inter template matching method proposed in NPL 2 will be described with reference to FIG. 2.

With the example in FIG. 2, a current frame (picture) to be encoded, and a reference frame which is referenced at the time of searching for motion vectors, are shown. Shown in the current frame are the current block A which is to be encoded, and a template region B which is adjacent to the current block A and which is made up of pixels that have already been encoded. For example, in the event of performing encoding processing in raster scan order, the template region B is a region situated to the left and upper side of the current block A, and is a region regarding which a decoded image is stored in the frame memory.

With the inter template matching method, template matching processing with a SAD or the like for example as a cost function value is performed within a predetermined search range E in the current frame, and a region B′ regarding which the correlation with the pixel values of the template region B is greatest is searched for. The block A′ corresponding to the searched region B′ is taken as a prediction image for the current block A, and a motion vector P as to the current block A is searched for.

With this inter template matching method, a decoded image is used for matching, so by setting the search range beforehand, the same processing as the encoding side can be performed at the decoding side. That is to say, by performing the same prediction/compensation processing such as described above at the decoding side as well, there is no need to hold motion vector information in the image compression information from the encoding side, so deterioration in encoding efficiency can be suppressed.

Now, the macro block size is defined as 16 pixels×16 pixels with the H.264-AVC format as well, but a macro block size of 16×16 pixels is not optimal for a large image frame such as with UHD (Ultra High Definition; 4000 pixels×2000 pixels) which is the object of next-generation encoding formats.

Accordingly, it is proposed in NPL 3 and so forth to make the macro block size to be 32 pixels×32 pixels, for example.

### CITATION LIST

### Non Patent Literature

NPL 1: “Intra Prediction by Template Matching”, T. K. Tan et al, ICIP2006
NPL 2: “Inter Frame Coding with Template Matching Averaging”, Y. Suzuki et al, ICIP2007
NPL 3: “Video Coding Using Extended Block Sizes”, Study Group 16 Contribution 123, ITU, January 2009

### SUMMARY OF INVENTION

### Technical Problem

Now, let us consider a case of performing processing in 4×4 pixel block increments in intra or inter template matching prediction processing, with reference to FIG. 3.

With the example in FIG. 3, a 16×16 pixel macro block is shown, with a sub macro block configured of 8×8 pixels shown situated at the upper left of the macro block within the macro block. This sub macro block is configured of an upper left block 0, an upper right block 1, a lower left block 2, and a lower right block 3, each configured of 4×4 pixels.

In the event of performing template matching prediction processing at block 1 for example, the pixel values of the pixels included in an upper left and upper template region P1 adjacent to the block 1 at the upper left and above, and in a left template region P2 adjacent to the left, are necessary.

Note, the pixels included in the upper left and upper template region P1 have already been obtained as a decoded image, but in order to obtain the pixel values of the pixels included in the left template region P2, a decoded image as to the block 0 is necessary.

That is to say, it has been difficult to start processing as to block 1 until the template matching prediction processing, differential processing, orthogonal transform processing, quantization processing, inverse quantization processing, inverse orthogonal transform processing, and so forth, of the block 0 ends. Accordingly, with the conventional template matching prediction processing performing pipeline processing at block 0 and block 1 has been difficult.

This holds true for not only template matching prediction processing, but also intra prediction processing in the H.264/AVC format which is prediction processing using adjacent pixels in the same way.

The present invention has been made in light of this situation, and enables pipeline processing to be performed in prediction processing using adjacent pixels.

### Solution to Problem

An image processing device according to an aspect of the present invention includes: prediction means configured to perform prediction of a block, using adjacent pixels adjacent to the block making up a predetermined block of an image; and adjacent pixel setting means configured to, in the event that the adjacent pixels belong within the predetermined block, set a prediction image of the adjacent pixels as the adjacent pixels to be used for the prediction.

In the event that the adjacent pixels exist outside of the predetermined block, the adjacent pixel setting means may set a decoded image of the adjacent pixels as the adjacent pixels to be used for the prediction.

In the event that the position of the block is at the upper left position within the predetermined block, of the adjacent pixels, a decoded image of all of adjacent pixels to the upper left portion, adjacent pixels above, and adjacent pixels to left, which exist outside of the predetermined block, may be set as the adjacent pixels to be used for the prediction.

In the event that the position of the block is at the upper right position within the predetermined block, of the adjacent pixels, a decoded image of adjacent pixels to the upper left and adjacent pixels above that exist outside of the predetermined block, is set as the adjacent pixels to be used for the prediction, and of the adjacent pixels, a prediction image of adjacent pixels to the left that belong within the predetermined block, may be set as the adjacent pixels to be used for the prediction.

In the event that the position of the block is at the lower left position within the predetermined block, of the adjacent pixels, a decoded image of adjacent pixels to the upper left and adjacent pixels to the left that exist outside of the predetermined block, is set as the adjacent pixels to be used for the prediction, and of the adjacent pixels, a prediction image of adjacent pixels above that belong within the predetermined block, may be set as the adjacent pixels to be used for the prediction.

In the event that the position of the block is at the lower right position within the predetermined block, of the adjacent pixels, a prediction image of all of adjacent pixels to the upper left portion, adjacent pixels above, and adjacent pixels to the left portion, which belong within the predetermined block, may be set as the adjacent pixels to be used for the prediction.

In the predetermined block configured of two of the blocks above and below, in the event that the position of the block is at the upper position within the predetermined block, of the adjacent pixels, a decoded image of all of adjacent pixels to the upper left portion, adjacent pixels above, and adjacent pixels to left, which exist outside of the predetermined block, may be set as the adjacent pixels to be used for the prediction.

In the predetermined block configured of two of the blocks above and below, in the event that the position of the block is at the lower position within the predetermined block, of the adjacent pixels, a decoded image of adjacent pixels to the upper left and adjacent pixels to the left that exist outside of the predetermined block, is set as the adjacent pixels to be used for the prediction, and of the adjacent pixels, a prediction image of adjacent pixels above that belong within the predetermined block, may be set as the adjacent pixels to be used for the prediction.

In the predetermined block configured of two of the blocks left and right, in the event that the position of the block is at the left position within the predetermined block, a decoded image of all of adjacent pixels to the upper left portion, adjacent pixels above, and adjacent pixels to left, which exist outside of the predetermined block, may be set as the adjacent pixels to be used for the prediction.

In the predetermined block configured of two of the blocks left and right, in the event that the position of the block is at the right position within the predetermined block, of the adjacent pixels, a decoded image of adjacent pixels to the upper left and adjacent pixels above that exist outside of the predetermined block, is set as the adjacent pixels to be used for the prediction, and of the adjacent pixels, a prediction image of adjacent pixels to the left that belong within the predetermined block, may be set as the adjacent pixels to be used for the prediction.

The prediction means may use the adjacent pixels as a template to perform the prediction regarding the block by matching of the template.

The prediction means may use the adjacent pixels as a template to perform the prediction regarding color difference signals of the block as well, by matching of the template.

The prediction means may use the adjacent pixels to perform intra prediction as the prediction as to the block.

The image processing device may further include decoding means configured to decode an image of a block which is encoded; wherein the decoding means decode an image of a block including a prediction image of the adjacent pixels, while the prediction means perform prediction processing of the predetermined book using a prediction image of the adjacent pixels.

An image processing method according to an aspect of the present invention includes the steps of: an image processing device which performs prediction of a block, using adjacent pixels adjacent to the block making up a predetermined block of an image, performing processing so as to, in the event that the adjacent pixels exist within of the predetermined block, set a prediction image of the adjacent pixels as the adjacent pixels to be used for the prediction; and performing prediction of the block using the adjacent pixels that have been set.

A program according to an aspect of the present invention includes causes a computer of an image processing device which performs prediction of a block, using adjacent pixels adjacent to the block making up a predetermined block of an image, to execute processing comprising the steps of: setting, in the event that the adjacent pixels exist within of the predetermined block, a prediction image of the adjacent pixels as the adjacent pixels to be used for the prediction; and performing prediction of the block using the adjacent pixels that have been set.

According to an aspect of the present invention, prediction of a block, image processing device which performs prediction of a block, using adjacent pixels, performing processing so as to, in the event that adjacent pixels adjacent to a block block making up an encoded predetermined block of an image belong within the predetermined block, a prediction image of the adjacent pixels is set as the adjacent pixels to be used for the prediction. Prediction of the block is performed using the adjacent pixels that have been set.

Note that each of the above-described image processing devices may be independent devices, or may be internal blocks making up a single image encoding device or image decoding device.

### Advantageous Effects of Invention

According to an aspect of the present invention, an image can be decoded. Also, according to an aspect of the present invention, pipeline processing can be performed with prediction processing using adjacent pixels.

### BRIEF DESCRIPTION OF DRAWINGS

FIG. 1 is a diagram describing the intra template matching method.

FIG. 2 is a diagram describing the inter template matching method.

FIG. 3 is a diagram describing a conventional template.

FIG. 4 is a block diagram illustrating the configuration of an embodiment of an image encoding device to which the present invention has been applied.

FIG. 5 is a diagram for describing variable block size motion prediction and compensation processing.

FIG. 6 is a diagram for describing motion prediction and compensation processing with ¼ pixel precision.

FIG. 7 is a diagram for describing a motion prediction and compensation method of multi-reference frames.

FIG. 8 is a diagram for describing an example of a motion vector information generating method.

FIG. 9 is a block diagram illustrating a detailed configuration example of a intra template motion prediction/compensation unit.

FIG. 10 is a diagram illustrating a template used for prediction of a current block.

FIG. 11 is a diagram illustrating examples of current blocks in a macro block configured of 2×2 blocks.

FIG. 12 is a diagram illustrating examples of current blocks in a macro block configured of two blocks, upper and lower.

FIG. 13 is a diagram illustrating examples of current blocks in a macro block configured of two blocks, left and right.

FIG. 14 is a flowchart for describing the encoding processing of the image encoding device in FIG. 2.

FIG. 15 is a flowchart for describing the prediction processing in step S21 in FIG. 14.

FIG. 16 is a diagram for describing processing sequence in the event of a 16×16-pixel intra prediction mode.

FIG. 17 is a diagram illustrating the kinds of 4×4-pixel intra prediction modes for luminance signals.

FIG. 18 is a diagram illustrating the kinds of 4×4-pixel intra prediction modes for luminance signals.

FIG. 19 is a diagram for describing the direction of 4×4-pixel intra prediction.

FIG. 20 is a diagram for describing 4×4-pixel intra prediction.

FIG. 21 is a diagram for describing encoding of the 4×4-pixel intra prediction modes for luminance signals.

FIG. 22 is a diagram illustrating the kinds of 8×8-pixel intra prediction modes for luminance signals.

FIG. 23 is a diagram illustrating the kinds of 8×8-pixel intra prediction modes for luminance signals.

FIG. 24 is a diagram illustrating the kinds of 16×16-pixel intra prediction modes for luminance signals.

FIG. 25 is a diagram illustrating the kinds of 16×16-pixel intra prediction modes for luminance signals.

FIG. 26 is a diagram for describing 16×16-pixel intra prediction.

FIG. 27 is a diagram illustrating the kinds of intra prediction modes for color difference signals.

FIG. 28 is a flowchart for describing the intra prediction processing in step S31 in FIG. 15.

FIG. 29 is a flowchart for describing the inter motion prediction processing in step S32 in FIG. 15.

FIG. 30 is a flowchart for describing the intra template motion prediction processing in step S33 in FIG. 15.

FIG. 31 is a flowchart for describing the inter template motion prediction processing in step S35 in FIG. 15.

FIG. 32 is a flowchart for describing the template pixel setting processing in step S61 in FIG. 30 or in step S71 in FIG. 31.

FIG. 33 is a diagram for describing the advantages of template pixel setting.

FIG. 34 is a block diagram illustrating the configuration example of an embodiment of an image decoding device to which the present invention has been applied.

FIG. 35 is a flowchart for describing the decoding processing of the image decoding device in FIG. 34.

FIG. 36 is a flowchart for describing the prediction processing in step S138 in FIG. 35.

FIG. 37 is a block diagram illustrating the configuration of another embodiment of an image encoding device to which the present invention has been applied.

FIG. 38 is a block diagram illustrating a detailed configuration example of an intra prediction unit.

FIG. 39 is a flowchart for describing another example of prediction processing in step S21 in FIG. 14.

FIG. 40 is a flowchart for describing the intra prediction processing in step S201 in FIG. 39.

FIG. 41 is a block diagram illustrating the configuration example of another embodiment of an image decoding device to which the present invention has been applied.

FIG. 42 is a flowchart for describing another example of the prediction processing in step S138 in FIG. 35.

FIG. 43 is a block diagram illustrating a configuration example of the hardware of a computer.

### DESCRIPTION OF EMBODIMENTS

Embodiments of the present invention will now be described with reference to the drawings. Note that description will be made in the following order.

1. First Embodiment (adjacent pixel setting: example of template matching prediction)
2. Second Embodiment (adjacent pixel setting: example of intra prediction)

### 1. First Embodiment

### [Configuration Example of Image Encoding Device]

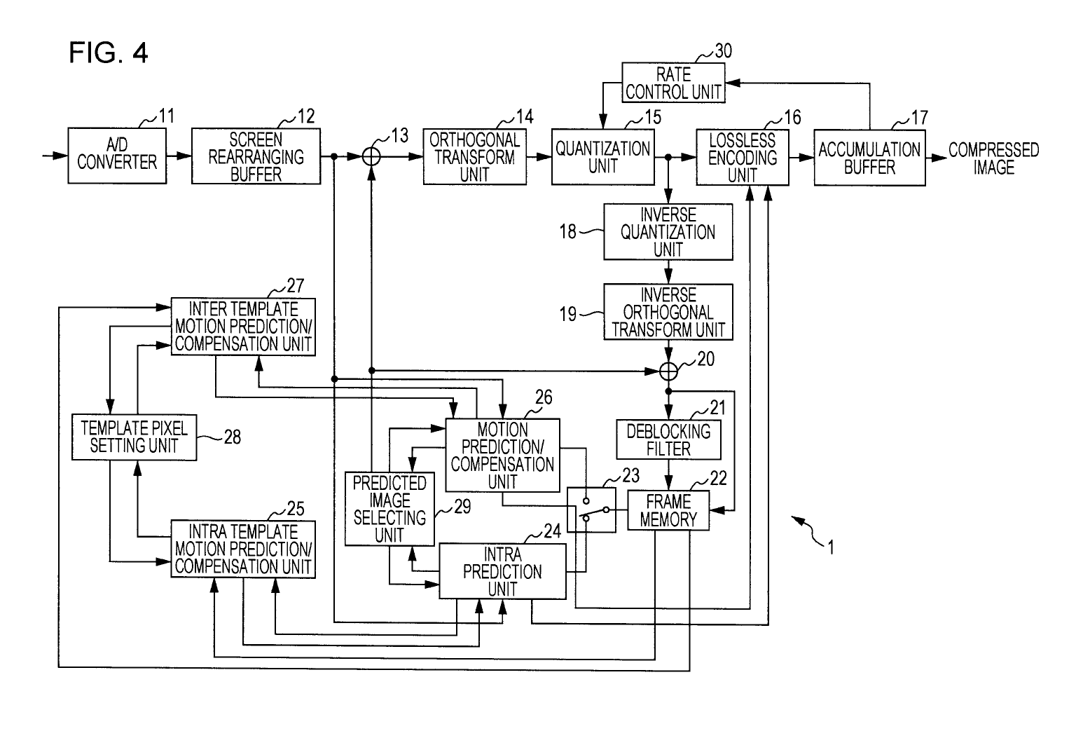

FIG. 4 illustrates the configuration of an embodiment of an image encoding device serving as an image processing device to which the present invention has been applied.

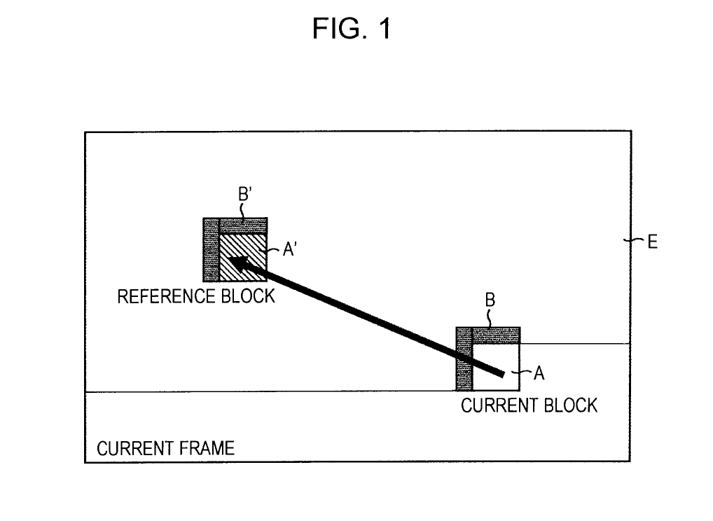

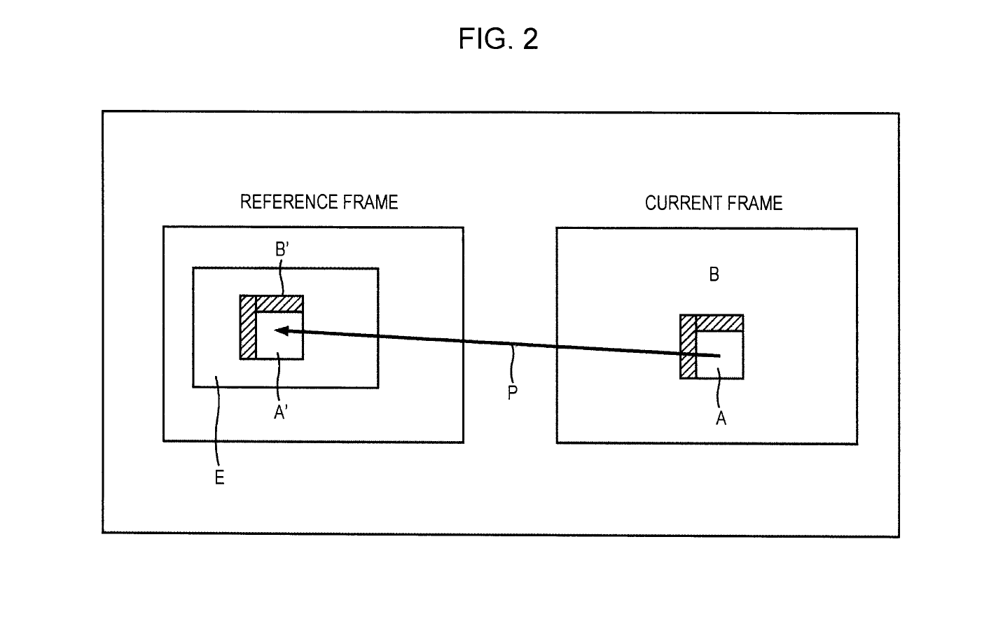

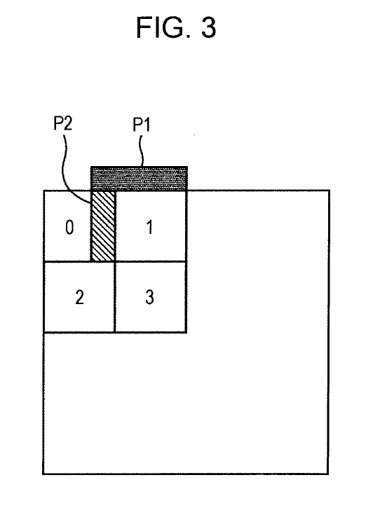

The image encoding device 1 performs compression encoding of images with H.264 and MPEG-4 Part 10 (Advanced Video Coding) (hereinafter written as H.264/AVC) format, unless stated otherwise in particular. That is to say, in actual practice, with the image encoding device 1, the template matching method described above with FIG. 1 or FIG. 2 is also used, so image compression-encoding is performed with the H.264/AVC format for other than the template matching method.

In the example in FIG. 4, the image encoding device 1 includes an A/D converter 11, a screen rearranging buffer 12, a computing unit 13, an orthogonal transform unit 14, a quantization unit 15, a lossless encoding unit 16, a storage buffer 17, an inverse quantization unit 18, an inverse orthogonal transform unit 19, a computing unit 20, a deblocking filter 21, a frame memory 22, a switch 23, an intra prediction unit 24, an intra template motion prediction/compensation unit 25, a motion prediction/compensation unit 26, an intra template motion prediction/compensation unit 27, a template pixel setting unit 28, a predicted image selecting unit 29, and a rate control unit 30.

Note that in the following, the intra template motion prediction/compensation unit 25 and the intra template motion prediction/compensation unit 27 will each be called intra TP motion prediction/compensation unit 25 and inter TP motion prediction/compensation unit 27.

The A/D converter 11 performs A/D conversion of input images, and outputs to the screen rearranging buffer 12 so as to be stored. The screen rearranging buffer 12 rearranges the images of frames which are in the order of display stored, in the order of frames for encoding in accordance with the GOP (Group of Picture).

The computing unit 13 subtracts a predicted image from the intra prediction unit 24 or a predicted image from the motion prediction/compensation unit 26, selected by the predicted image selecting unit 29, from the image read out from the screen rearranging buffer 12, and outputs the difference information thereof to the orthogonal transform unit 14. The orthogonal transform unit 14 performs orthogonal transform such as disperse cosine transform, Karhunen-Loève transform, or the like, on the difference information from the computing unit 13, and outputs transform coefficients thereof. The quantization unit 15 quantizes the transform coefficients which the orthogonal transform unit 14 outputs.

The quantized transform coefficients which are output from the quantization unit 15 are input to the lossless encoding unit 16 where they are subjected to lossless encoding such as variable-length encoding, arithmetic encoding, or the like, and compressed.

The lossless encoding unit 16 obtains information indicating intra prediction and intra template prediction from the intra prediction unit 24, and obtains information indicating inter prediction and inter template prediction from the motion prediction/compensation unit 26. Note that the information indicating intra prediction and intra template prediction will also be called intra prediction mode information and intra template prediction mode information hereinafter. Also, the information indicating inter prediction and inter template prediction will also be called inter prediction mode information and inter template prediction mode information hereinafter.

The lossless encoding unit 16 encodes the quantized transform coefficients, and also encodes information indicating intra prediction and intra template prediction, information indicating inter prediction and inter template prediction and so forth, and makes this to be part of header information of the compressed image. The lossless encoding unit 16 supplies the encoded data to the storage buffer 17 so as to be stored.

For example, with the lossless encoding unit 16, lossless encoding processing such as variable-length encoding or arithmetic encoding or the like is performed. Examples of variable length encoding include CAVLC (Context-Adaptive Variable Length Coding) stipulated by the H.264/AVC format, and so forth. Examples of arithmetic encoding include CABAC (Context-Adaptive Binary Arithmetic Coding) and so forth.

The storage buffer 17 outputs the data supplied from the lossless encoding unit 16 to a downstream unshown recording device or transfer path or the like, for example, as a compressed image encoded by the H.264/AVC format.

Also, the quantized transform coefficients output from the quantization unit 15 are also input to the inverse quantization unit 18 and inverse-quantized, and subjected to inverse orthogonal transform at the inverse orthogonal transform unit 19. The output that has been subjected to inverse orthogonal transform is added with a predicted image supplied from the predicted image selecting unit 29 by the computing unit 20, and becomes a locally-decoded image. The deblocking filter 21 removes block noise in the decoded image, which is then supplied to the frame memory 22, and stored. The frame memory 22 also receives supply of the image before the deblocking filter processing by the deblocking filter 21, which is stored.

The switch 23 outputs a reference image stored in the frame memory 22 to the motion prediction/compensation unit 26 or the intra prediction unit 24.

With the image encoding device 1, for example, an I picture, B pictures, and P pictures, from the screen rearranging buffer 12, are supplied to the intra prediction unit 24 as images for intra prediction (also called intra processing). Also, B pictures and P pictures read out from the screen rearranging buffer 12 are supplied to the motion prediction/compensation unit 26 as images for inter prediction (also called inter processing).

The intra prediction unit 24 performs intra prediction processing for all candidate intra prediction modes, based on images for intra prediction read out from the screen rearranging buffer 12 and the reference image supplied from the frame memory 22, and generates a predicted image. Also, the intra prediction unit 24 supplies the image for intra prediction read out from the screen rearranging buffer 12 and the information (Address) of the block for prediction, to the intra TP motion prediction/compensation unit 25.

The intra prediction unit 24 calculates a cost function value for all candidate intra prediction modes. The intra prediction unit 24 determines the prediction mode which gives the smallest value of the calculated cost function values and the cost function values for the intra template prediction modes calculated by the intra TP motion prediction/compensation unit 25, to be an optimal intra prediction mode.

The intra prediction unit 24 supplies the predicted image generated in the optimal intra prediction mode and the cost function value thereof to the predicted image selecting unit 29. In the event that the predicted image generated in the optimal intra prediction mode is selected by the predicted image selecting unit 29, the intra prediction unit 24 supplies information relating to the optimal intra prediction mode (intra prediction mode information or intra template prediction mode information) to the lossless encoding unit 16. The lossless encoding unit 16 encodes this information so as to be a part of the header information in the compressed image.

The intra TP motion prediction/compensation unit 25 is input with the image for intra prediction from the intra prediction unit 24 and the address of the current block. The intra TP motion prediction/compensation unit 25 calculates the address of adjacent pixels adjacent to the current block to be used as a template from the address of the current block, and supplies this information to the template pixel setting unit 28.

The intra TP motion prediction/compensation unit 25 uses the reference image in the frame memory 22 to perform motion prediction and compensation processing in the intra template prediction mode, using these images, and generates a predicted image. At this time, a template configured of adjacent pixels set by the template pixel setting unit 28 in one of the decoded image or prediction image is used at the intra TP motion prediction/compensation unit 25. The intra TP motion prediction/compensation unit 25 then calculates a cost function value for the intra template prediction mode, and supplies the calculated cost function value and predicted image to the intra prediction unit 24.

The motion prediction/compensation unit 26 performs motion prediction and compensation processing for all candidate inter prediction modes. That is to say, the motion prediction/compensation unit 26 is supplied with the images for intra processing read out from the screen rearranging buffer 12 and the reference image supplied from the frame memory 22 via the switch 23. Based on the images for intra processing and reference image, the inter TP motion prediction/compensation unit 26 detects motion vectors for all candidate inter prediction modes, subjects the reference image to compensation processing based on the motion vectors, and generates a predicted image. Also, the motion prediction/compensation unit 26 supplies the images for intra processing read out from the screen rearranging buffer 12 and the information of a block for prediction (address) to the inter TP motion prediction/compensation unit 27.

The motion prediction/compensation unit 26 calculates cost function values for all candidate inter prediction modes. The motion prediction/compensation unit 26 determines the prediction mode which gives the smallest value of the cost function values for the inter prediction modes and the cost function values for the inter template prediction modes from the inter TP motion prediction/compensation unit 27, to be an optimal inter prediction mode.

The motion prediction/compensation unit 26 supplies the predicted image generated by the optimal inter prediction mode, and the cost function values thereof, to the predicted image selecting unit 29. In the event that the predicted image generated in the optimal inter prediction mode is selected by the predicted image selecting unit 29, information indicating the optimal inter prediction mode (inter prediction mode information or inter template prediction mode information) is output to the lossless encoding unit 16.

Note that if necessary, motion vector information, flag information, reference frame information, and so forth, are also output to the lossless encoding unit 16. The lossless encoding unit 16 subjects also the information from the motion prediction/compensation unit 26 to lossless encoding such as variable-length encoding, arithmetic encoding, or the like, and inserts this to the header portion of the compressed image.

The inter TP motion prediction/compensation unit 27 is input with the images for inter prediction from the motion prediction/compensation unit 26 and the address of the current block. The inter TP motion prediction/compensation unit 27 calculates the address of adjacent pixels adjacent to the current block to be used as a template from the address of the current block, and supplies this information to the template pixel setting unit 28.

Also, the inter TP motion prediction/compensation unit 27 performs motion prediction and compensation processing in the template prediction mode using the reference image from the frame memory 22, and generates a predicted image. At this time, the inter TP motion prediction/compensation unit 27 uses a template configured of adjacent pixels set by the template pixel setting unit 28 in one of the decoded image or prediction image. The inter TP motion prediction/compensation unit 27 then calculates cost function values for the inter template prediction modes, and supplies the calculated cost function values and predicted images to the motion prediction/compensation unit 26.

The template pixel setting unit 28 sets which of decoded pixels of the adjacent pixels or prediction pixels of the adjacent pixels are to be used as adjacent pixels of the template used for template matching prediction of the current block. Which adjacent pixels are to be used is set at the template pixel setting unit 28 depending on whether the adjacent pixels of the current block belong to a macro block (or sub macro block). Note that whether or not the adjacent pixels of the current block belong to a macro block differs depending on the position of the current block within the macro block. That is, it can be said that the template pixel setting unit 28 sets which adjacent pixels to used in accordance with the position of the current block within the macro block.

The information of the adjacent pixels of the template that has been set is supplied to the intra TP motion prediction/compensation unit 25 or inter TP motion prediction/compensation unit 27.

The predicted image selecting unit 29 determines the optimal prediction mode from the optimal intra prediction mode and optimal inter prediction mode, based on the cost function values output from the intra prediction unit 24 or motion prediction/compensation unit 26. The predicted image selecting unit 29 then selects the predicted image of the optimal prediction mode that has been determined, and supplies this to the computing units 13 and 20. At this time, the predicted image selecting unit 29 supplies the selection information of the predicted image to the intra prediction unit 24 or motion prediction/compensation unit 26.

The rate control unit 30 controls the rate of quantization operations of the quantization unit 15 so that overflow or underflow does not occur, based on the compressed images stored in the storage buffer 17.

### [Description of H.264/AVC Format]

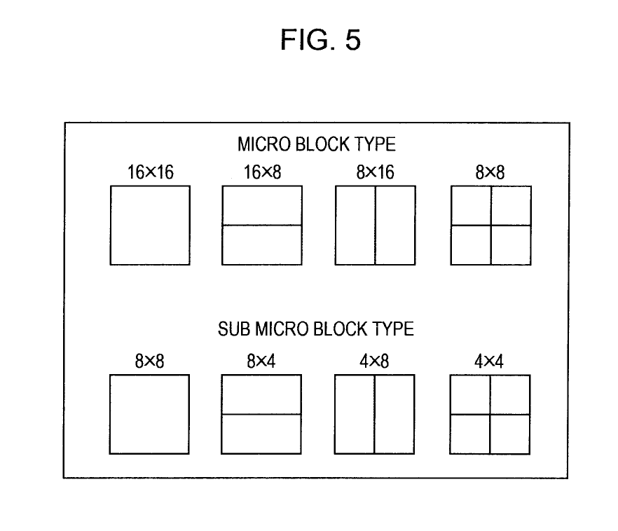

FIG. 5 is a diagram describing examples of block sizes in motion prediction/compensation according to the H.264/AVC format. With the H.264/AVC format, motion prediction/compensation processing is performed with variable block sizes.

Shown at the upper tier in FIG. 5 are macro blocks configured of 16×16 pixels divided into partitions of, from the left, 16×16 pixels, 16×8 pixels, 8×16 pixels, and 8×8 pixels, in that order. Also, shown at the lower tier in FIG. 5 are partitions configured of 8×8 pixels divided into sub partitions of, from the left, 8×8 pixels, 8×4 pixels, 4×8 pixels, and 4×4 pixels, in that order.

That is to say, with the H.264/AVC format, a macro block can be divided into partitions of any one of 16×16 pixels, 16×8 pixels, 8×16 pixels, or 8×8 pixels, with each having independent motion vector information. Also, a partition of 8×8 pixels can be divided into sub-partitions of any one of 8×8 pixels, 8×4 pixels, 4×8 pixels, or 4×4 pixels, with each having independent motion vector information.

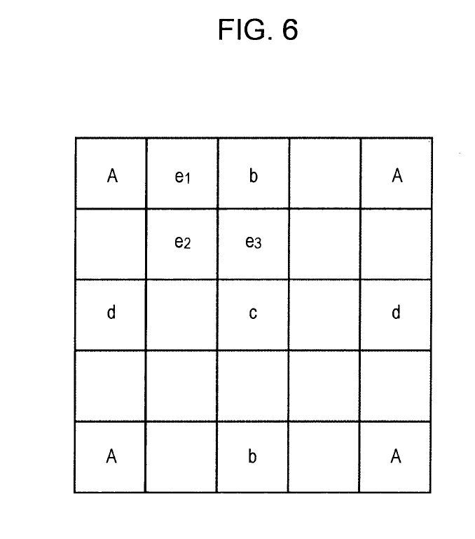

FIG. 6 is a diagram for describing prediction/compensation processing of quarter-pixel precision with the H.264/AVC format. With the H.264/AVC format, quarter-pixel precision prediction/compensation processing is performed using 6-tap FIR (Finite Impulse Response Filter) filter.

In the example in FIG. 6, a position A indicates integer-precision pixel positions, positions b, c, and d indicate half-pixel precision positions, and positions e1, e2, and e3 indicate quarter-pixel precision positions. First, in the following Clip( ) is defined as in the following Expression (1).

$$\begin{matrix}[ Mathematical Expression 1 ] & \\ Clip 1 ( a ) = \{ \begin{matrix}0 ; if ( a < 0 ) \\ a ; otherwise \\ max\_pix ; if ( a > max\_pix )\end{matrix} & ( 1 )\end{matrix}$$

Note that in the event that the input image is of 8-bit precision, the value of max_pix is 255.

The pixel values at positions b and d are generated as with the following Expression (2), using a 6-tap FIR filter.

[Mathematical Expression 2]

F=A₋₂−5·A₋₁+20·A₀+20·A₁−5·A₂+A₃

b,d=Clip1((F+16)>>5) (2)

The pixel value at the position c is generated as with the following Expression (3), using a 6-tap FIR filter in the horizontal direction and vertical direction.

[Mathematical Expression 3]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512)>>10) (3)

Note that Clip processing is performed just once at the end, following having performed product-sum processing in both the horizontal direction and vertical direction.

The positions e1 through e3 are generated by linear interpolation as with the following Expression (4).

[Mathematical Expression 4]

e₁=(A+b+1)>>1

e₂=(b+d+1)>>1

e₃=(b+c+1)>>1 (4)

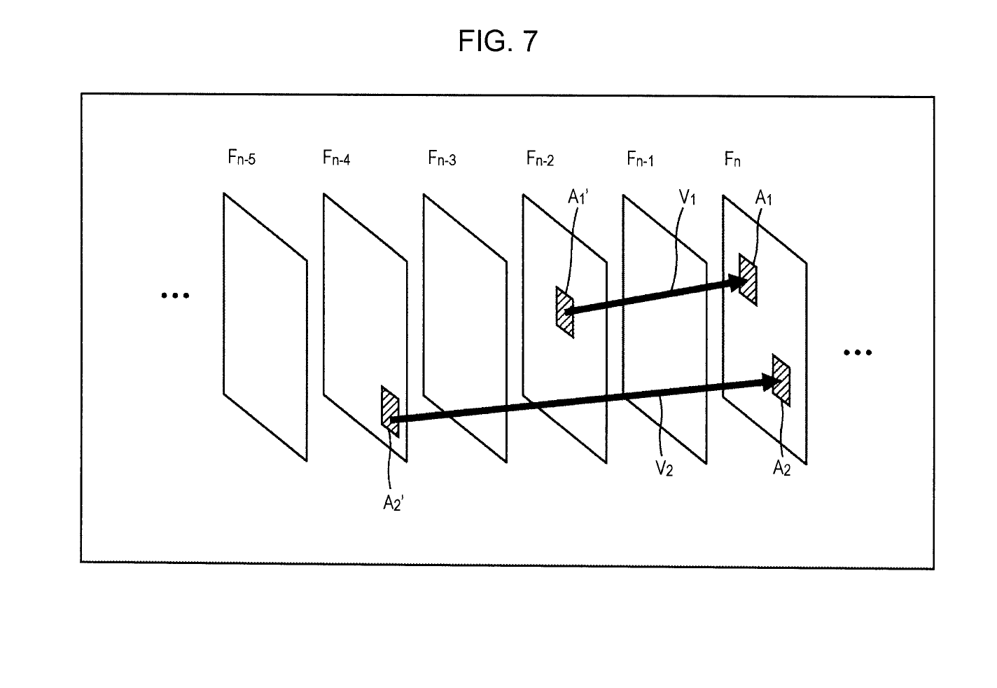

FIG. 7 is a drawing describing motion prediction/compensation processing of multi-reference frames in the H.264/AVC format. The H.264/AVC format stipulates the motion prediction/compensation method of multi-reference frames (Multi-Reference Frame).

In the example in FIG. 7, a current frame Fn to be encoded from now, and already-encoded frames Fn-5, . . . , Fn-1, are shown. The frame Fn-1 is a frame one before the current frame Fn, the frame Fn-2 is a frame two before the current frame Fn, and the frame Fn-3 is a frame three before the current frame Fn. Also, the frame Fn-4 is a frame four before the current frame Fn, and the frame Fn-5 is a frame five before the current frame Fn. Generally, the closer the frame is to the current frame Fn on the temporal axis, the smaller the attached reference picture No. (ref_id) is. That is to say, the reference picture No. is smallest for frame fn-1, and thereafter the reference picture No. is smaller in the order of Fn-2, . . . , Fn-5.

Block A1 and block A2 are displayed in the current frame Fn, with a motion vector V1 having been found for block A1 due to correlation with a block A1′ in the frame Fn-2 two back. Also, a motion vector V2 has been found for block A2 due to correlation with a block A1′ in the frame Fn-4 four back.

As described above, with the H.264/AVC format, multiple reference frames are stored in memory, and different reference frames can be referred to for one frame (picture). That is to say, each block in one picture can have independent reference frame information (reference picture No. (ref_id)), such as block A1 referring to frame Fn-2, block A2 referring to frame Fn-4, and so on, for example.

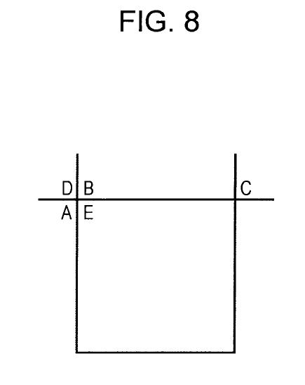

With the H.264/AVC format, motion prediction/compensation processing is performed as described above with reference to FIG. 5 through FIG. 7, resulting in massive motion vector information being generated, which has led to deterioration in encoding efficiency if this is encoded as it is. In contrast, with the H.264/AVC format, reduction in the encoded information of motion vectors is realized with the method shown in FIG. 8.

FIG. 8 is a diagram describing a motion vector information generating method with the H.264/AVC format. The example in FIG. 8 shows a current block E to be encoded from now (e.g., 16×16 pixels), and blocks A through D which have already been encoded and are adjacent to the current block E.

That is to say, the block D is situated adjacent to the upper left of the current block E, the block B is situated adjacent above the current block E, the block C is situated adjacent to the upper right of the current block E, and the block A is situated adjacent to the left of the current block E. Note that the reason why blocks A through D are not sectioned off is to express that they are blocks of one of the configurations of 16×16 pixels through 4×4 pixels, described above with FIG. 5.

For example, let us express motion vector information as to X (=A, B, C, D, E) as mv_{X}. First, prediction motion vector information (prediction value of motion vector) pmv_{E} as to the current block E is generated as shown in the following Expression (5), using motion vector information relating to the blocks A, B, and C.

pmv_{E}=med(mv_{A},mv_{B},mv_{C}) (5)

In the event that the motion vector information relating to the block C is not available (is unavailable) due to a reason such as being at the edge of the image frame, or not being encoded yet, the motion vector information relating to the block D is substituted instead of the motion vector information relating to the block C.

Data mvd_{E} to be added to the header portion of the compressed image, as motion vector information as to the current block E, is generated as shown in the following Expression (6), using pmv_{E}.

mvd_{E}=mv_{E}−pmv_{E} (6)

Note that in actual practice, processing is performed independently for each component of the horizontal direction and vertical direction of the motion vector information.

Thus, motion vector information can be reduced by generating prediction motion vector information, and adding the difference between the prediction motion vector information generated from correlation with adjacent blocks and the motion vector information to the header portion of the compressed image.

Now, even with median prediction, the percentage of motion vector information in the image compression information is not small. Accordingly, with the image encoding device 1, templates which are made up of pixels adjacent to the region of the image to be encoded with a predetermined positional relation are used, so motion prediction compensation processing is also performed for template prediction modes regarding which motion vectors do not need to be sent to the decoding side. At this time, pixels to be used for the templates are set at the image encoding device 1.

### [Detailed Configuration Example of Intra TP Motion Prediction/Compensation Unit]

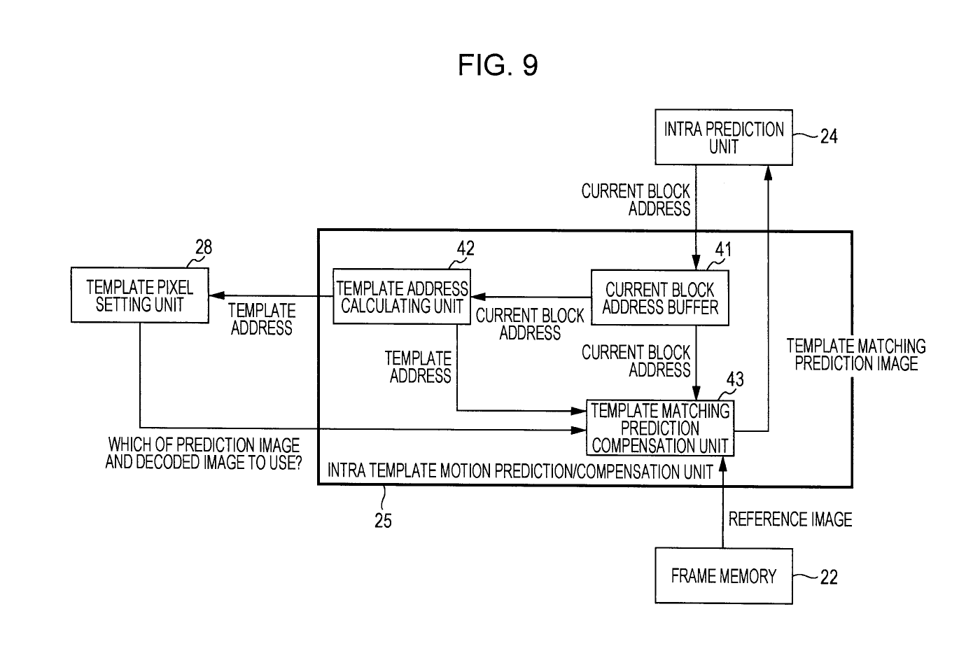

FIG. 9 is a block diagram illustrating a detailed configuration example of the intra TP motion prediction/compensation unit.

In the example in FIG. 9, the intra TP motion prediction/compensation unit 25 is configured of a current block address buffer 41, a template address calculating unit 42, and a template matching prediction compensation unit 43.

The current block address from the intra prediction unit 24 is supplied to the current block address buffer 41. Though not shown in the drawings, the image for intra prediction from the intra prediction unit 24 is supplied to the template matching prediction compensation unit 43.

The current block address buffer 41 stores the current block address for prediction that has been supplied from the intra prediction unit 24. The template address calculating unit 42 uses the current block address stored in the current block address buffer 41 to calculate the address of adjacent pixels making up the template. The template address calculating unit 42 supplies the calculated adjacent pixel address to the template pixel setting unit 28 and template matching prediction compensation unit 43 as a template address.

The template pixel setting unit 28 determines which of the decoded image and prediction image to used for the adjacent pixels of the template, based on the template address from the template address calculating unit 42, and supplies the information to the template matching prediction compensation unit 43.

The template matching prediction compensation unit 43 reads out the current block address stored in the current block address buffer 41. The template matching prediction compensation unit 43 is supplied with the image for intra prediction from the intra prediction unit 24, the template address from the template address calculating unit 42, and the information of adjacent pixels from the template pixel setting unit 28.

The template matching prediction compensation unit 43 reads out the reference image from the frame memory 22, performs template prediction mode motion prediction using the template regarding which the adjacent pixels have been set by the template pixel setting unit 28, and generates a prediction image. This prediction image is stored in an unshown internal buffer.

Specifically, the template matching prediction compensation unit 43 makes reference to the template address, and reads out from the frame memory 22 the pixel values of the adjacent pixels of the template regarding which the template pixel setting unit 28 has set to use decoded pixels. Also, the template matching prediction compensation unit 43 references the template address and reads out from the internal buffer the pixel values of the of the template regarding which the template pixel setting unit 28 has set to use the prediction pixels. The template matching prediction compensation unit 43 then searches for a region in the reference image read out from the frame memory 22, regarding which there is correlation with the template mode up of adjacent pixels read out from the frame memory 22 or the internal buffer. Further, a prediction image is obtained with a block adjacent to the searched region as a block corresponding to the block regarding which prediction is to be made.

Also, the template matching prediction compensation unit 43 calculates the cost function value of the template prediction mode using the image for intra prediction from the intra prediction unit 24, and supplies this to the intra prediction unit 24 along with the prediction image.

While description thereof will be omitted, the inter TP motion prediction/compensation unit 27 is configured basically in the same way as with the intra TP motion prediction/compensation unit 25 shown with FIG. 9. Accordingly, the functional block of FIG. 9 will be used for description of the inter TP motion prediction/compensation unit 27 as well.

That is, the inter TP motion prediction/compensation unit 27 is configured of a current block address buffer 41, template address calculating unit 42, and template matching prediction compensation unit 43, in the same way as with the intra TP motion prediction/compensation unit 25.

### [Example of Adjacent Pixel Setting Processing]

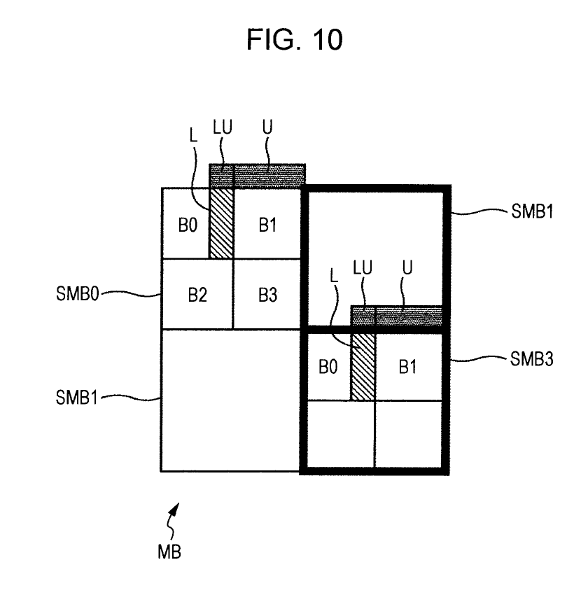

FIG. 10 illustrates an example of a template used for prediction of a current block. In the case of the example in FIG. 10, a macro block MB made up of 16×16 pixels is shown, and the macro block MB is made up of four sub macro blocks SB0 through SB3 of 8×8 pixels. Each sub macro block SMB is configured of four blocks B0 through B3 made up of 4×4 pixels.

Note that processing of the macro block MB in this case is performed in the order of sub macro block SB0 through SB3 (raster scan order), and at each sub macro block SMB, processing is performed in the order of blocks B0 through B3 (raster scan order).

Note that the template used for prediction of the current block is made up of a region adjacent to the current block by a predetermined positional relation, and the pixel values of pixels included in that region are used for prediction. For example, this is the upper portion, upper left portion, and left portion, and so forth of the current block, and in the following the template will be described divided into the three regions of upper region U, upper left region LU, and left region L.

In the example in FIG. 10, a case where the block B1 of the sub macro block SMB0 is a block which is the object of prediction, and a case where the block B1 of the sub macro block SMB3 is a block which is the object of prediction, are shown.

In the case where the block B1 of the sub macro block SMB0 is a block which is the object of prediction, of the templates adjacent to the block B1 of the sub macro block SMB0, the upper region U and upper left region LU exist outside the macro block MB and sub macro block SMB0. That is to say, a decoded image of adjacent pixels included in the upper region U and upper left region LU has already been generated, so the template pixel setting unit 28 sets using a decoded image as the adjacent pixels included in the upper region U and upper left region LU.

Conversely, the left region L belongs within the macro block MB and sub macro block SMB0. That is to say, the decoded image of adjacent pixels included in the left region L has not yet been processed, so the template pixel setting unit 28 uses a prediction image as the adjacent pixels included in the left region L.

Thus, the template pixel setting unit 28 sets which to use of the decoded image or prediction image as adjacent pixels, according to whether belonging within the current macro block (sub macro block).

That is to say, with the template prediction mode of the image encoding device 1, not only decoded images but also prediction images are used as necessary as adjacent pixels making up a template for the current block. Specifically, in the event that the adjacent pixels belong within the current macro block (sub macro block), a prediction image is used.

Accordingly, at the sub macro block SMB0, the processing of the block B1 can be started even without waiting for compensation processing which is processing where the decoded image of the block B0 is generated.

Note that in the event that the block B1 of the sub macro block SMB3 is the block for prediction, of the templates adjacent to the block B1 of the sub macro block SMB3, the upper region U and upper left region LU exist outside of the sub macro block SMB3. However, these the upper region U and upper left region LU exist within the macro block MB.

In such a case, either decoded pixels may be used, or prediction pixels may be used, as the adjacent pixels. In the case of the latter, processing of the sub macro block SMB3 can be started without waiting for the compensation processing of the sub macro block SMB1 to end, so processing can be performed faster.

Note that hereinafter, a block made up of a current block will be described as a macro block, but cases of a sub macro block will also be included.

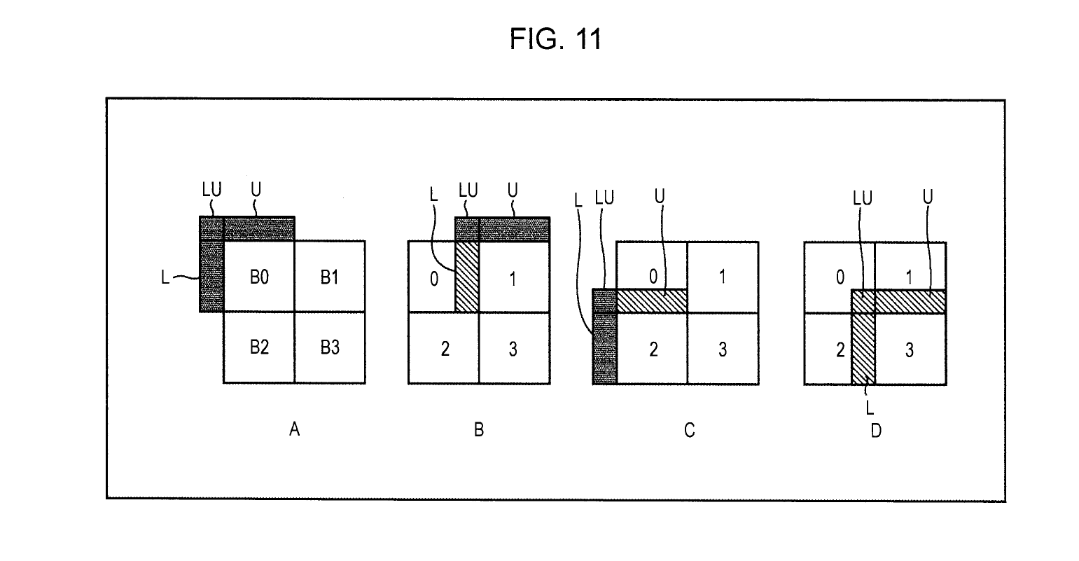

FIG. 11 is a diagram illustrating an example of templates according to the position of the current block in the macro block.

With the example of A in FIG. 11, an example of a case is shown where the block B0 which is at the first position in raster scan order is the current block. That is to say, this is a case where the current block is situated at the upper left of the macro block. In this case, a decoded image can be used for all adjacent pixels included in the upper region U, upper left region LU, and left region L, of the template as to the current block B0.

With the example of B in FIG. 11, an example of a case is shown where the block B1 which is at the second position in raster scan order is the current block. That is to say, this is a case where the current block is situated at the upper right of the macro block. In this case, a decoded image is set to be used for adjacent pixels included in the upper region U and upper left region LU of the template as to the current block B1. Also, a prediction image is set to be used for adjacent pixels included in the left region L of the template as to the current block B1.

With the example of C in FIG. 11, an example of a case is shown where the block B2 which is at the third position in raster scan order is the current block. That is to say, this is a case where the current block is situated at the lower left of the macro block. In this case, a decoded image is set to be used for adjacent pixels included in the upper left region LU and left region L of the template as to the current block B2. Also, a prediction image is set to be used for adjacent pixels included in the upper region U of the template as to the current block B2.

With the example of D in FIG. 11, an example of a case is shown where the block B3 which is at the fourth position in raster scan order is the current block. That is to say, this is a case where the current block is situated at the lower right of the macro block. In this case, a prediction image is set to be used for all adjacent pixels included in the upper region U, upper left region LU, and left region L of the template as to the current block B3.

Now, while description has been made above regarding an example where a macro block (or sub macro block) is divided into four, the arrangement is not restricted to this. Pixels making up the template are set from a decoded image or prediction image in the same way as with a case where the macro block (or sub macro block) is divided into two, for example.

FIG. 12 is a diagram illustrating an example of a case where a macro block is configured of two blocks, upper and lower. In the example in FIG. 12, a 16×16 pixel macro block is illustrated, with the macro block being configured of two upper and lower blocks B0 and B1 made up of 8×16 pixels.

In the example of A in FIG. 12, an example of a case is shown where in the macro block, the block B0 at the first position in the raster scan order is the current block. That is to say, this is a case where the current block is situated at the top of the macro block. In this case, a decoded image is set to be used for all adjacent pixels included in the upper region U, upper left region LU, and left region L, of the template as to the current block B0.

In the example of B in FIG. 12, an example of a case is shown where in the macro block, the block B1 at the second position in the raster scan order is the current block. That is to say, this is a case where the current block is situated at the bottom of the macro block. In this case, a decoded image is set to be used for adjacent pixels included in the left region L and upper left region LU of the template as to the current block B1. Also, a prediction image is set to be used for adjacent pixels included in the upper region U of the template as to the current block B1.

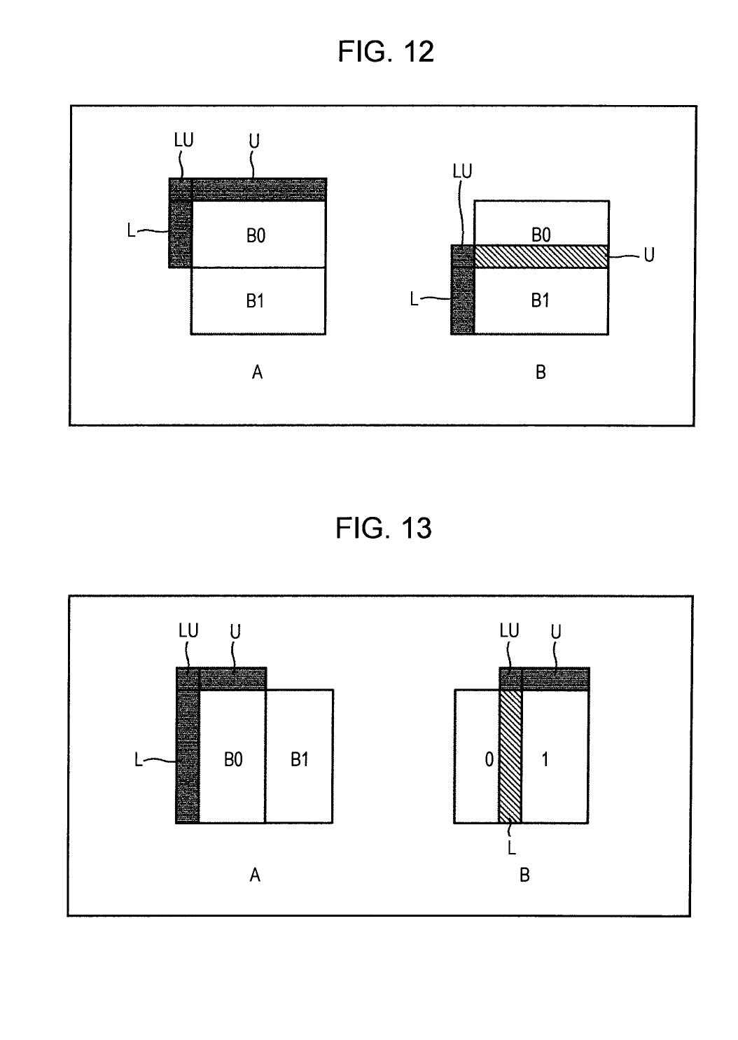

FIG. 13 is a diagram illustrating an example of a case where a macro block is configured of two blocks, upper and lower. In the example in FIG. 13, a 16×16 pixel macro block is illustrated, with the macro block being configured of two left and right blocks B0 and B1 made up of 16×8 pixels.

In the example of A in FIG. 13, an example of a case is shown where in the macro block, the block B0 at the first position in the raster scan order is the current block. That is to say, this is a case where the current block is situated at the left of the macro block. In this case, a decoded image is set to be used for all adjacent pixels included in the upper region U, upper left region LU, and left region L, of the template as to the current block B0.

In the example of B in FIG. 13, an example of a case is shown where in the macro block, the block B1 at the second position in the raster scan order is the current block. That is to say, this is a case where the current block is situated at the right of the macro block. In this case, a decoded image is set to be used for adjacent pixels included in the upper region U and upper left region LU of the template as to the current block B1. Also, a prediction image is set to be used for adjacent pixels included in the left region L of the template as to the current block B1.

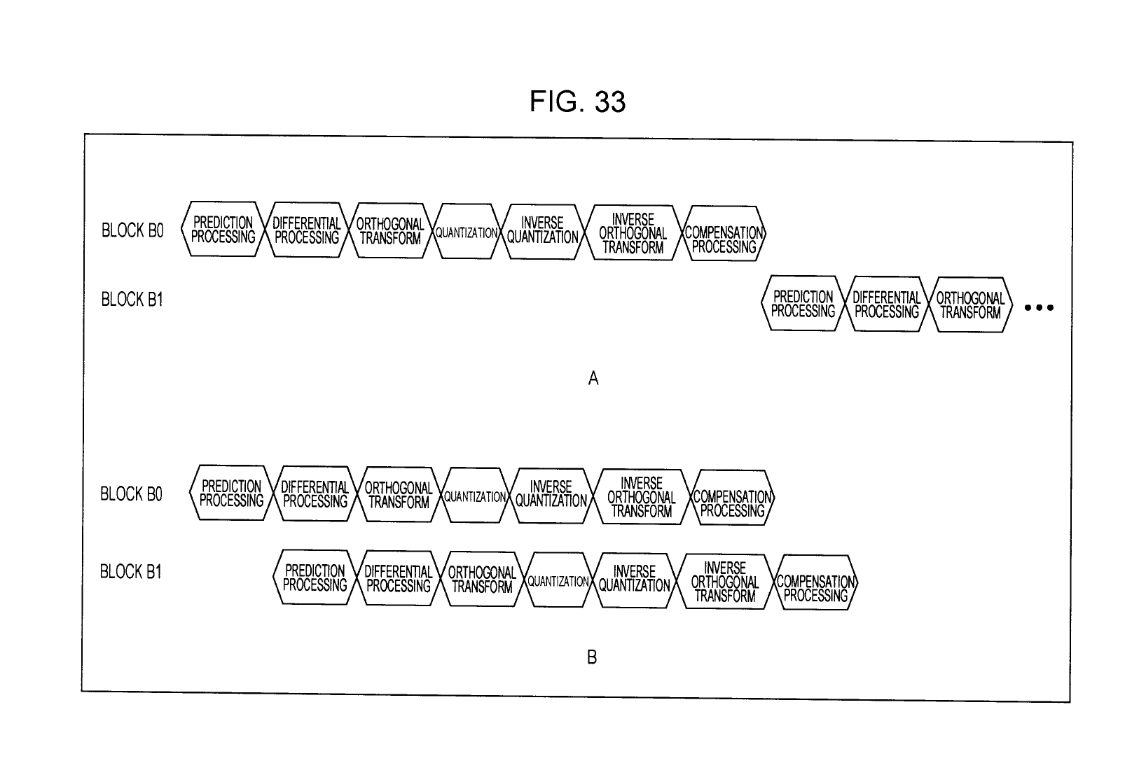

Thus, which to use of the decoded image or prediction image as adjacent pixels used for prediction of the current block within the macro block is set according to whether or not the adjacent pixels belong to the macro block. Accordingly, processing of the blocks within the macro block can be realized by pipeline processing, and processing efficiency is improved. Details of the advantages thereof will be described later with reference to FIG. 33.

### [Description of Encoding Processing]

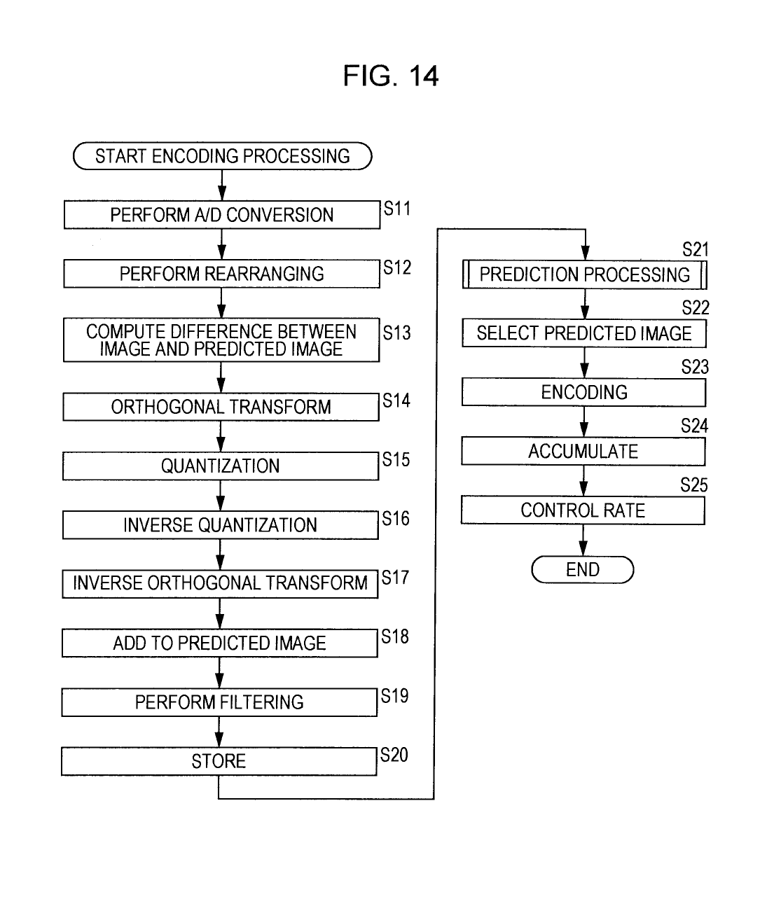

Next, the encoding processing of the image encoding device 1 in FIG. 4 will be described with reference to the flowchart in FIG. 14.

In step S11, the A/D converter 11 performs A/D conversion of an input image. In step S12, the screen rearranging buffer 12 stores the image supplied from the A/D converter 11, and performs rearranged of the pictures from the display order to the encoding order.

In step S13, the computing unit 13 computes the difference between the image rearranged in step S12 and a prediction image. The prediction image is supplied from the motion prediction/compensation unit 26 in the case of performing inter prediction, and from the intra prediction unit 24 in the case of performing intra prediction, to the computing unit 13 via the predicted image selecting unit 29.

The amount of data of the difference data is smaller in comparison to that of the original image data. Accordingly, the data amount can be compressed as compared to a case of performing encoding of the image as it is.

In step S14, the orthogonal transform unit 14 performs orthogonal transform of the difference information supplied from the computing unit 13. Specifically, orthogonal transform such as disperse cosine transform, Karhunen-Loève transform, or the like, is performed, and transform coefficients are output. In step S15, the quantization unit 15 performs quantization of the transform coefficients. The rate is controlled for this quantization, as described with the processing in step S25 described later.

The difference information quantized as described above is locally decoded as follows. That is to say, in step S16, the inverse quantization unit 18 performs inverse quantization of the transform coefficients quantized by the quantization unit 15, with properties corresponding to the properties of the quantization unit 15. In step S17, the inverse orthogonal transform unit 19 performs inverse orthogonal transform of the transform coefficients subjected to inverse quantization at the inverse quantization unit 18, with properties corresponding to the properties of the orthogonal transform unit 14.

In step S18, the computing unit 20 adds the predicted image input via the predicted image selecting unit 29 to the locally decoded difference information, and generates a locally decoded image (image corresponding to the input to the computing unit 13). In step S19, the deblocking filter 21 performs filtering of the image output from the computing unit 20. Accordingly, block noise is removed. In step S20, the frame memory 22 stores the filtered image. Note that the image not subjected to filter processing by the deblocking filter 21 is also supplied to the frame memory 22 from the computing unit 20, and stored.

In step S21, the intra prediction unit 24, intra TP motion prediction/compensation unit 25, motion prediction/compensation unit 26, and inter TP motion prediction/compensation unit 27 perform their respective image prediction processing. That is to say, in step S21, the intra prediction unit 24 performs intra prediction processing in the intra prediction mode, and the intra TP motion prediction/compensation unit 25 performs motion prediction/compensation processing in the intra template prediction mode. Also, the motion prediction/compensation unit 26 performs motion prediction/compensation processing in the inter prediction mode, and the and inter TP motion prediction/compensation unit 27 performs motion prediction/compensation processing in the inter template prediction mode. Note that at this time, with the intra TP motion prediction/compensation unit 25 and the inter TP motion prediction/compensation unit 27, templates set by the template pixel setting unit 28 are used.

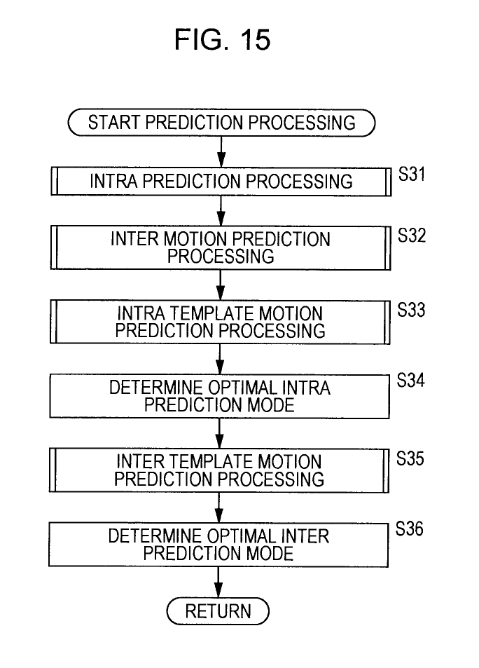

While the details of the prediction processing in step S21 will be described later in detail with reference to FIG. 15, with this processing, prediction processing is performed in each of all candidate prediction modes, and cost function values are each calculated in all candidate prediction modes. An optimal intra prediction mode is then selected from the intra prediction mode and the intra template prediction mode, based on the calculated cost function value, and the predicted image generated by the intra prediction in the optimal intra prediction mode and the cost function value are supplied to the predicted image selecting unit 29. Also, an optimal inter prediction mode is determined from the inter prediction mode and inter template prediction mode based on the calculated cost function value, and the predicted image generated with the optimal inter prediction mode and the cost function value thereof are supplied to the predicted image selecting unit 29.

In step S22, the predicted image selecting unit 29 determines one of the optimal intra prediction mode and optimal inter prediction mode as the optimal prediction mode, based on the respective cost function values output from the intra prediction unit 24 and the motion prediction/compensation unit 26. The predicted image selecting unit 29 then selects the predicted image of the determined optimal prediction mode, and supplies this to the computing units 13 and 20. The predicted image is used for computation in steps S13 and S18, as described above.

Note that the selection information of the predicted image is supplied to the intra prediction unit 24 or motion prediction/compensation unit 26. In the event that the predicted image of the optimal intra prediction mode is selected, the intra prediction unit 24 supplies information relating to the optimal intra prediction mode (i.e., intra prediction mode information or intra template prediction mode information) to the lossless encoding unit 16.

In the event that the predicted image of the optimal inter prediction mode is selected, the motion prediction/compensation unit 26 outputs information relating to the optimal inter prediction mode, and information corresponding to the optimal inter prediction mode as necessary, to the lossless encoding unit 16. Examples of information corresponding to the optimal inter prediction mode include motion vector information, flag information, reference frame information, etc. More specifically, in the event that the predicted image with the inter prediction mode is selected as the optimal inter prediction mode, the motion prediction/compensation unit 26 outputs inter prediction mode information, motion vector information, and reference frame information, to the lossless encoding unit 16.

On the other hand, in the event that a prediction image with the inter template prediction mode is selected as the optimal inter prediction mode, the motion prediction/compensation unit 26 outputs only inter template prediction mode information to the lossless encoding unit 16. That is to say, in the case of encoding with inter template prediction mode information, motion vector information or the like does not have to be sent to the decoding side, and accordingly this is not output to the lossless encoding unit 16. Accordingly, the motion vector information in the compressed image can be reduced.

In step S23, the lossless encoding unit 16 encodes the quantized transform coefficients output from the quantization unit 15. That is to say, the difference image is subjected to lossless encoding such as variable-length encoding, arithmetic encoding, or the like, and compressed. At this time, the information relating to the optimal intra prediction mode from the intra prediction unit 24 or the information relating to the optimal inter prediction mode form the motion prediction/compensation unit 26 and so forth, input to the lossless encoding unit 16 in step S22, also is encoded and added to the header information.

In step S24, the storage buffer 17 stores the difference image as a compressed image. The compressed image stored in the storage buffer 17 is read out as appropriate, and transmitted to the decoding side via the transmission path.

In step S25, the rate control unit 30 controls the rate of quantization operations of the quantization unit 15 so that overflow or underflow does not occur, based on the compressed images stored in the storage buffer 17.

### [Description of Prediction Processing]

Next, the prediction processing in step S21 of FIG. 14 will be described with reference to the flowchart in FIG. 15.

In the event that the image to be processed that is supplied from the screen rearranging buffer 12 is a block image for intra processing, a decoded image to be referenced is read out from the frame memory 22, and supplied to the intra prediction unit 24 via the switch 23. Based on these images, in step S31 the intra prediction unit 24 performs intra prediction of pixels of the block to be processed for all candidate intra prediction modes. Note that for decoded pixels to be referenced, pixels not subjected to deblocking filtering by the deblocking filter 21 are used.

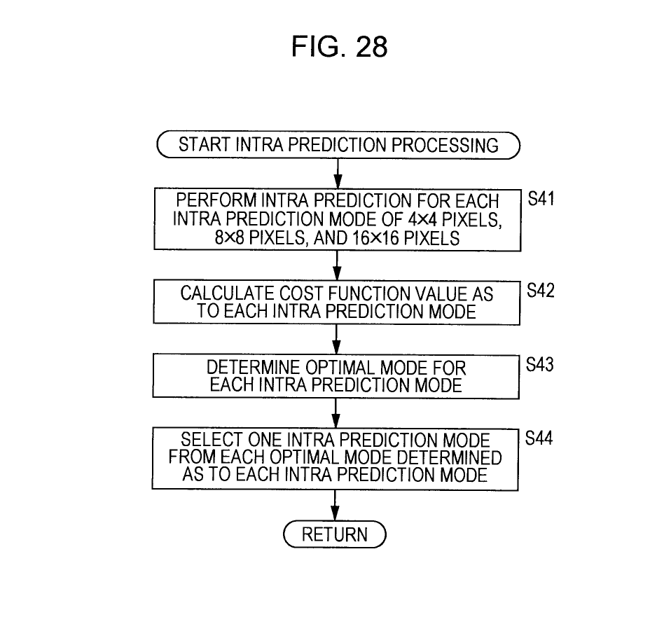

While the details of the intra prediction processing in step S31 will be described later with reference to FIG. 28, due to this processing, intra prediction is performed in all candidate intra prediction modes, and cost function values are calculated for all candidate intra prediction modes. One intra prediction mode is then selected from all intra prediction modes as the optimal one, based on the calculated cost function values.

In the event that the image to be processed that is supplied from the screen rearranging buffer 12 is an image for inter processing, the image to be referenced is read out from the frame memory 22, and supplied to the motion prediction/compensation unit 26 via the switch 23. In step S32, the motion prediction/compensation unit 26 performs motion prediction/compensation processing based on these images. That is to say, the motion prediction/compensation unit 26 references the image supplied from the frame memory 22 and performs motion prediction processing for all candidate inter prediction modes.

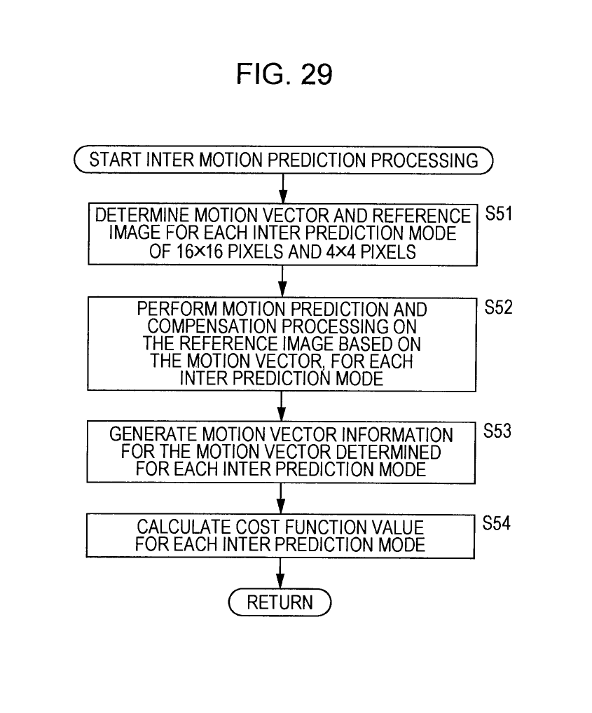

While details of the inter motion prediction processing in step S32 will be described later with reference to FIG. 29, due to this processing, prediction processing is performed for all candidate inter prediction modes, and cost function values are calculated for all candidate inter prediction modes.

Also, in the event that the image to be processed that is supplied from the screen rearranging buffer 12 is a block image for inter processing, the intra prediction unit 24 supplies the image for intra prediction that has been read out from the screen rearranging buffer 12 to the intra TP motion prediction/compensation unit 25. At this time, the information (address) of the block for prediction is also supplied to the intra TP motion prediction/compensation unit 25. Accordingly, in step S33, the intra TP motion prediction/compensation unit 25 performs intra template motion prediction processing in the intra template prediction mode.

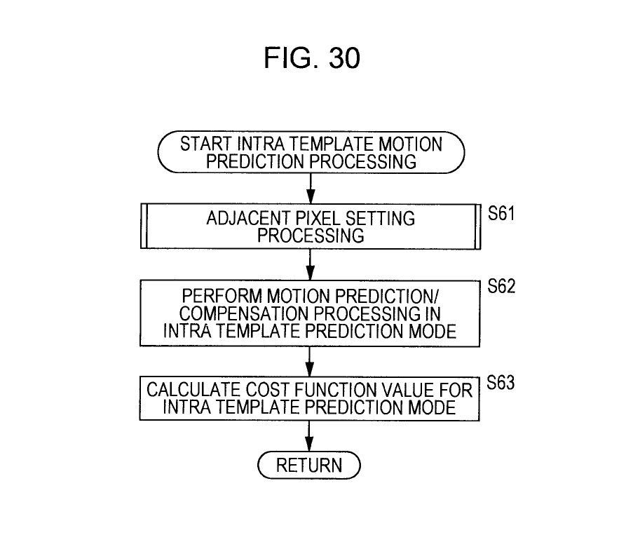

While the details of the intra template motion prediction processing in step S33 will be described later with reference to FIG. 30, due to this processing, adjacent pixels of the template are set. The template that is set is used so that motion prediction processing is performed in the intra template prediction mode, and cost function values are calculated as to the intra template prediction mode. The predicted image generated by the motion prediction processing for the intra template prediction mode, and the cost function value thereof are then supplied to the intra prediction unit 24.

In step S34, the intra prediction unit 24 compares the cost function value as to the intra prediction mode selected in step S31 with the cost function value calculated as to the intra template prediction mode selected in step S33. The intra prediction unit 24 then determines the prediction mode which gives the smallest value to be the optimal intra prediction mode, and supplies the predicted image generated in the optimal intra prediction mode and the cost function value thereof to the predicted image selecting unit 29.

Further, in the event that the image to be processed that is supplied from the screen rearranging buffer 12 is an image for inter processing, the motion prediction/compensation unit 26 supplies the image for inter prediction that has been read out from the screen rearranging buffer 12 to the inter TP motion prediction/compensation unit 27. At this time, the information (address) of the block for prediction is also supplied to the inter TP motion prediction/compensation unit 27. Accordingly, the inter TP motion prediction/compensation unit 27 performs inter template motion prediction processing in the inter template prediction mode in step S35.

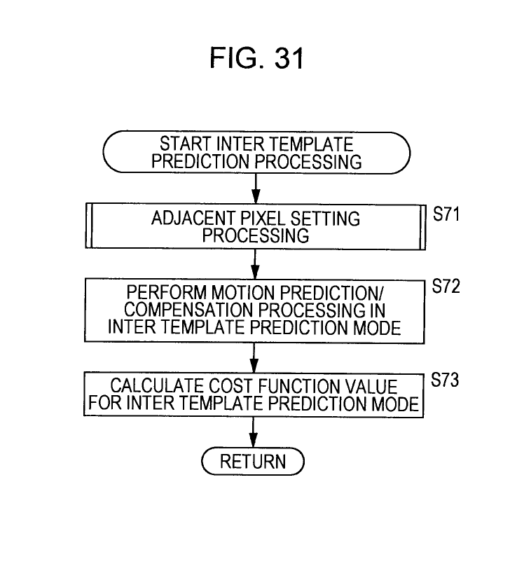

While details of the inter template motion prediction processing in step S35 will be described later with reference to FIG. 31, due to this processing, adjacent pixels of the template are set, motion prediction processing is performed in the inter template prediction mode using the set template, and cost function values as to the inter template prediction mode are calculated. The predicted image generated by the motion prediction processing in the inter template prediction mode and the cost function value thereof are then supplied to the motion prediction/compensation unit 26.

In step S36, the motion prediction/compensation unit 26 compares the cost function value as to the optimal inter prediction mode selected in step S32 with the cost function value calculated as to the inter template prediction mode in step S35. The motion prediction/compensation unit 26 then determines the prediction mode which gives the smallest value to be the optimal inter prediction mode, and the motion prediction/compensation unit 26 supplies the predicted image generated in the optimal inter prediction mode and the cost function value thereof to the predicted image selecting unit 29.

[Description of Intra Prediction Processing with H.264/AVC Format]

Next, the modes for intra prediction that are stipulated in the H.264/AVC format will be described.

First, the intra prediction modes as to luminance signals will be described. The luminance signal intra prediction mode include nine types of prediction modes in increments of 4×4 pixels, and four types of prediction modes in macro block increments of 16×16 pixels.

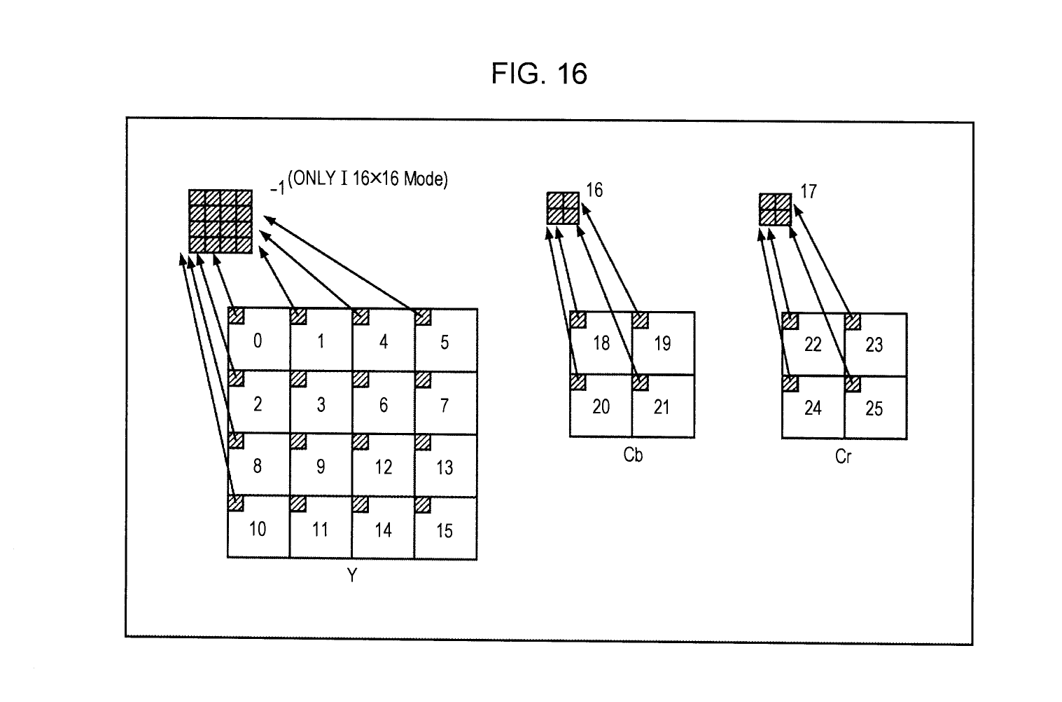

In the example in FIG. 16, the numerals −1 through 25 given to each block represent the order of each block in the bit stream (processing order at the decoding side). With regard to luminance signals, a macro block is divided into 4×4 pixels, and DCT is performed for the 4×4 pixels. Additionally, in the case of the intra prediction mode of 16×16 pixels, the direct current component of each block is gathered and a 4×4 matrix is generated, and this is further subjected to orthogonal transform, as indicated with the block −1.

Now, with regard to color difference signals, a macro block is divided into 4×4 pixels, and DCT is performed for the 4×4 pixels, following which the direct current component of each block is gathered and a 2×2 matrix is generated, and this is further subjected to orthogonal transform as indicated with the blocks 16 and 17.

Also, as for High Profile, a prediction mode in 8×8 pixel block increments is stipulated as to 8'th order DCT blocks, this method being pursuant to the 4×4 pixel intra prediction mode method described next.

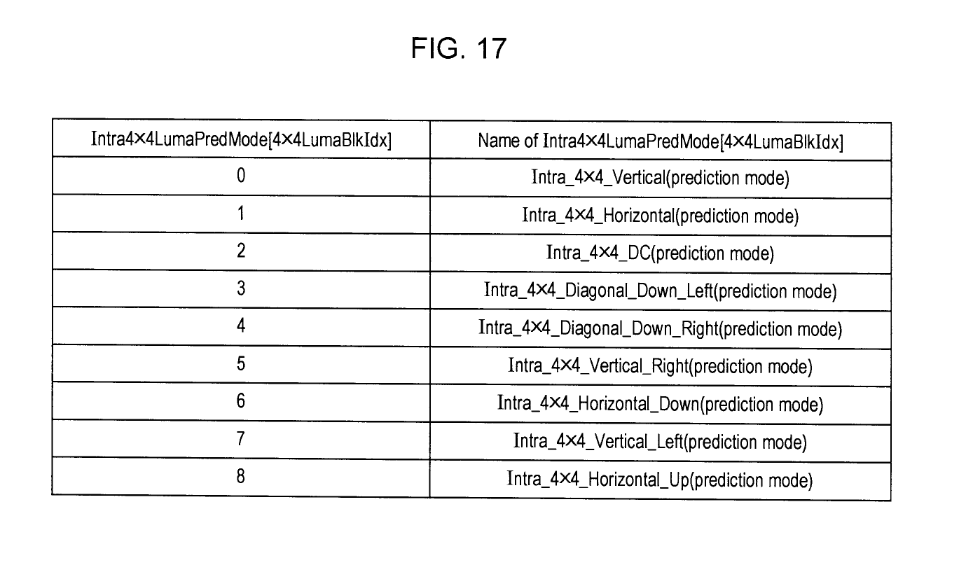

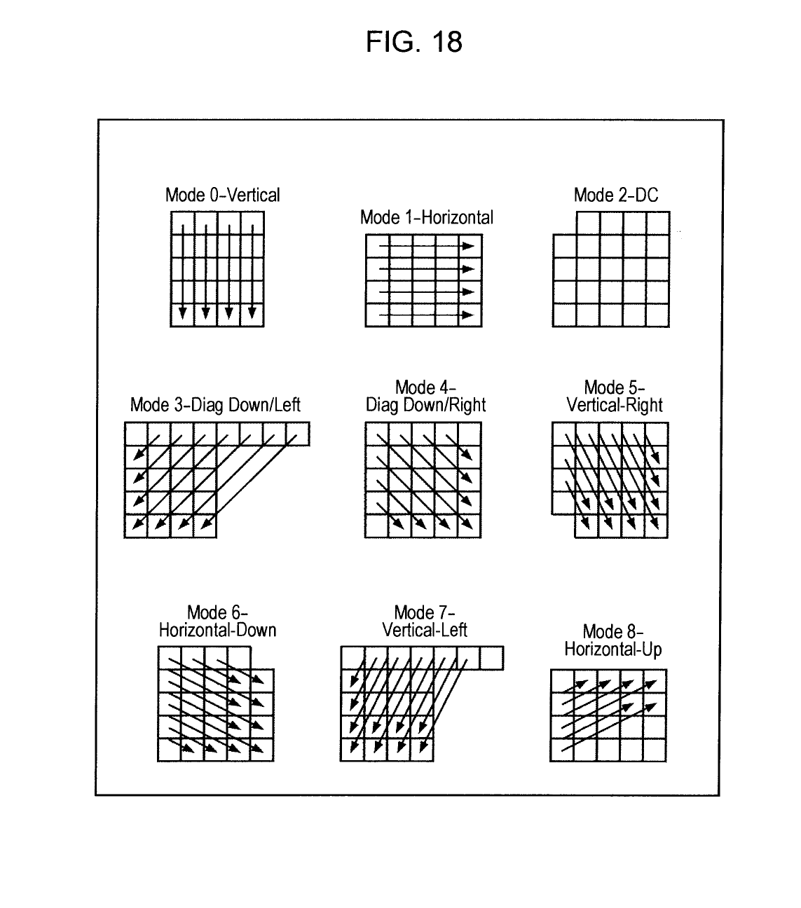

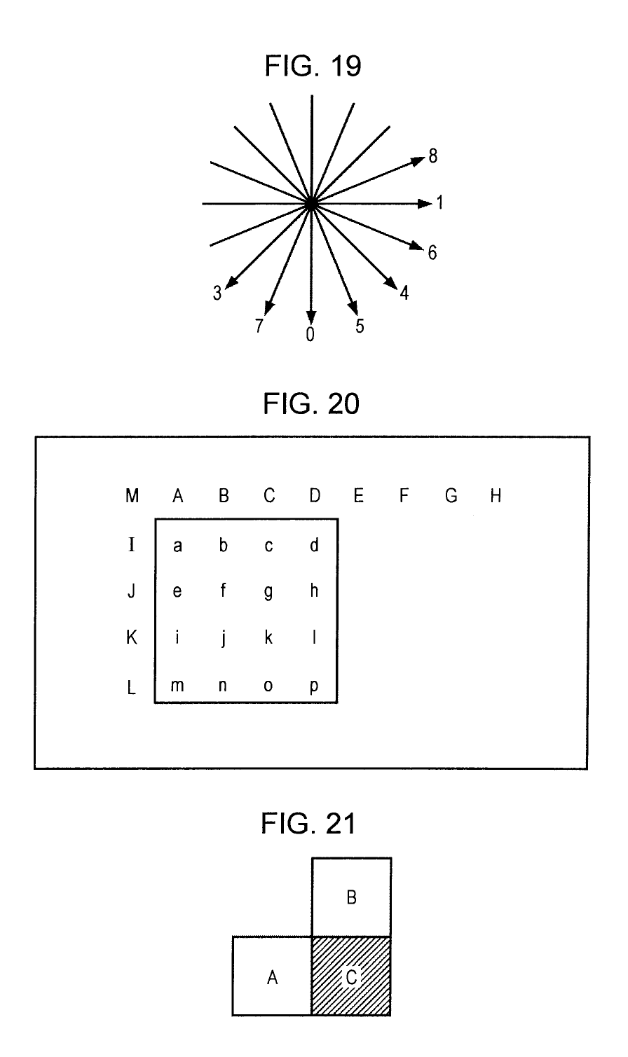

FIG. 17 and FIG. 18 are diagrams illustrating the nine types of luminance signal 4×4 pixel intra prediction modes (Intra_{—}4×4_pred_mode). The eight types of modes other than mode 2 which indicates average value (DC) prediction are each corresponding to the directions indicated by 0, 1, and 3 through 8, in FIG. 19.

The nine types of Intra_{—}4×4_pred_mode will be described with reference to FIG. 20. In the example in FIG. 20, the pixels a through p represent the current blocks to be subjected to intra processing, and the pixel values A through M represent the pixel values of pixels belonging to adjacent blocks. That is to say, the pixels a through p are the image to be processed that has been read out from the screen rearranging buffer 12, and the pixel values A through M are pixels values of the decoded image to be referenced that has been read out from the frame memory 22.

In the case of each intra prediction mode in FIG. 17 and FIG. 18, the predicted pixel values of pixels a through p are generated as follows using the pixel values A through M of pixels belonging to adjacent blocks. Note that in the event that the pixel value is “available”, this represents that the pixel is available with no reason such as being at the edge of the image frame or not being encoded yet, and in the event that the pixel value is “unavailable”, this represents that the pixel is unavailable due to a reason such as being at the edge of the image frame or not being encoded yet.

Mode 0 is a Vertical Prediction mode, and is applied only in the event that pixel values A through D are “available”. In this case, the prediction values of pixels a through p are generated as in the following Expression (7).

Prediction pixel value of pixels a, e, i, m=A

Prediction pixel value of pixels b, f, j, n=B

Prediction pixel value of pixels c, g, k, o=C

Prediction pixel value of pixels d, h, l, p=D (7)

Mode 1 is a Horizontal Prediction mode, and is applied only in the event that pixel values I through L are “available”. In this case, the prediction values of pixels a through p are generated as in the following Expression (8).

Prediction pixel value of pixels a, b, c, d=I

Prediction pixel value of pixels e, f, g, h=J

Prediction pixel value of pixels i, j, k, l=K

Prediction pixel value of pixels m, n, o, p=L (8)

Mode 2 is a DC Prediction mode, and prediction pixel values are generated as in the following Expression (9) in the event that pixel values A, B, C, D, I, J, K, L are all “available”.

(A+B+C+D+I+J+K+L+4) [symbol] 3 (9)

Also, prediction pixel values are generated as in the following Expression (10) in the event that pixel values A, B, C, D are all “unavailable”.

(I+J+K+L+2) [symbol] 2 (10)

Also, prediction pixel values are generated as in the following Expression (11) in the event that pixel values I, J, K, L are all “unavailable”.

(A+B+C+D+2) [symbol] 2 (11)

Also, in the event that pixel values A, B, C, D, I, J, K, L are all “unavailable”, 128 is generated as a prediction pixel value.

Mode 3 is a Diagonal_Down_Left Prediction mode, and prediction pixel values are generated only in the event that pixel values A, B, C, D, I, J, K, L, M are “available”. In this case, the prediction pixel values of the pixels a through p are generated as in the following Expression (12).

Prediction pixel value of pixel a=(A+2B+C+2) [symbol] 2

Prediction pixel value of pixels b, e=(B+2C+D+2) [symbol] 2

Prediction pixel value of pixels c, f, i=(C+2D+E+2) [symbol] 2

Prediction pixel value of pixels d, g, j, m=(D+2E+F+2) [symbol] 2

Prediction pixel value of pixels h, k, n=(E+2F+G+2) [symbol] 2

Prediction pixel value of pixels l, o=(F+2G+H+2) [symbol] 2

Prediction pixel value of pixel p=(G+3H+2) [symbol] 2 (12)

Mode 4 is a Diagonal_Down_Right Prediction mode, and prediction pixel values are generated only in the event that pixel values A, B, C, D, I, J, K, L, M are “available”. In this case, the prediction pixel values of the pixels a through p are generated as in the following Expression (13).

Prediction pixel value of pixel m=(J+2K+L+2) [symbol] 2

Prediction pixel value of pixels i, n=(I+2J+K+2) [symbol] 2

Prediction pixel value of pixels e, j, o=(M+2I+J+2) [symbol] 2

Prediction pixel value of pixels a, f, k, p=(A+2M+I+2) [symbol] 2

Prediction pixel value of pixels b, g, l=(M+2A+B+2) [symbol] 2

Prediction pixel value of pixels c, h=(A+2B+C+2) [symbol] 2

Prediction pixel value of pixel d=(B+2C+D+2) [symbol] 2 (13)

Mode 5 is a Diagonal_Vertical_Right Prediction mode, and prediction pixel values are generated only in the event that pixel values A, B, C, D, I, J, K, L, M are “available”. In this case, the pixel values of the pixels a through p are generated as in the following Expression (14).

Prediction pixel value of pixels a, j=(M+A+1) [symbol] 1

Prediction pixel value of pixels b, k=(A+B+1) [symbol] 1

Prediction pixel value of pixels c, l=(B+C+1) [symbol] 1

Prediction pixel value of pixel d=(C+D+1) [symbol] 1

Prediction pixel value of pixels e, n=(I+2M+A+2) [symbol] 2

Prediction pixel value of pixels f, o=(M+2A+B+2) [symbol] 2

Prediction pixel value of pixels g, p=(A+2B+C+2) [symbol] 2

Prediction pixel value of pixel h=(B+2C+D+2) [symbol] 2

Prediction pixel value of pixel i=(M+2I+J+2) [symbol] 2

Prediction pixel value of pixel m=(I+2J+K+2) [symbol] 2 (14)

Mode 6 is a Horizontal_Down Prediction mode, and prediction pixel values are generated only in the event that pixel values A, B, C, D, I, J, K, L, M are “available”. In this case, the pixel values of the pixels a through p are generated as in the following Expression (15).

Prediction pixel value of pixels a, g=(M+I+1) [symbol] 1

Prediction pixel value of pixels b, h=(I+2M+A+2) [symbol] 2

Prediction pixel value of pixel c=(M+2A+B+2) [symbol] 2

Prediction pixel value of pixel d=(A+2B+C+2) [symbol] 2

Prediction pixel value of pixels e, k=(I+J+1) [symbol] 1

Prediction pixel value of pixels f, l=(M+2I+J+2) [symbol] 2

Prediction pixel value of pixels i, o=(J+K+1) [symbol] 1

Prediction pixel value of pixels j, p=(I+2J+K+2) [symbol] 2

Prediction pixel value of pixel m=(K+L+1) [symbol] 1

Prediction pixel value of pixel n=(J+2K+L+2) [symbol] 2 (15)

Mode 7 is a Vertical_Left Prediction mode, and prediction pixel values are generated only in the event that pixel values A, B, C, D, I, J, K, L, M are “available”. In this case, the pixel values of the pixels a through p are generated as in the following Expression (16).

Prediction pixel value of pixel a=(A+B+1) [symbol] 1

Prediction pixel value of pixels b, i=(B+C+1) [symbol] 1

Prediction pixel value of pixels c, j=(C+D+1) [symbol] 1

Prediction pixel value of pixels d, k=(D+E+1) [symbol] 1

Prediction pixel value of pixel l=(E+F+1) [symbol] 1

Prediction pixel value of pixel e=(A+2B+C+2) [symbol] 2

Prediction pixel value of pixels f, m=(B+2C+D+2) [symbol] 2

Prediction pixel value of pixels g, n=(C+2D+E+2) [symbol] 2

Prediction pixel value of pixels h, o=(D+2E+F+2) [symbol] 2

Prediction pixel value of pixel p=(E+2F+G+2) [symbol] 2 (16)

Mode 8 is a Horizontal_Up Prediction mode, and prediction pixel values are generated only in the event that pixel values A, B, C, D, I, J, K, L, M are “available”. In this case, the pixel values of the pixels a through p are generated as in the following Expression (17).

Prediction pixel value of pixel a=(I+J+1) [symbol] 1

Prediction pixel value of pixels b=(I+2J+K+2) [symbol] 2

Prediction pixel value of pixels c, e=(J+K+1) [symbol] 1

Prediction pixel value of pixels d, f=(J+2K+L+2) [symbol] 2

Prediction pixel value of pixels g, i=(K+L+1) [symbol] 1

Prediction pixel value of pixels h, j=(K+3L+2) [symbol] 2

Prediction pixel value of pixels k, l, m, n, o, p=L (17)

Next, the intra prediction mode (Intra_{—}4×4_pred_mode) encoding method for 4×4 pixel luminance signals will be described with reference to FIG. 21. In the example in FIG. 21, a current block C to be encoded which is made up of 4×4 pixels is shown, and a block A and block B which are made up of 4×4 pixel and are adjacent to the current block C are shown.

In this case, the Intra_{—}4×4_pred_mode in the current block C and the Intra_{—}4×4_pred_mode in the block A and block B are thought to have high correlation. Performing the following encoding processing using this correlation allows higher encoding efficiency to be realized.

That is to say, in the example in FIG. 21, with the Intra_{—}4×4_pred_mode in the block A and block B as Intra_{—}4×4_pred_modeA and Intra_{—}4×4_pred_modeB respectively, the MostProbableMode is defined as the following Expression (18).

MostProbableMode=Min(Intra_{—}4×4_pred_modeA, Intra_{—}4×4_pred_modeB) (18)

That is to say, of the block A and block B, that with the smaller mode_number allocated thereto is taken as the MostProbableMode.

There are two values of prev_intra4×4_pred_mode_flag[luma4×4BlkIdx] and rem_intra4×4_pred_mode[luma4×4BlkIdx] defined as parameters as to the current block C in the bit stream, with decoding processing being performed by processing based on the pseudocode shown in the following Expression (19), so the values of Intra_{—}4×4_pred_mode, Intra4×4PredMode[luma4×4BlkIdx] as to the current block C can be obtained.

if(prev_intra4×4_pred_mode_flag[luma4×4BlkIdx]) Intra4×4PredMode[luma4×4BlkIdx]=MostProbableMode

else

if(rem_intra4×4_pred_mode[luma4×4BlkIdx]<MostProbableMode)

Intra4×4PredMode[luma4×4BlkIdx]=rem_intra4×4_pred_mode[luma4×4BlkIdx]

else

Intra4×4PredMode[luma4×4BlkIdx]=rem_intra4×4_pred_mode[luma4×4BlkIdx]+1 (19)

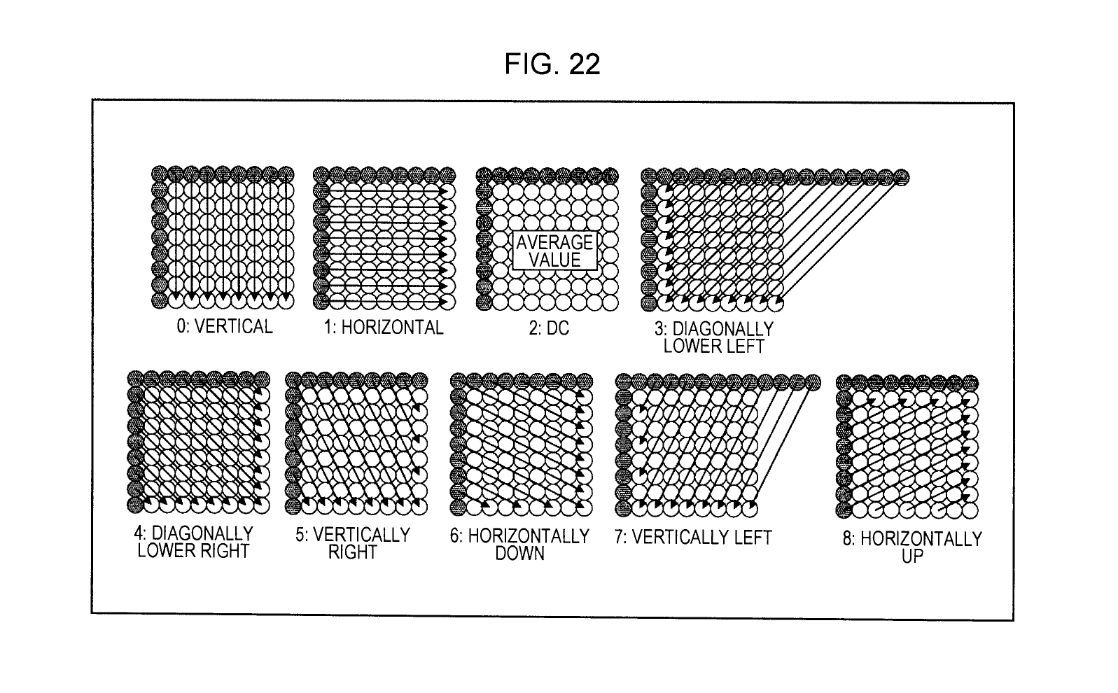

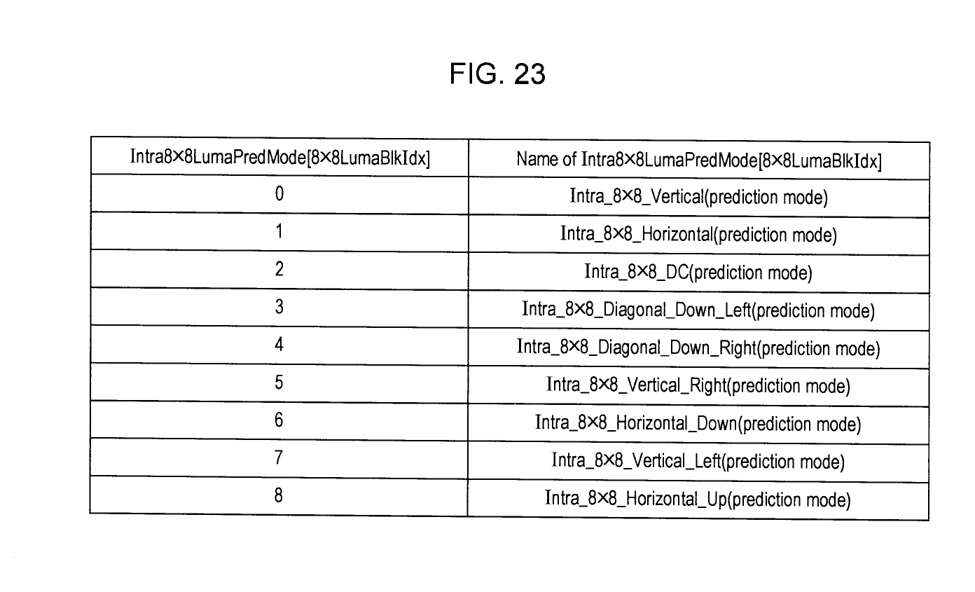

Next, the 8×8-pixel intra prediction mode will be described. FIG. 22 and FIG. 23 are diagrams showing the nine kinds of 8×8-pixel intra prediction modes (intra_{—}8×8_pred_mode) for luminance signals.

Let us say that the pixel values in the current 8×8 block are taken as p[x, y](0≦x≦7; 0≦y≦7), and the pixel values of an adjacent block are represented as p[−1, −1], . . . , p[−1, 15], p[−1, 0], . . . , [p−1, 7].

With regard to the 8×8-pixel intra prediction modes, adjacent pixels are subjected to low-pass filtering processing prior to generating a prediction value. Now, let us say that pixel values before low-pass filtering processing are represented with p[−1, −1], . . . , p[−1, 15], p[−1, 0], . . . , p[−1, 7], and pixel values after the processing are represented with p′[−1, −1], . . . , p′[−1, 15], p′[−1, 0], . . . , p′[−1, 7].

First, p′[0, −1] is calculated as with the following Expression (20) in the event that p[−1, −1] is “available”, and calculated as with the following Expression (21) in the event of “not available”.

p′[0,−1]=(p[−1,−1]+2*p[0,−1]+p[1,−1]+2)>>2 (20)

p′[0,−1]=(3*p[0,−1]+p[1,−1]+2)>>2 (21)

p′[x, −1] (x=0, . . . , 7) is calculated as with the following Expression (22).

p′[x,−1]=(p[x−1,−1]+2*p[x,−1]+p[x+1,−1]+2)>>2 (22)

p′[x, −1] (x=8, . . . , 15) is calculated as with the following Expression (23) in the event that p[x, −1] (x=8, . . . , 15) is “available”.

p′[x,−1]=(p[x−1,−1]+2*p[x,−1]+p[x+1,−1]+2)>>2

p′[15,−1]=(p[14,−1]+3*p[15,−1]+2)>>2 (23)

p′[−1, −1] is calculated as follows in the event that p[−1, −1] is “available”. Specifically, p′[−1, −1] is calculated as in Expression (24) in the event that both of p[0, −1] and p[−1, 0] are “available”, and calculated as in Expression (25) in the event that p[−1, 0] is “unavailable”. Also, p′[−1, −1] is calculated as in Expression (26) in the event that p[0, −1] is “unavailable”.

p′[−1,−1]=(p[0,−1]+2*p[−1,−1]+p[−1,0]+2)>>2 (24)

p′[−1,−1]=(3*p[−1,−1]+p[0,−1]+2)>>2 (25)

p′[−1,−1]=(3*p[−1,−1]+p[−1,0]+2)>>2 (26)

p′[−1, y] (y=0, . . . , 7) is calculated as follows when p[−1, y] (y=0, . . . , 7) is “available”. Specifically, first, in the event that p[−1, −1] is “available”, p′[−1, 0] is calculated as with the following Expression (27), and in the event of “unavailable”, calculated as in Expression (28).

p′[−1,0]=(p[−1,−1]+2*p[−1,0]+p[−1,1]+2)>>2 (27)

p′[−1,0]=(3*p[−1,0]+p[−1,1]+2)>>2 (28)

Also, p′[−1, y] (y=1, . . . , 6) is calculated as with the following Expression (29), and p′[−1, 7] is calculated as in Expression (30).

p[−1,y]=(p[−1,y−1]+2*p[−1,y]+p[−1,y+1]+2)>>2 (29)

p′[−1,7]=(p[−1,6]+3*p[−1,7]+2)>>2 (30)

Prediction values in the intra prediction modes shown in FIG. 22 and FIG. 23 are generated as follows using p′ thus calculated.

Mode 0 is a Vertical Prediction mode, and is applied only when p[x, −1] (x=0, . . . , 7) is “available”. A prediction value pred8×8_{L}[x, y] is generated as with the following Expression (31).

pred8×8_{L}[x,y]=p′[x,−1]x,y=0, . . . , 7 (31)

Mode 1 is a Horizontal Prediction mode, and is applied only when p[−1, y] (y=0, . . . , 7) is “available”. The prediction value pred8×8_{L}[x, y] is generated as with the following Expression (32).

pred8×8_{L}[x,y]=p′[−1,y]x,y=0, . . . , 7 (32)

Mode 2 is a DC Prediction mode, and the prediction value pred8×8_{L}[x, y] is generated as follows. Specifically, in the event that both of p[x, −1] (x=0, . . . , 7) and p[−1, y] (y=0, . . . , 7) are “available”, the prediction value pred8×8_{L}[x, y] is generated as with the following Expression (33).

$$\begin{matrix} [ Mathematical Expression 5 ] & \\ Pred 8 \times {8}_{L} [ x , y ] = ( {\sum }_{{x}^{′} = 0}^{7} {P}^{′} [ {x}^{′} , - 1 ] + {\sum }_{{y}^{′} = 0}^{7} {P}^{′} [ - 1 , y ] + 8 ) >> 4 & ( 33 )\end{matrix}$$

In the event that p[x, −1] (x=0, . . . , 7) is “available”, but p[−1, y] (y=0, . . . , 7) is “unavailable”, the prediction value pred8×8_{L}[x, y] is generated as with the following Expression (34).

$$\begin{matrix}[ Mathematical Expression 6 ] & \\ Pred 8 \times {8}_{L} [ x , y ] = ( {\sum }_{{x}^{′} = 0}^{7} {P}^{′} [ {x}^{′} , - 1 ] + 4 ) >> 3 & ( 34 )\end{matrix}$$

In the event that p[x, −1] (x=0, . . . , 7) is “unavailable”, but p[−1, y] (y=0, . . . , 7) is “available”, the prediction value pred8×8_{L}[x, y] is generated as with the following Expression (35).

$$\begin{matrix}[ Mathematical Expression 7 ] & \\ Pred 8 \times {8}_{L} [ x , y ] = ( {\sum }_{{y}^{′} = 0}^{7} {P}^{′} [ - 1 , y ] + 4 ) >> 3 & ( 35 )\end{matrix}$$

In the event that both of p[x, −1] (x=0, . . . , 7) and p[−1, y] (y=0, . . . , 7) are “unavailable”, the prediction value pred8×8_{L}[x, y] is generated as with the following Expression (36).

pred8×8_{L}[x,y]=128 (36)

Here, Expression (36) represents a case of 8-bit input.

Mode 3 is a Diagonal_Down_Left_prediction mode, and the prediction value pred8×8_{L}[x, y] is generated as follows. Specifically, the Diagonal_Down_Left_prediction mode is applied only when p[x, −1], x=0, . . . , 15, is “available”, and the prediction pixel value with x=7 and y=7 is generated as with the following Expression (37), and other prediction pixel values are generated as with the following Expression (38).

pred8×8_{L}[x,y]=(p′[14,−1]+3*p[15,−1]+2)>>2 (37)

pred8×8_{L}[x,y]=(p′[x+y,−1]+2*p′[x+y+1,−1]+p′[x+y+2,−1]+2)>>2 (38)

Mode 4 is a Diagnonal_Down_Right_prediction mode, and the prediction value pred8×8_{L}[x, y] is generated as follows. Specifically, the Diagnonal_Down_Right_prediction mode is applied only when p[x, −1], x=0, . . . , 7 and p[−1, y], y=0, . . . , 7 are “available”, the prediction pixel value with x>y is generated as with the following Expression (39), and the prediction pixel value with x<y is generated as with the following Expression (40). Also, the prediction pixel value with x=y is generated as with the following Expression (41).

pred8×8_{L}[x,y]=(p′[x−y−2,−1]+2*p′[x−y−1,−1]+p′[x−y,−1]+2)>>2 (39)

pred8×8_{L}[x,y]=(p′[−1,y−x−2]+2*p′[−1,y−x−1]+p′[−1,y−x]+2)>>2 (40)

pred8×8_{L}[x,y]=(p′[0,−1]+2*p′[−1,−1]+p′[−1,0]+2)>>2 (41)

Mode 5 is a Vertical_Right_prediction mode, and the prediction value pred8×8_{L}[x, y] is generated as follows. Specifically, the Vertical_Right_prediction mode is applied only when p[x, −1], x=0, . . . , 7 and p[−1, y], y=−1, . . . , 7 are “available”. Now, zVR is defined as with the following Expression (42).

zVR=2*x−y (42)

At this time, in the event that zVR is 0, 2, 4, 6, 8, 10, 12, or 14, the pixel prediction value is generated as with the following Expression (43), and in the event that zVR is 1, 3, 5, 7, 9, 11, or 13, the pixel prediction value is generated as with the following Expression (44).

pred8×8_{L}[x,y]=(p′[x−(y>>1)−1,−1]+p′[x−(y>>1),−1]+1)>>1 (43)

pred8×8_{L}[x,y]=(p′[x−(y>>1)−2,−1]+2*p′[x−(y>>1)−1,−1]+p′[x−(y>>1),−1]+2)>>2 (44)

Also, in the event that zVR is −1, the pixel prediction value is generated as with the following Expression (45), and in the cases other than this, specifically, in the event that zVR is −2, −3, −4, −5, −6, or −7, the pixel prediction value is generated as with the following Expression (46).

pred8×8_{L}[x,y]=(p′[31 1,0]+2*p′[−1,−1]+p′[0,−1]+2)>>2 (45)

pred8×8_{L}[x,y]=(p′[−1,y−2*x−1]+2*p′[−1,y−2*x−2]+p′[−1,y−2*x−3]+2)>>2 (46)

Mode 6 is a Horizontal_Down_prediction mode, and the prediction value pred8×8_{L}[x, y] is generated as follows. Specifically, the Horizontal_Down_prediction mode is applied only when p[x, −1], x=0, . . . , 7 and p[−1, y], y=−1, . . . , 7 are “available”. Now, zVR is defined as with the following Expression (47).

zHD=2*y−x (47)

At this time, in the event that zHD is 0, 2, 4, 6, 8, 10, 12, or 14, the prediction pixel value is generated as with the following Expression (48), and in the event that zHD is 1, 3, 5, 7, 9, 11, or 13, the prediction pixel value is generated as with the following Expression (49).

pred8×8_{L}[x,y]=(p′[−1,y−(x>>1)−1]+p′[−1,y−(x>>1)+1]>>1 (48)

pred8×8_{L}[x,y]=(p′[−1,y−(x>>1)−2]+2*p′[−1,y−(x>>1)−1]+p′[−1,y−(x>>1)]+2)>>2 (49)

Also, in the event that zHD is −1, the prediction pixel value is generated as with the following Expression (50), and in the event that zHD is other than this, specifically, in the event that zHD is −2, −3, −4, −5, −6, or −7, the prediction pixel value is generated as with the following Expression (51).

pred8×8_{L}[x,y]=(p′[−1,0]+2*p′[−1,−1]+p′[0,−1]+2)>>2 (50)

pred8×8_{L}[x,y]=(p′[x−2*Y−1,−1]+2*p′[x−2*y−2,−1]+p′[x−2*y−3,−1]+2)>>2 (51)

Mode 7 is a Vertical_Left_prediction mode, and the prediction value pred8×8_{L}[x, y] is generated as follows. Specifically, the Vertical_Left_prediction mode is applied only when p[x, −1], x=0, . . . , 15, is “available”, in the case that y=0, 2, 4, or 6, the prediction pixel value is generated as with the following Expression (52), and in the cases other than this, i.e., in the case that y=1, 3, 5, or 7, the prediction pixel value is generated as with the following Expression (53).

pred8×8_{L}[x,y]=(p′[x+(y>>1),−1]+p′[x+(y>>1)+1,−1]+1)>>1 (52)

pred8×8_{L}[x,y]=(p′[x+(y>>1),−1]+2*p′[x+(y>>1)+1,−1]+p′[x+(y>>1)+2,−1]+2)>>2 (53)

Mode 8 is a Horizontal_Up_prediction mode, and the prediction value pred8×8_{L}[x, y] is generated as follows. Specifically, the Horizontal_Up_prediction mode is applied only when p[−1, y], y=0, . . . , 7, is “available”. Hereafter, zHU is defined as with the following Expression (54).

zHU=x+2*y (54)

In the event that the value of zHU is 0, 2, 4, 6, 8, 10, 12, the prediction pixel value is generated as with the following Expression (55), and in the event that the value of zHU is 1, 3, 5, 7, 9, or 11, the prediction pixel value is generated as with the following Expression (56).

pred8×8_{L}[x,y]=(p′[−1,y+(x>>1)]+p′[−1,y+(x>>1)+1]+1)>>1 (55)

pred8×8_{L}[x,y]=(p′[−1,y+(x>>1)] (56)

Also, in the event that the value of zHU is 13, the prediction pixel value is generated as with the following Expression (57), and in the cases other than this, i.e., in the event that the value of zHU is greater than 13, the prediction pixel value is generated as with the following Expression (58).

pred8×8_{L}[x,y]=(p′[−1,6]+3*p′[−1,7]+2)>>2 (57)

pred8×8_{L}[x,y]=p′[−1,7] (58)

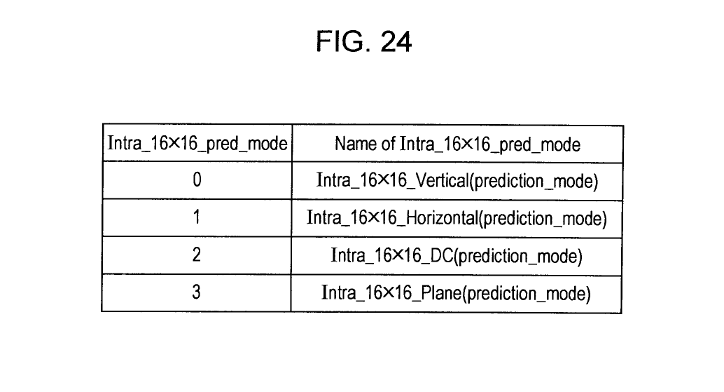

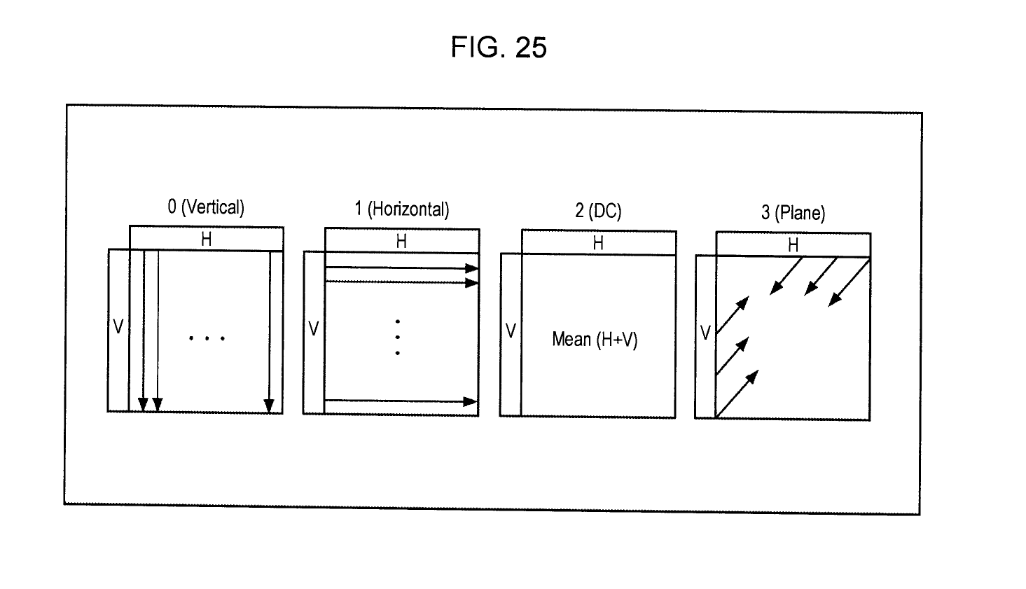

Next, description will be made regarding the 16×16 pixel intra prediction mode. FIG. 24 and FIG. 25 are diagrams illustrating the four types of 16×16 pixel luminance signal intra prediction modes (Intra_{—}16×16_pred_mode).

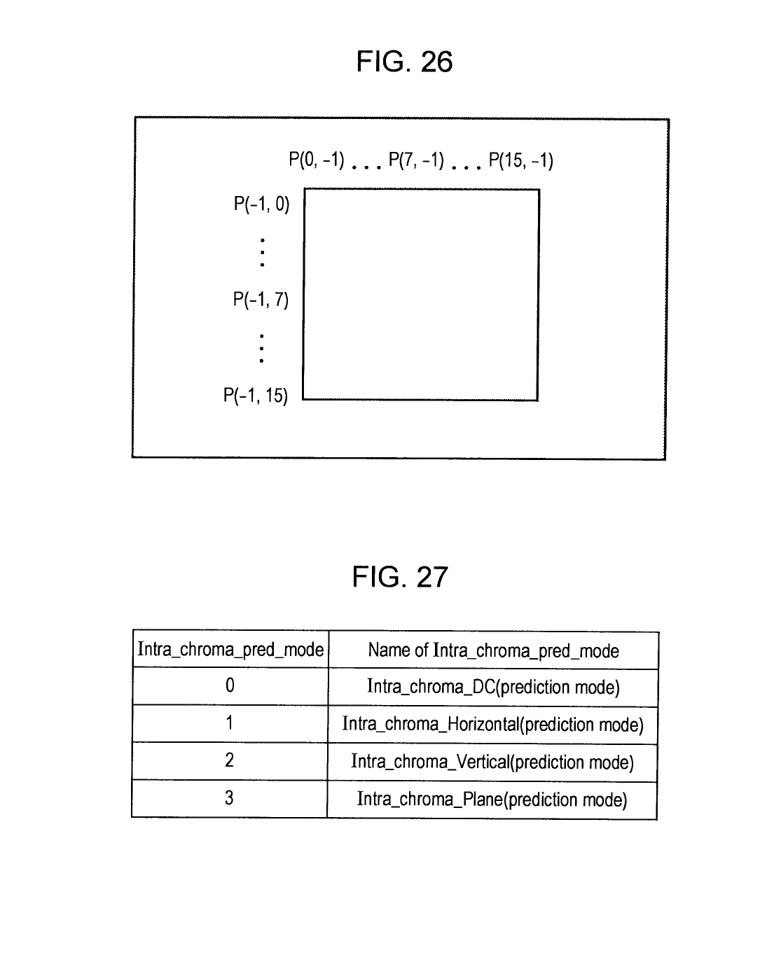

The four types of intra prediction modes will be described with reference to FIG. 26. In the example in FIG. 26, a current macro block A to be subjected to intra processing is shown, and P(x,y); x,y=−1, 0, . . . , 15 represents the pixel values of the pixels adjacent to the current macro block A.

Mode 0 is the Vertical Prediction mode, and is applied only in the event that P(x,−1); x,y=−1, 0, . . . , 15 is “available”. In this case, the prediction value Pred(x,y) of each of the pixels in the current macro block A is generated as in the following Expression (59).

Pred(x,y)=P(x,−1); x,y=0, . . . , 15 (59)

Mode 1 is the Horizontal Prediction mode, and is applied only in the event that P(−1,y); x,y=−1, 0, . . . , 15 is “available”. In this case, the prediction value Pred(x,y) of each of the pixels in the current macro block A is generated as in the following Expression (60).

Pred(x,y)=P(−1,y); x,y=0, . . . , 15 (60)

Mode 2 is the DC Prediction mode, and in the event that P(x,−1) and P(−1,y); x,y=−1, 0, . . . , 15 are all “available”, the prediction value Pred(x,y) of each of the pixels in the current macro block A is generated as in the following Expression (61).

$$\begin{matrix}[ Mathematical Expression 8 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , … , 15 & ( 61 )\end{matrix}$$

Also, in the event that P(x,−1); x,y=−1, 0, . . . , 15 is “unavailable”, the prediction value Pred(x,y) of each of the pixels in the current macro block A is generated as in the following Expression (62).

$$\begin{matrix}[ Mathematical Expression 9 ] & \\ Pred ( x , y ) = [ {\sum }_{{y}^{′} = 0}^{15} P ( - 1 , {y}^{′} ) + 8 ] >> 4 \\ with x , y = 0 , … , 15 & ( 62 )\end{matrix}$$

In the event that P(−1,y); x,y=−1, 0, . . . , 15 is “unavailable”, the prediction value Pred(x,y) of each of the pixels in the current macro block A is generated as in the following Expression (63).

$$\begin{matrix}[ Mathematical Expression 10 ] & \\ Pred ( x , y ) = [ {\sum }_{{y}^{′} = 0}^{15} P ( {x}^{′} , - 1 ) + 8 ] >> 4 \\ with x , y = 0 , … , 15 & ( 63 )\end{matrix}$$

In the event that P(x,−1) and P(−1,y); x,y=−1, 0, . . . , 15 as all “unavailable”, 128 is used as a prediction pixel value.

Mode 3 is the Plane Prediction mode, and is applied only in the event that P(x,−1) and P(−1,y); x,y=−1, 0, . . . , 15 are all “available”. In this case, the prediction value Pred(x,y) of each of the pixels in the current macro block A is generated as in the following Expression (64).

$$\begin{matrix}[ Mathematical Expression 11 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 64 )\end{matrix}$$

Next, the intra prediction modes as to color difference signals will be described. FIG. 27 is a diagram illustrating the four types of color difference signal intra prediction modes (Intra_chroma_pred_mode). The color difference signal intra prediction mode can be set independently from the luminance signal intra prediction mode. The intra prediction mode for color difference signals conforms to the above-described luminance signal 16×16 pixel intra prediction mode.

Note however, that while the luminance signal 16×16 pixel intra prediction mode handles 16×16 pixel blocks, the intra prediction mode for color difference signals handles 8×8 pixel blocks. Further, the mode Nos. do not correspond between the two, as can be seen in FIG. 24 and FIG. 27 described above.

In accordance with the definition of pixel values of the macro block which the object of the luminance signal 16×16 pixel intra prediction mode and the adjacent pixel values described above with reference to FIG. 26, the pixel values adjacent to the macro block A for intra processing (8×8 pixels in the case of color difference signals) will be taken as P(x,y);x,y=−1, 0, . . . , 7.

Mode 0 is the DC Prediction mode, and in the event that P(x,−1) and P(−1,y); x,y=−1, 0, . . . , 7 are all “available”, the prediction pixel value Pred(x,y) of each of the pixels of the current macro block A is generated as in the following Expression (65).

$$\begin{matrix}[ Mathematical Expression 12 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 65 )\end{matrix}$$

Also, in the event that P(−1,y); x,y=−1, 0, . . . , 7 is “unavailable”, the prediction pixel value Pred(x,y) of each of the pixels of current macro block A is generated as in the following Expression (66).

$$\begin{matrix}[ Mathematical Expression 13 ] & \\ Pred ( x , y ) = [ ( {\sum }_{n = 0}^{7} P ( n , - 1 ) ) + 4 ] >> 3 \\ with x , y = 0 , … , 7 & ( 66 )\end{matrix}$$

Also, in the event that P(x,−1); x,y=−1, 0, . . . , 7 is “unavailable”, the prediction pixel value Pred(x,y) of each of the pixels of current macro block A is generated as in the following Expression (67).

$$\begin{matrix}[ Mathematical Expression 14 ] & \\ Pred ( x , y ) = [ ( {\sum }_{n = 0}^{7} P ( - 1 , n ) ) + 4 ] >> 3 \\ with x , y = 0 , … , 7 & ( 67 )\end{matrix}$$

Mode 1 is the Horizontal Prediction mode, and is applied only in the event that P(−1,y); x,y=−1, 0, . . . , 7 is “available”. In this case, the prediction pixel value Pred(x,y) of each of the pixels of current macro block A is generated as in the following Expression (68).

Pred(x,y)=P(−1,y); x,y=0, . . . , 7 (68)

Mode 2 is the Vertical Prediction mode, and is applied only in the event that P(x,−1); x,y=−1, 0, . . . , 7 is “available”. In this case, the prediction pixel value Pred(x,y) of each of the pixels of current macro block A is generated as in the following Expression (69).

Pred(x,y)=P(x,−1); x,y=0, . . . , 7 (69)

Mode 3 is the Plane Prediction mode, and is applied only in the event that P(x,−1) and P(−1,y); x,y=−1, 0, . . . , 7 are “available” In this case, the prediction pixel value Pred(x,y) of each of the pixels of current macro block A is generated as in the following Expression (70).

$$\begin{matrix}[ Mathematical Expression 15 ] & \\ Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 70 )\end{matrix}$$

As described above, there are nine types of 4×4 pixel and 8×8 pixel block-increment and four types of 16×16 pixel macro block-increment prediction modes for luminance signal intra prediction modes. Also, there are four types of 8×8 pixel block-increment prediction modes for color difference signal intra prediction modes. The color difference signal intra prediction mode can be set separately from the luminance signal intra prediction mode.

For the luminance signal 4×4 pixel and 8×8 pixel intra prediction modes, one intra prediction mode is defined for each 4×4 pixel and 8×8 pixel luminance signal block. For luminance signal 16×16 pixel intra prediction modes and color difference intra prediction modes, one prediction mode is defined for each macro block.

Note that the types of prediction modes correspond to the directions indicated by the Nos. 0, 1, 3 through 8, in FIG. 19 described above. Prediction mode 2 is an average value prediction.

### [Description of Intra Prediction Processing]

Next, the intra prediction processing in step S31 of FIG. 15, which is processing performed as to these intra prediction modes, will be described with reference to the flowchart in FIG. 28. Note that in the example in FIG. 28, the case of luminance signals will be described as an example.

In step S41, the intra prediction unit 24 performs intra prediction as to each intra prediction mode of 4×4 pixels, 8×8 pixels, and 16×16 pixels, for luminance signals, described above.

For example, the case of 4×4 pixel intra prediction mode will be described with reference to FIG. 20 described above. In the event that the image to be processed that has been read out from the screen rearranging buffer 12 (e.g., pixels a through p), is a block image to be subjected to intra processing, a decoded image to be reference (pixels indicated by pixel values A through M) is read out from the frame memory 22, and supplied to the intra prediction unit 24 via the switch 23.

Based on these images, the intra prediction unit 24 performs intra prediction of the pixels of the block to be processed. Performing this intra prediction processing in each intra prediction mode results in a prediction image being generated in each intra prediction mode. Note that pixels not subject to deblocking filtering by the deblocking filter 21 are used as the decoded signals to be referenced (pixels indicated by pixel values A through M).

In step S42, the intra prediction unit 24 calculates cost function values for each intra prediction mode of 4×4 pixels, 8×8 pixels, and 16×16 pixels. Now, one technique of either a High Complexity mode or a Low Complexity mode is used for calculation of cost function values, as stipulated in JM (Joint Model) which is reference software in the H.264/AVC format.

That is to say, with the High Complexity mode, as far as temporary encoding processing is performed for all candidate prediction modes as the processing of step S41. A cost function value is then calculated for each prediction mode as shown in the following Expression (71), and the prediction mode which yields the smallest value is selected as the optimal prediction mode.

Cost(Mode)=D+λ·R (71)

D is difference (noise) between the original image and decoded image, R is generated code amount including orthogonal transform coefficients, and λ is a Lagrange multiplier given as a function of a quantization parameter QP.

On the other hand, in the Low Complexity mode, as for the processing of step S41, prediction images are generated and calculation is performed as far as the header bits such as motion vector information, prediction mode information, flag information, and so forth, for all candidates prediction modes. A cost function value shown in the following Expression (72) is then calculated for each prediction mode, and the prediction mode yielding the smallest value is selected as the optimal prediction mode.

Cost(Mode)=D+QPtoQuant(QP)·Header_Bit (72)

D is difference (noise) between the original image and decoded image, Header_Bit is header bits for the prediction mode, and QPtoQuant is a function given as a function of a quantization parameter QP.

In the Low Complexity mode, just a prediction image is generated for all prediction modes, and there is no need to perform encoding processing and decoding processing, so the amount of computation that has to be performed is small.

In step S43, the intra prediction unit 24 determines an optimal mode for each intra prediction mode of 4×4 pixels, 8×8 pixels, and 16×16 pixels. That is to say, as described above, there are nine types of prediction modes in the case of intra 4×4 pixel prediction mode and intra 8×8 pixel prediction mode, and there are four types of prediction modes in the case of intra 16×16 pixel prediction mode. Accordingly, the intra prediction unit 24 determines from these an optimal intra 4×4 pixel prediction mode, an optimal intra 8×8 pixel prediction mode, and an optimal intra 16×16 pixel prediction mode, based on the cost function value calculated in step S42.

In step S44, the intra prediction unit 24 selects one intra prediction mode from the optimal modes selected for each intra prediction mode of 4×4 pixels, 8×8 pixels, and 16×16 pixels, based on the cost function value calculated in step S42. That is to say, the intra prediction mode of which the cost function value is the smallest is selected from the optimal modes decided for each intra prediction mode of 4×4 pixels, 8×8 pixels, and 16×16 pixels.

### [Description of Inter Motion Prediction Processing]

Next, the inter motion prediction processing in step S32 in FIG. 15 will be described with reference to the flowchart in FIG. 29.

In step S51, the motion prediction/compensation unit 26 determines a motion vector and reference information for each of the eight types of inter prediction modes made up of 16×16 pixels through 4×4 pixels, described above with reference to FIG. 5. That is to say, a motion vector and reference image is determined for a block to be processed with each inter prediction mode.

In step S52, the motion prediction/compensation unit 26 performs motion prediction and compensation processing for the reference image, based on the motion vector determined in step S51, for each of the eight types of inter prediction modes made up of 16×16 pixels through 4×4 pixels. As a result of this motion prediction and compensation processing, a prediction image is generated in each inter prediction mode.

In step S53, the motion prediction/compensation unit 26 generates motion vector image to be added to a compressed image, based on the motion vector determined as to the eight types of inter prediction modes made up of 16×16 pixels through 4×4 pixels. At this time, the motion vector generating method described above with reference to FIG. 8 is used to generate motion vector information.

The generated motion vector information is also used for calculating cost function values in the following step S54, and in the event that a corresponding prediction image is ultimately selected by the predicted image selecting unit 29, this is output to the lossless encoding unit 16 along with the mode information and reference frame information.

In step S54 the motion prediction/compensation unit 26 calculates the cost function values shown in Expression (71) or Expression (72) described above, for each inter prediction mode of the eight types of inter prediction modes made up of 16×16 pixels through 4×4 pixels. The cost function values calculated here are used at the time of determining the optimal inter prediction mode in step S36 in FIG. 15 described above.

### [Description of Intra Template Motion Prediction Processing]

Next, the intra template prediction processing in step S33 of FIG. 15 will be described with reference to the flowchart in FIG. 30.

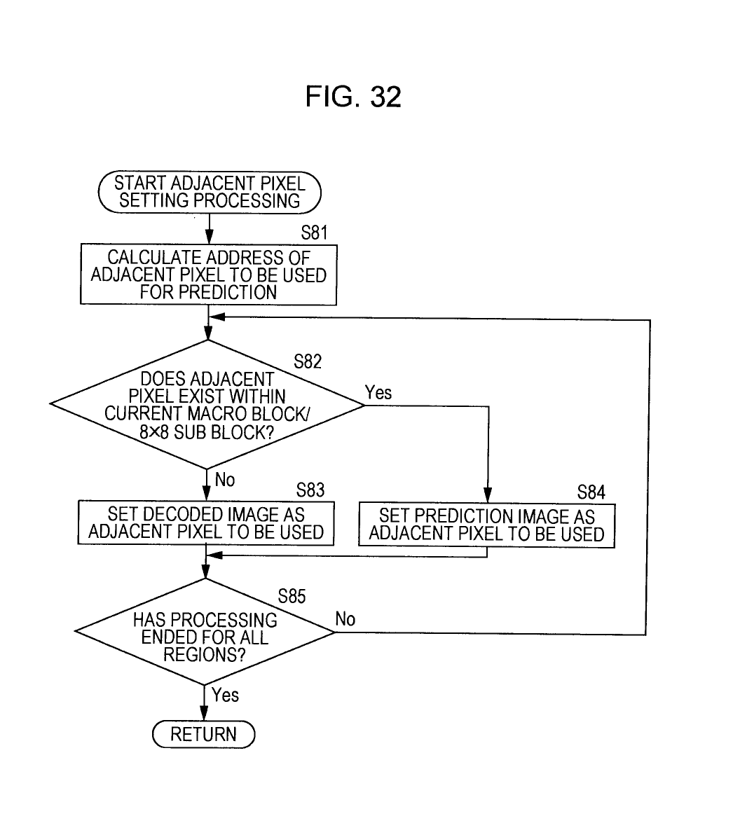

A current block address from the intra prediction unit 24 is stored in the current block address buffer 41 of the intra TP motion prediction/compensation unit 25. In step S61, the intra TP motion prediction/compensation unit 25 and template pixel setting unit 28 perform adjacent pixel setting processing which is processing for setting the adjacent pixels of a template as to a current block in the intra template prediction mode. The details of this adjacent pixel setting processing will be described with reference to FIG. 32. Due to this processing, which of a decoded image or prediction image are to be used as adjacent pixels making up the template for the current block in the intra template prediction mode, is set.

In step S62, the template matching prediction/compensation unit 43 of the intra TP motion prediction/compensation unit 25 performs intra template prediction mode motion prediction/compensation processing. That is to say, the template matching prediction/compensation unit 43 is supplied with the current address from the current block address buffer 41, the template address from the template address calculating unit 42, and information of adjacent pixels from the template pixel setting unit 28. The template matching prediction/compensation unit 43 makes reference to this information to perform intra template prediction mode motion prediction described with reference to FIG. 1 and generates a prediction image, using the template in which the template pixel setting unit 28 has set adjacent pixels.

Specifically, the template matching prediction/compensation unit 43 reads out a reference image of a predetermined search range within the same frame, from the frame memory 22. Also, the template matching prediction/compensation unit 43 makes reference to the template address and reads out pixel values of adjacent pixels of the template regarding which using decoded pixels has been set by the template pixel setting unit 28, from the frame memory 22. Further, the template matching prediction/compensation unit 43 makes reference to the template address and read out pixel values of adjacent pixels of the template regarding which using prediction pixels has been set by the template pixel setting unit 28, from the internal buffer.

The template matching prediction/compensation unit 43 then searches for a region in the predetermined search range in the same frame for a region where the adjacent pixels set by the template pixel setting unit 28 have the greatest correlation with the set template. The template matching prediction/compensation unit 43 takes the block corresponding to the searched region as a block corresponding to the current block, and generates a prediction image with the pixel values of that block. The prediction image is stored in the internal buffer.

In step S63, the template matching prediction/compensation unit 43 uses the image for intra prediction from the intra prediction unit 24 to calculate the cost function value shown in Expression (71) or Expression (72) described above, for the intra template prediction mode. The template matching prediction/compensation unit 43 supplies the generated prediction image and calculated cost function value to the intra prediction unit 24. This cost function value is used for determining the optimal intra prediction mode in step S34 in FIG. 15 described above.

Though not mentioned in particular, the sizes of the blocks and templates in the intra template prediction mode are optional. That is to say, as with the intra prediction unit 24, the intra template prediction mode can be carried out with the block size of each intra prediction mode as a candidate, or can be performed fixed to the block size of one prediction mode. The template size may be variable according to the block size which is the object thereof, or may be fixed.

### [Description of Inter Template Motion Prediction Processing]

Next, the inter template prediction processing in step S35 in FIG. 15 will be described with reference to the flowchart in FIG. 31.

A current block address from the motion prediction/compensation unit 26 is stored in the current block address buffer 41 of the inter TP motion prediction/compensation unit 27. In step S71, the inter TP motion prediction/compensation unit 27 and template pixel setting unit 28 perform adjacent pixel setting processing which is processing for setting the adjacent pixels of a template as to a current block in the inter template prediction mode. The details of this adjacent pixel setting processing will be described with reference to FIG. 32. Due to this processing, which of a decoded image or prediction image are to be used as adjacent pixels making up the template for the current block in the inter template prediction mode, is set.

In step S72, the template matching prediction/compensation unit 43 of the inter TP motion prediction/compensation unit 27 performs intra template prediction mode motion prediction/compensation processing. That is to say, the template matching prediction/compensation unit 43 is supplied with template address from the template address calculating unit 42 and with information of adjacent pixels from the template pixel setting unit 28. The template matching prediction/compensation unit 43 makes reference to this information to perform inter template prediction mode motion prediction described with reference to FIG. 2 and generates a prediction image, using the template in which the template pixel setting unit 28 has set adjacent pixels.

Specifically, the template matching prediction/compensation unit 43 reads out a reference image of a predetermined search range within the same frame, from the frame memory 22. Also, the template matching prediction/compensation unit 43 makes reference to the template address and reads out pixel values of adjacent pixels of the template regarding which using decoded pixels has been set by the template pixel setting unit 28, from the frame memory 22. Further, the template matching prediction/compensation unit 43 makes reference to the template address and read out pixel values of adjacent pixels of the template regarding which using prediction pixels has been set by the template pixel setting unit 28, from the internal buffer.

The template matching prediction/compensation unit 43 then searches for a region in the predetermined search range in the same frame for a region where the adjacent pixels set by the template pixel setting unit 28 have the greatest correlation with the set template. The template matching prediction/compensation unit 43 takes the block corresponding to the searched region as a block corresponding to the current block, and generates a prediction image with the pixel values of that block.

In step S73, the template matching prediction/compensation unit 43 uses the image for inter prediction from the motion prediction/compensation unit 26 to calculate the cost function value shown in Expression (71) or Expression (72) described above, for the inter template prediction mode. The template matching prediction/compensation unit 43 supplies the generated prediction image and calculated cost function value to motion prediction/compensation unit 26. This cost function value is used for determining the optimal inter prediction mode in step S36 in FIG. 15 described above.

Though not mentioned in particular, the sizes of the blocks and templates in the inter template prediction mode are optional. That is to say, as with the motion prediction/compensation unit 26, this may be fixed to one block size form the eight types of block sizes made up of 16×16 pixels through 4×4 pixels described above with FIG. 5, or may be performed with all block sizes as candidates. The template size may be variable according to the block size, or may be fixed.

### [Description of Adjacent Pixel Setting Processing]

Next, the adjacent pixel setting processing in step S61 of FIG. 30 will be described with reference to the flowchart in FIG. 32. Note that while description will be made of the processing which the intra TP motion prediction/compensation unit 25 performs in the example in FIG. 32, the adjacent pixel setting processing which the inter TP motion prediction/compensation unit 27 performs in step S71 in FIG. 31 is basically the same processing, so description thereof will be omitted.

A current block address from the intra prediction unit 24 is stored in the current block address buffer 41 of the intra TP motion prediction/compensation unit 25. In step S81, the template address calculating unit 42 uses the current block address stored in the current block address buffer 41 to calculate the addresses of adjacent pixels making up the template. The template address calculating unit 42 supplies these to the template pixel setting unit 28 and template matching prediction/compensation unit 43 as template addresses.

Now, with the example in FIG. 32, the template will be described divided into the upper region, upper left region, and left region. The upper region is the region of the template which is adjacent to the bock or macro block or the like above. The upper left region is the region of the template which is adjacent to the bock or macro block or the like at the upper left. The left region is the region of the template which is adjacent to the bock or macro block or the like at the left.

In step S82, the template pixel setting unit 28 first determines whether or not the adjacent pixels included in the upper region exist within the current macro block or current sub macro block of the current block. While description will be omitted, there a cases wherein determination is made regarding only within the current macro block, depending on the processing increment.

In the event that determination is made in step S82 that the adjacent pixels included in the upper region exist within the current macro block, the processing advances to step S83. In step S83, the template pixel setting unit 28 sets decoded pixels as the adjacent pixels to be used for prediction.

On the other hand, in the event that determination is made in step S82 that pixels included in the upper region exist outside of the current macro block or current sub macro block, the processing advances to step S84. In step S84, the template pixel setting unit 28 sets prediction pixels as the adjacent pixels to be used for prediction.

In step S85, the template pixel setting unit 28 determines whether or not processing for all regions of the template (upper region, upper left region, and left region) has ended. In step S85, in the event determination is made that processing for all regions of the template has not ended, the processing returns to step S82, and the subsequent processing is repeated.

Also, in the event that determination is made in step S85 that processing for all regions of the template has ended, the adjacent pixel setting processing ends. At this time, the information of the adjacent pixels making up the template set by the template pixel setting unit 28 is supplied to the template matching prediction/compensation unit 43, and used for the processing of step S62 in FIG. 30.

### [Example of Advantages of Adjacent Pixel Setting Processing]

The advantages of the above-described adjacent pixel setting processing will be described with reference to the timing chart in FIG. 33. In the example in FIG. 33, an example is illustrated of <prediction processing>, <differential processing>, <orthogonal transform>, <quantization>, <inverse quantization>, <inverse orthogonal transform>, and <compensation processing>.

A in FIG. 33 illustrates a timing chart of processing in a case of using a conventional template. B in FIG. 33 illustrates a timing chart of pipeline processing enabled in a case of using a template regarding which adjacent pixels have been set by the template pixel setting unit 28.

With the device using the conventional template, in the case of performing processing of the block B1 in FIG. 10 described above, the pixel values of the decoded image in block B0 are used as a part of the template, so generating of these pixel values has to be waited for.

Accordingly, as shown in A in FIG. 33, the <prediction processing> of block B1 cannot be performed until <prediction processing>, <differential processing>, <orthogonal transform>, <quantization>, <inverse quantization>, <inverse orthogonal transform>, and <compensation processing> end in order regarding the block B0, and the decoded image is written to the memory. That is to say, conventionally, it has been difficult to perform processing of block B0 and block B1 with pipeline processing.

On the other hand, in the case of using the template set by the template pixel setting unit 28, a prediction image of the block B0 is used instead of the decoded image of the block B0, for the adjacent pixels making up the left region L of the template for the block B1. The prediction image of the block B0 is generated by <prediction processing> of the block B0.

Accordingly, there is no need to way for generating of the decoded pixels of the block B0 to perform processing of the block B1. Accordingly, as shown in B in FIG. 33 for example, after <prediction processing> has ended for the block B0, <prediction processing> for the block B1 can be performed in parallel with the <differential processing> as to the block B0. That is to say, processing of Block B0 and block B1 can be performed by pipeline processing.

Thus, processing efficiency within macro blocks and sub macro blocks can be improved. Note that with the example in FIG. 33, an example has been described regarding performing pipeline processing with two blocks, but pipeline processing can be performed in the same way with three blocks, or four blocks, as a matter of course.

Also, while description has been made in the above description regarding cases of the current block size being 4×4 pixels, 8×8 pixels, 8×16 pixels, and 16×8 pixels, but the scope of applicability of the present invention is not restricted to this.

That is to say, regarding a case of a block size of 8×4 pixels or 4×8 pixels, pipeline processing can be performed within a sub macro block of 8×8 pixels by performing processing the same as with the examples described above with reference to FIG. 12 or FIG. 13. Also, regarding a case of a block size of 2×2 pixels, 2×4 pixels, or 4×2 pixels, pipeline processing can be performed within a block of 4×4 pixels by performing processing the same as with the examples regarding a block of 4×4 described above with reference to FIG. 11.

Note that in the event that the size of the block for template matching is 2×2 pixels for example, the size for orthogonal transform stipulated with the H.264/AVC format is at least 4×4 pixels, so conventionally, the processing shown in A in FIG. 33 was difficult to begin with.

In contrast, using a template regarding which adjacent pixels have been set by the template pixel setting unit 28 allows template matching prediction with block sizes smaller than the block size in orthogonal transform (4×4) to be performed.

Also, as described above with reference to FIG. 16, with regard to color difference signals, orthogonal transform processing for the DC component is defined as with block 16 and block 17 in FIG. 16 as well. Accordingly, when block 19 is being processed for example, the pixel values of the decoded image as to block 18 are unknown, so performing template matching processing with block increments smaller than macro blocks has been difficult.

In contrast, using a template regarding which adjacent pixels have been set by the template pixel setting unit 28 does away with the need to wait for processing of blocks 16 and 17 in FIG. 16. Thus, performing template matching processing with block increments smaller than macro blocks is enabled.

The encoded compressed image is transmitted over a predetermined transmission path and is decoded by the image decoding device.

### [Configuration Example of Image Decoding Device]

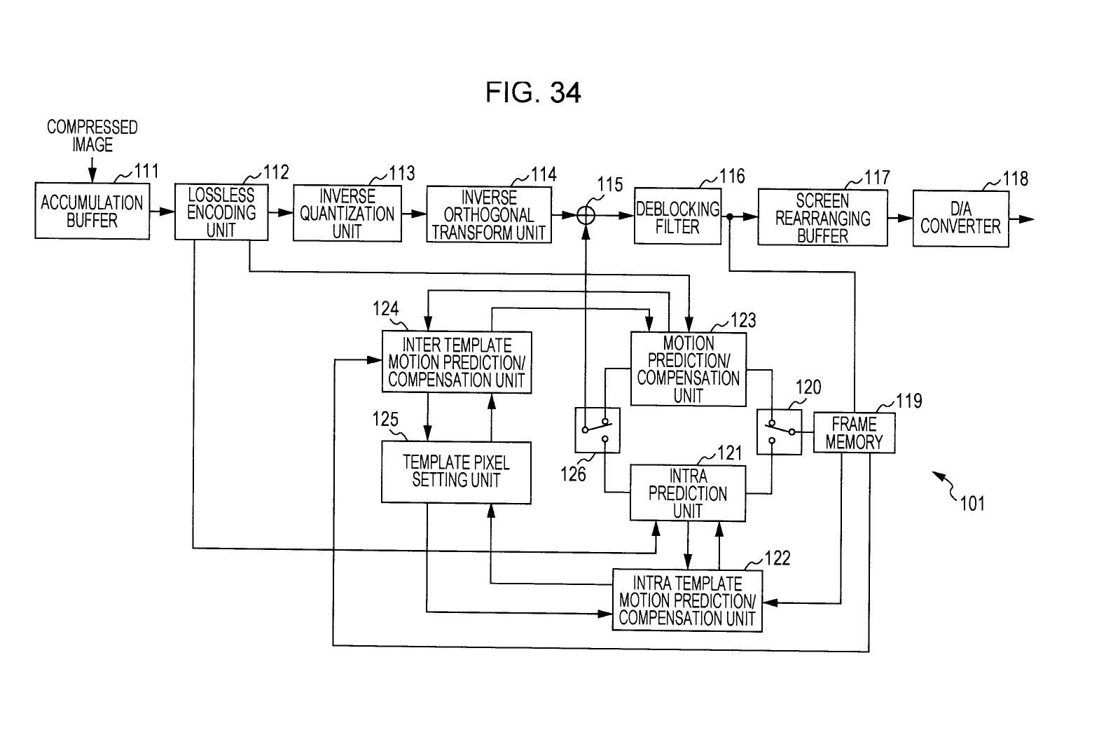

FIG. 34 illustrates the configuration of an embodiment of an image decoding device serving as an image processing device to which the present invention has been applied.

The image decoding device 101 is configured of an storage buffer 111, a lossless decoding unit 112, an inverse quantization unit 113, an inverse orthogonal transform unit 114, a computing unit 115, a deblocking filter 116, a screen rearranging buffer 117, a D/A converter 118, frame memory 119, a switch 120, an intra prediction unit 121, an intra template motion prediction/compensation unit 122, a motion prediction/compensation unit 123, an inter template motion prediction/compensation unit 124, a template pixel setting unit 125, and a switch 126.

Note that in the following, the intra template motion prediction/compensation unit 122 and inter template motion prediction/compensation unit 124 will be referred to as intra TP motion prediction/compensation unit 122 and inter TP motion prediction/compensation unit 124, respectively.

The storage buffer 111 stores compressed images transmitted thereto. The lossless decoding unit 112 decodes information encoded by the lossless encoding unit 16 in FIG. 4 that has been supplied from the storage buffer 111, with a format corresponding to the encoding format of the lossless encoding unit 16. The inverse quantization unit 113 performs inverse quantization of the image decoded by the lossless decoding unit 112, with a format corresponding to the quantization format of the quantization unit 15 in FIG. 4. The inverse orthogonal transform unit 114 performs inverse orthogonal transform of the output of the inverse quantization unit 113, with a format corresponding to the orthogonal transform format of the orthogonal transform unit 14 in FIG. 4.

The output of inverse orthogonal transform is added by the computing unit 115 with a prediction image supplied from the switch 126 and decoded. The deblocking filter 116 removes block noise in the decoded image, supplies to the frame memory 119 so as to be stored, and outputs to the screen rearranging buffer 117.

The screen rearranging buffer 117 performs rearranging of images. That is to say, the order of frames rearranged by the screen rearranging buffer 12 in FIG. 4 in the order for encoding, is rearranged to the original display order. The D/A converter 118 performs D/A conversion of images supplied from the screen rearranging buffer 117, and outputs to an unshown display for display.

The switch 120 reads out the image to be subjected to inter encoding and the image to be referenced from the frame memory 119, and outputs to the motion prediction/compensation unit 123, and also reads out, from the frame memory 119, the image to be used for intra prediction, and supplies to the intra prediction unit 121.

Information relating to the intra prediction mode or intra template prediction mode obtained by decoding header information is supplied to the intra prediction unit 121 from the lossless decoding unit 112. In the event that information is supplied indicating the intra prediction mode, the intra prediction unit 121 generates a prediction image based on this information. In the event that information is supplied indicating the intra template prediction mode, the intra prediction unit 121 supplies the address of the current block to be used for intra prediction to the intra TP motion prediction/compensation unit 122, so that motion prediction/compensation processing in the intra template prediction mode is performed.

The intra prediction unit 121 outputs the generated prediction image or the prediction image generated by the inter TP motion prediction/compensation unit 122 to the switch 126.

The TP motion prediction/compensation unit 122 calculates the addresses of adjacent pixels adjacent to the current block to be used as a template, from the address of the current block, and supplies this information to the template pixel setting unit 125.

Also, the inter TP motion prediction/compensation unit 122 performs motion prediction and compensation processing for the intra template prediction mode, the same as with the intra TP motion prediction/compensation unit 25 in FIG. 4. That is to say, the intra TP motion prediction/compensation unit 122 uses images from the frame memory 119 to perform motion prediction and compensation processing for the intra template prediction mode, and generates a prediction image. At this time, the intra TP motion prediction/compensation unit 122 uses a template made up of adjacent pixels to one of the decoded image or prediction image, set by the template pixel setting unit 125.

The prediction image generated by the motion prediction and compensation processing for the intra template prediction mode is supplied to the intra prediction unit 121.

Information obtained by decoding the header information (prediction mode information, motion vector information, reference frame information) is supplied from the lossless decoding unit 112 to the motion prediction/compensation unit 123. In the event that information which is the inter prediction mode is supplied, the motion prediction/compensation unit 123 subjects the image to motion prediction and compensation processing based on the motion vector information and reference frame information, and generates a prediction image. In the event that information which is the inter template prediction mode is supplied, the motion prediction/compensation unit 123 supplies the address of the current block to the inter TP motion prediction/compensation unit 124.

The inter TP motion prediction/compensation unit 124 calculates the addresses of adjacent pixels adjacent to the current block to be used as a template, from the address of the current block, and supplies this information to the template pixel setting unit 125.

The inter TP motion prediction/compensation unit 124 performs motion prediction and compensation processing in the inter template prediction mode, the same as the inter TP motion prediction/compensation unit 27 in FIG. 4. That is to say, the inter TP motion prediction/compensation unit 124 performs motion prediction and compensation processing in the inter template prediction mode from the frame memory 119 and the image to be referenced, and generates a prediction image. At this time, inter TP motion prediction/compensation unit 124 uses a template made up of pixels set by the template pixel setting unit 125 of one or the other of the decoded image or predicted image as a template.

The prediction image generated by the motion prediction/compensation processing in the inter template prediction mode is supplied to the motion prediction/compensation unit 123.

The template pixel setting unit 125 performs setting processing for adjacent pixels making up the template, the same as with the template pixel setting unit 28 in FIG. 4. That is to say, the template pixel setting unit 125 sets which of the decoded pixels of adjacent pixels or the prediction pixels of the adjacent pixels to use as the adjacent pixels of the template to be used for prediction of the current block. The template pixel setting unit 125 sets which adjacent pixels to use depending on whether the adjacent pixels of the current block belong within the macro block (or sub macro block) of the current block. The adjacent pixel information of the template that is set is supplied to the intra TP motion prediction/compensation unit 122 or inter TP motion prediction/compensation unit 124.

The switch 126 selects a prediction image generated by the motion prediction/compensation unit 123 or the intra prediction unit 121, and supplies this to the computing unit 115.

Note that in FIG. 34, the intra TP motion prediction/compensation unit 122 and inter TP motion prediction/compensation unit 124, which perform the processing relating to the intra or inter template prediction mode, are configured basically the same as with the intra TP motion prediction/compensation unit 25 and inter TP motion prediction/compensation unit 27 in FIG. 4. Accordingly, the functional block shown in FIG. 9 described above is also used for description of the intra TP motion prediction/compensation unit 122 and inter TP motion prediction/compensation unit 124.

That is to say, the intra TP motion prediction/compensation unit 122 and inter TP motion prediction/compensation unit 124 are configured of the block address calculating unit 41, motion prediction unit 42, and template matching prediction/compensation unit 43, the same as with the intra TP motion prediction/compensation unit 25.

Also, with the image encoding device 1 in FIG. 4, motion prediction/compensation processing was performed on all candidate prediction modes including template matching, and the mode determined to have the best efficiency of the current block according to cost functions and the like was selected and encoded. In contrast, with this image decoding device 101, processing for setting adjacent pixels of the current block is performed only in the event of a macro block or block encoded by template matching.

### [Description of Decoding Processing by Image Decoding Device]

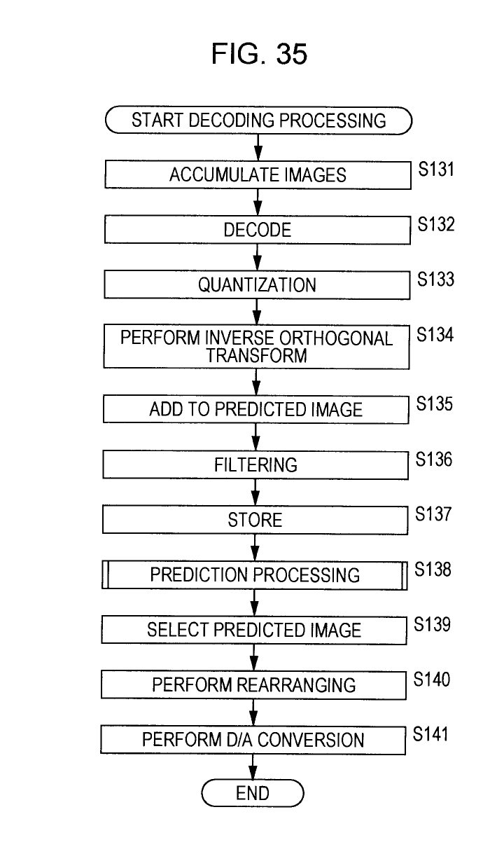

Next, the decoding processing which the image decoding device 101 executes will be described with reference to the flowchart in FIG. 35.

In step S131, the storage buffer 111 stores images transmitted thereto. In step S132, the lossless decoding unit 112 decodes compressed images supplied from the storage buffer 111. That is to say, the I picture, P pictures, and B pictures, encoded by the lossless encoding unit 16 in FIG. 4, are decoded.

At this time, motion vector information, reference frame information and prediction mode information (information representing intra prediction mode, intra template prediction mode, inter prediction mode, or inter template prediction mode) is also decoded.

That is to say, in the event that the prediction mode information is intra prediction mode information or inter template prediction mode information, the prediction mode information is supplied to the intra prediction unit 121. In the event that the prediction mode information is the inter prediction mode or inter template prediction mode, the prediction mode information is supplied to the motion prediction/compensation unit 123. At this time, in the event that there is corresponding motion vector information or reference frame information, that is also supplied to the motion prediction/compensation unit 123.

In step S133, the inverse quantization unit 113 performs inverse quantization of the transform coefficients decoded at the lossless decoding unit 112, with properties corresponding to the properties of the quantization unit 15 in FIG. 4. In step S134, the inverse orthogonal transform unit 114 performs inverse orthogonal transform of the transform coefficients subjected to inverse quantization at the inverse quantization unit 113, with properties corresponding to the properties of the orthogonal transform unit 14 in FIG. 4. Thus, difference information corresponding to the input of the orthogonal transform unit 14 (output of the computing unit 13) in FIG. 4 has been decoded.

In step S135, the computing unit 115 adds to the difference information, a prediction image selected in later-described processing of step S141 and input via the switch 126. Thus, the original image is decoded. In step S136, the deblocking filter 116 performs filtering of the image output from the computing unit 115. Thus, block noise is eliminated. In step S137, the frame memory 119 stores the filtered image.

In step S138, the intra prediction unit 121, intra TP motion prediction/compensation unit 122, motion prediction/compensation unit 123, or inter TP motion prediction/compensation unit 124, each perform image prediction processing in accordance with the prediction mode information supplied from the lossless decoding unit 112.

That is to say, in the event that intra prediction mode information is supplied from the lossless decoding unit 112, the intra prediction unit 121 performs intra prediction processing in the intra prediction mode. In the event that intra template prediction mode information is supplied from the lossless decoding unit 112, the intra TP motion prediction/compensation unit 122 performs motion prediction/compensation processing in the inter template prediction mode. Also, in the event that inter prediction mode information is supplied from the lossless decoding unit 112, the motion prediction/compensation unit 123 performs motion prediction/compensation processing in the inter prediction mode. In the event that inter template prediction mode information is supplied from the lossless decoding unit 112, the inter TP motion prediction/compensation unit 124 performs motion prediction/compensation processing in the inter template prediction mode.

At this time, the intra TP motion prediction/compensation unit 122 or inter TP motion prediction/compensation unit 124 performs template prediction mode processing using the template made up of adjacent pixels set to one of the decoded image or prediction image by the template pixel setting unit 125.

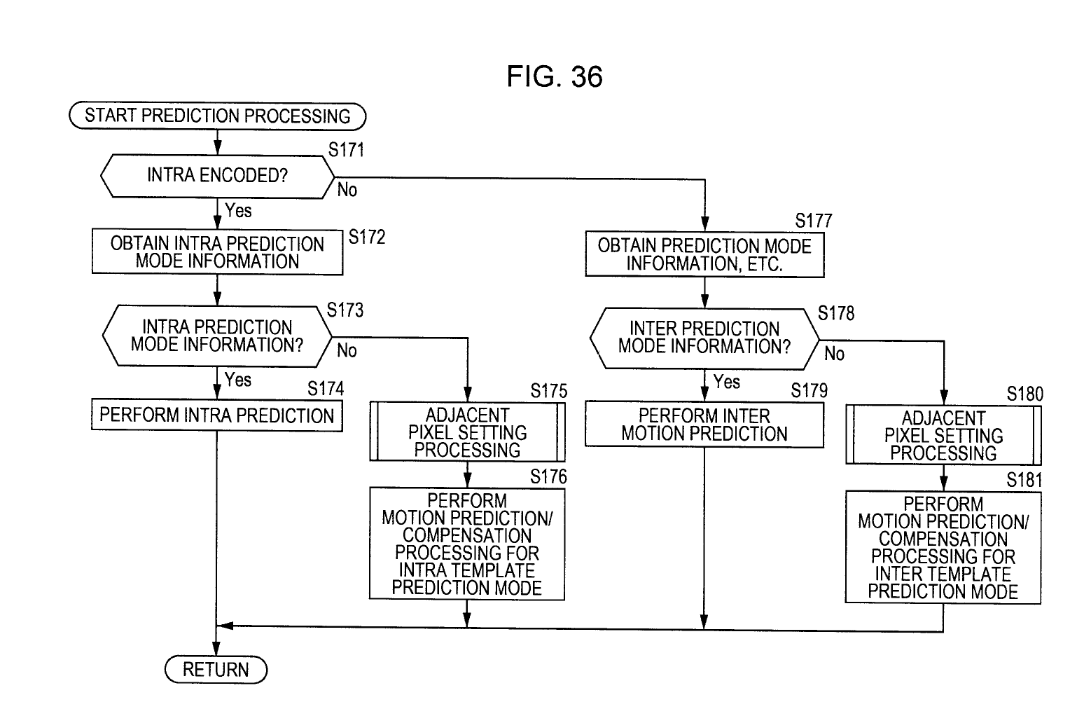

Details of the prediction processing in step S138 will be described later with reference to FIG. 36. Due to this processing, a prediction image generated by the intra prediction unit 121, a prediction image generated by the intra TP motion prediction/compensation unit 122, a prediction image generated by the motion prediction/compensation unit 123, or a prediction image generated by the inter TP motion prediction/compensation unit 124, is supplied to the switch 126.

In step S139, the switch 126 selects a prediction image. That is to say, a prediction image generated by the intra prediction unit 121, a prediction image generated by the intra TP motion prediction/compensation unit 122, a prediction image generated by the motion prediction/compensation unit 123, or a prediction image generated by the inter TP motion prediction/compensation unit 124, is supplied. Accordingly, the supplied prediction image is selected and supplied to the computing unit 115, and added to the output of the inverse orthogonal transform unit 114 in step S134 as described above.

In step S140, the screen rearranging buffer 117 performs rearranging. That is to say, the order for frames rearranged for encoding by the screen rearranging buffer 12 of the image encoding device 1 is rearranged in the original display order.

In step S141, the D/A converter 118 performs D/A conversion of the image from the screen rearranging buffer 117. This image is output to an unshown display, and the image is displayed.

### [Description of Prediction Processing]

Next, the prediction processing of step S138 in FIG. 35 will be described with reference to the flowchart in FIG. 36.

In step S171, the intra prediction unit 121 determines whether or not the current block has been subjected to intra encoding. Intra prediction mode information or intra template prediction mode information is supplied from the lossless decoding unit 112 to the intra prediction unit 121. In accordance therewith, the intra prediction unit 121 determines in step S171 that the current block has been intra encoded, and the processing proceeds to step S172.

In step S172, the intra prediction unit 121 obtains the intra prediction mode information or intra template prediction mode information, and in step S173 determines whether or not the intra prediction mode. In the event that determination is made in step S173 that the intra prediction mode, the intra prediction unit 121 performs intra prediction in step S174.

That is to say, in the event that the object of processing is an image to be subjected to intra processing, necessary images are read out from the frame memory 119, and supplied to the intra prediction unit 121 via the switch 120. In step S174, the intra prediction unit 121 performs intra prediction following the intra prediction mode information obtained in step S172, and generates a prediction image. The generated prediction image is output to the switch 126.

On the other hand, in the event that intra template prediction mode information is obtained in step S172, determination is made in step S173 that this is not intra prediction mode information, and the processing advances to step S175.

In the event that the image to be processed is an image to be subjected to intra template prediction processing, the address of the current block to be processed is supplied from the intra prediction unit 121 to the intra TP motion prediction/compensation unit 122 and is stored in the current block address buffer 41.

Based on this address information, in step S175 the intra TP motion prediction/compensation unit 122 and the template pixel setting unit 125 perform adjacent pixel setting processing which is processing for setting adjacent pixels of the template for the current block to be processed. Details of this template pixel setting processing are basically the same as the processing described above with reference to FIG. 32, so description thereof will be omitted. Due to this processing, which of the decoded image or prediction image to use as pixels configuring a template as to a current block in the intra template prediction mode is set.

In step S176, the template matching prediction/compensation unit 43 of the intra TP motion prediction/compensation unit 122 performs motion prediction and compensation processing in the intra template prediction mode. That is to say, the current block address from the current block address buffer 41, the template address from the template address calculating unit 42, and adjacent pixel information from the template pixel setting unit 125, are supplied to the template matching prediction/compensation unit 43. The template matching prediction/compensation unit 43 references these information and uses the template regarding which the adjacent pixels have been set by the template pixel setting unit 125 to perform the motion prediction in the intra template prediction mode described above with reference to FIG. 1, and generates a prediction image.

Specifically, the template matching prediction/compensation unit 43 reads a reference image of a predetermined search range within the same frame, from the frame memory 119. Also, the template matching prediction/compensation unit 43 makes reference to the template address and reads the pixel values of the adjacent pixels of the template regarding which using decoded pixels has been set by the template pixel setting unit 125, from the frame memory 119. Further, the template matching prediction/compensation unit 43 makes reference to the template address and reads the pixel values of the adjacent pixels of the template regarding which using prediction pixels has been set by the template pixel setting unit 125, from the internal buffer.

The template matching prediction/compensation unit 43 then searches within the predetermined search range within the same frame for a region where the correlation with the template of which the adjacent pixels have been set by the template pixel setting unit 125 are the highest. The template matching prediction/compensation unit 43 takes the block corresponding to the searched region as a block corresponding to the current block, and generates a prediction image based on the pixel values of that block. This prediction image is stored in the internal buffer, and also output to the switch 126 via the intra prediction unit 121.

On the other hand, in the event that determination is made in step S171 that this is not intra encoded, the processing advances to step S177. In step S177, the motion prediction/compensation unit 123 obtains prediction mode information and the like from the lossless decoding unit 112.

In the event that the image which is an object of processing is an image to be subjected to inter processing, the inter prediction mode information, reference frame information, and motion vector information, from the lossless decoding unit 112, are supplied to the motion prediction/compensation unit 123. In this case, in step S177 the motion prediction/compensation unit 123 obtains the inter prediction mode information, reference frame information, and motion vector information.

Then, in step S178, the motion prediction/compensation unit 123 determines whether or not the prediction mode information from the lossless decoding unit 112 is inter prediction mode information. In the event that determination is made in step S178 that this is inter prediction mode information, the processing advances to step S179.

In step S179, the motion prediction/compensation unit 123 performs inter motion prediction. That is to say, in the event that the image which is an object of processing is an image which is to be subjected to inter prediction processing, the necessary images are read out from the frame memory 119 and supplied to the motion prediction/compensation unit 123 via the switch 120. In step S179, the motion prediction/compensation unit 123 performs motion prediction in the inter prediction mode based on the motion vector obtained in step S177, and generates a prediction image. The generated prediction image is output to the switch 126.

On the other hand, in the event that inter template prediction mode information is obtained in step S177, in step S178 determination is made that this is not inter prediction mode information, and the processing advances to step S180.

In the event that the image which is an object of processing is an image to be subjected to inter template prediction processing, the address of the current block to be processed is supplied from the motion prediction/compensation unit 123 to the inter TP motion prediction/compensation unit 124, and stored in the current block address buffer 41.

Based on this address information, in step S180 the inter TP motion prediction/compensation unit 124 and template pixel setting unit 125 perform adjacent pixel setting processing which is processing for setting adjacent pixels of the template, as to the current block to be processed. Note that details of this adjacent pixel setting processing is basically the same processing as the processing described above with reference to FIG. 32, so description thereof will be omitted. Due to this processing, setting is made regarding which to the decoded image or prediction image is to be used as the adjacent pixels making up the template as to the current block in the inter template prediction mode.

In step S181, the template matching prediction/compensation unit 43 of the inter TP motion prediction/compensation unit 124 performs motion prediction and compensation processing in the intra template prediction mode. That is to say, the current block address from the current block address buffer 41, the template address from the template address calculating unit 42, and adjacent pixel information from the template pixel setting unit 125, are supplied to the template matching prediction/compensation unit 43. The template matching prediction/compensation unit 43 references these information and uses the template regarding which the adjacent pixels have been set by the template pixel setting unit 125 to perform the motion prediction in the inter template prediction mode described above with reference to FIG. 2, and generates a prediction image.

Specifically, the template matching prediction/compensation unit 43 reads a reference image of a predetermined search range within the same frame, from the frame memory 119. Also, the template matching prediction/compensation unit 43 makes reference to the template address and reads the pixel values of the adjacent pixels of the template regarding which using decoded pixels has been set by the template pixel setting unit 125, from the frame memory 119. Further, the template matching prediction/compensation unit 43 makes reference to the template address and reads the pixel values of the adjacent pixels of the template regarding which using prediction pixels has been set by the template pixel setting unit 125, from the internal buffer.

The template matching prediction/compensation unit 43 then searches within the predetermined search range within the same frame for a region where the correlation with the template of which the adjacent pixels have been set by the template pixel setting unit 125 are the highest. The template matching prediction/compensation unit 43 takes the block corresponding to the searched region as a block corresponding to the current block, and generates a prediction image based on the pixel values of that block. The generated prediction image is stored in the internal buffer, and also output to the switch 126 via the motion prediction/compensation unit 123.

As described above, the pixel values of not only a decoded image but also a prediction image are used as adjacent pixels of a template as to a current block of the macro block (sub macro block). Thus, processing for each block within the macro block (sub macro block) can be realized by pipeline processing. Accordingly, the prediction efficiency in the template prediction mode can be improved.

Note that while description has been made regarding an example of performing template matching in which prediction is performed using adjacent pixels as a template in the above description, the present invention can be applied in the same way to intra prediction performing prediction using adjacent pixels.

### 2. Second Embodiment

### [Other Configuration Example of Image Encoding Device]

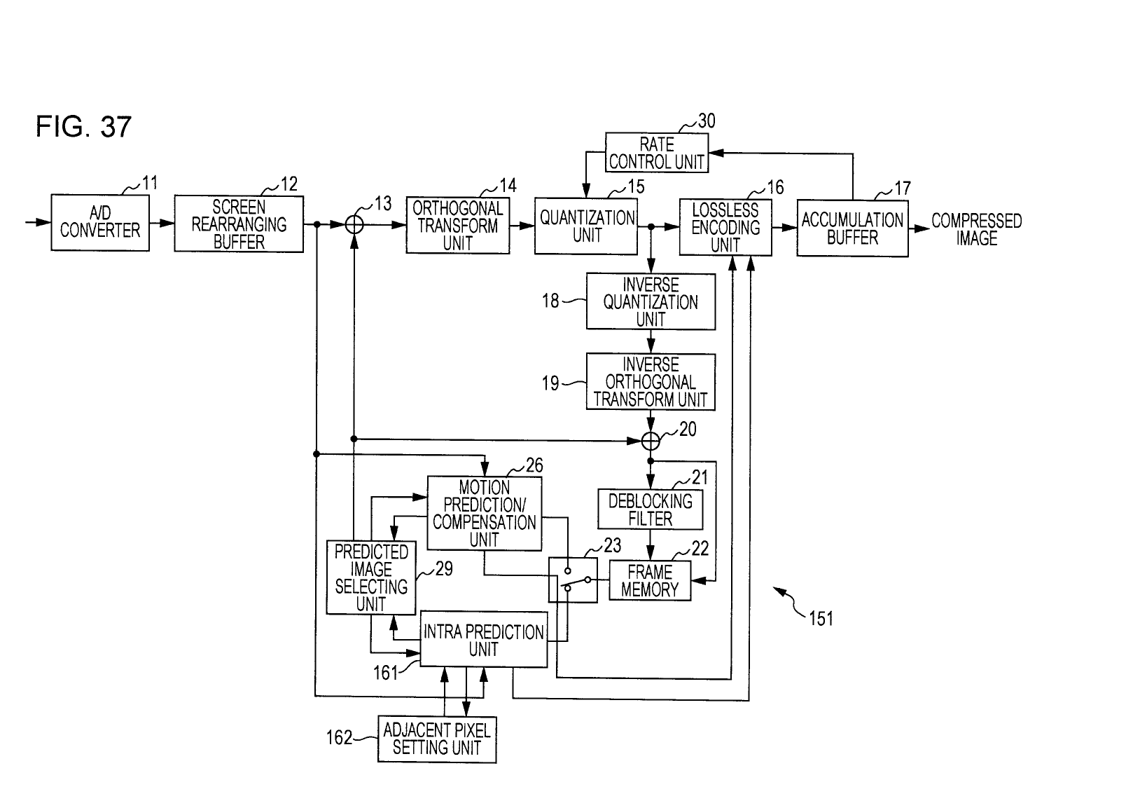

FIG. 37 illustrates a configuration of another embodiment of an image encoding device serving as an image processing device to which the present invention has been applied.

An image encoding device 151 is in common with the image encoding device 1 in FIG. 4 with regard to the point of including an A/D converter 11, a screen rearranging buffer 12, a computing unit 13, an orthogonal transform unit 14, a quantization unit 15, a lossless encoding unit 16, an storage buffer 17, an inverse quantization unit 18, an inverse orthogonal transform unit 19, a computing unit 20, a deblocking filter 21, a frame memory 22, a switch 23, a motion prediction/compensation unit 26, a predicted image selecting unit 29, and a rate control unit 30.

Also, the image encoding device 151 differs from the image encoding device 1 in FIG. 4 with regard to the points that the intra prediction unit 24, intra TP motion prediction/compensation unit 25, inter TP motion prediction/compensation unit 27, and template pixel setting unit 28 have been removed, and that an intra prediction unit 161 and an adjacent pixel setting unit 162 have been added.

That is to say, with the example in FIG. 37, the intra prediction unit 161 calculates the address of adjacent pixels adjacent to the current block from the information (address) of the current block for intra prediction, and supplies this information to the adjacent pixel setting unit 162.

The intra prediction unit 161 reads the pixel values of the adjacent pixels set by the adjacent pixel setting unit 162 from the frame memory 22 via the switch 23, uses these to perform intra prediction processing for all candidate intra prediction modes, and generates a prediction image.

The intra prediction unit 161 further uses the image for intra prediction that has been read out from the screen rearranging buffer 12, and calculates cost function values for all candidate intra prediction modes. The intra prediction unit 161 decides upon the prediction mode which gives the smallest value out of the calculated cost function values as the optimal intra prediction mode.

The adjacent pixel setting unit 162 performs basically the same processing as with the template pixel setting unit 28 in FIG. 4, the only difference being whether the adjacent pixels to be set are pixels used for intra prediction or pixels used for template matching prediction. That is to say, the adjacent pixel setting unit 162 sets which of decoded pixels of the adjacent pixels or prediction pixels of the adjacent pixels to use as the adjacent pixels for use in intra prediction of the current block. With the adjacent pixel setting unit 162 as well, which adjacent pixels to use is set depending on whether or not the adjacent pixels for the current block belong within the macro block (or sub macro block).

Note that in the same way as with the template pixel setting unit 28, whether or not adjacent pixels of the current block belong within the macro block depend on the position of the current block within the macro block. That is to say, with the adjacent pixel setting unit 162 as well, which adjacent pixels to use is set in accordance with the position of the current block within the macro block.

### [Detailed Configuration Example of Intra Prediction Unit]

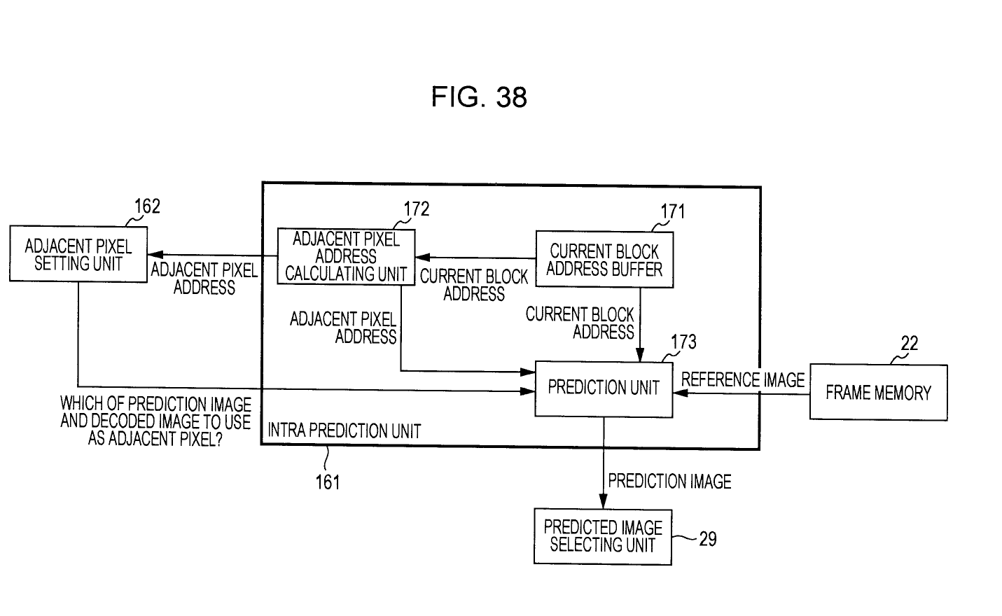

FIG. 38 is a block diagram illustrating a detailed configuration example of an intra prediction unit.

In the case of FIG. 38, the intra prediction unit 161 is configured of a current block address buffer 171, an adjacent pixel address calculating unit 172, and a prediction unit 173. Note that while not shown in the drawing, the intra prediction image from the screen rearranging buffer 12 to the prediction unit 173.

The current block address buffer 171 stores the address of the current block for prediction. The adjacent pixel address calculating unit 172 uses the current block address stored in the current block address buffer 171 to calculate the address of adjacent pixels used for intra prediction, which is supplied to the adjacent pixel setting unit 162 and prediction unit 173 as an adjacent pixel address.

The adjacent pixel setting unit 162 decodes which of the decoded image and prediction image to use for intra prediction, based on the adjacent pixel address from the adjacent pixel address calculating unit 172, and supplies this information to the prediction unit 173.

The prediction unit 173 reads out the current block address stored in the current block address buffer 171. The prediction unit 173 is supplied with the image for intra prediction from the screen rearranging buffer 12, the adjacent pixel address from the adjacent pixel address calculating unit 172, and the information of adjacent pixels from the adjacent pixel setting unit 162.

The prediction unit 173 reads out the reference image from the frame memory 22, performs intra processing using the adjacent pixels set by the adjacent pixel setting unit 162, and generates a prediction image. This prediction image is stored in an unshown internal buffer.

Specifically, the prediction unit 173 makes reference to the adjacent pixel address to read the pixel values of the adjacent pixels regarding which the adjacent pixel setting unit 162 has set to use the decoded image, from the frame memory 22. Also, the prediction unit 173 makes reference to the adjacent pixel address to read the pixel values of the adjacent pixels regarding which the adjacent pixel setting unit 162 has set to use the prediction image, from the internal memory. Out of the reference images read out from the frame memory 22, the prediction unit 173 then uses the adjacent pixels read out from the frame memory 22 or the internal buffer to perform intra prediction, and a prediction image is obtained.

Also, the prediction unit 173 uses the image for intra prediction from the screen rearranging buffer 12 and calculates cost function values for the intra prediction modes. Of the generated prediction images, that with the smallest cost function value is stored in an unshown internal buffer, and is also supplied to the prediction image selecting unit 29 along with the cost function value, as the optimal intra prediction mode.

### [Description of Another Example of Prediction Processing]

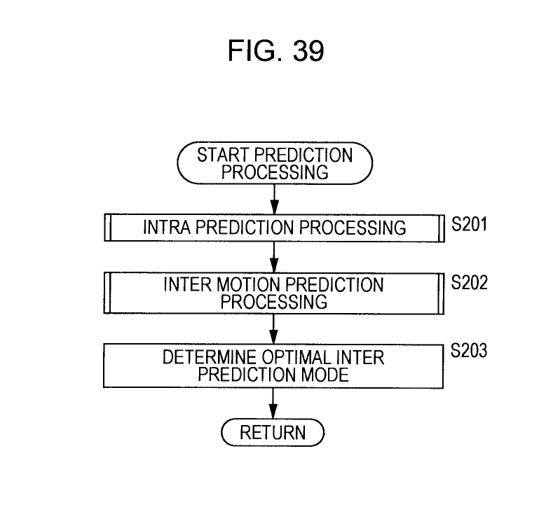

Next, prediction processing of the image encoding device 151 will be described with reference to the flowchart in FIG. 39. Note that this prediction processing is another example of the prediction processing in FIG. 15 describing the prediction processing of step S21 in FIG. 14. That is to say, the encoding processing of the image encoding device 151 is basically the same as the encoding processing of the image encoding device 1 described above with reference to FIG. 14, so description thereof will be omitted.

In the event that the image to be processed that is supplied from the screen rearranging buffer 12 is an image of a block regarding which intra processing is to be performed, an image which has already been decoded to be referenced is read out from the frame memory 22, and supplied to the intra prediction unit 161 via the switch 23. In step S201, the intra prediction unit 161 performs intra prediction of pixels of the block to be processed, in all candidate intra prediction modes. At this time, the adjacent pixels regarding which the adjacent pixel setting unit 162 has set to the decoded image or prediction image are used.

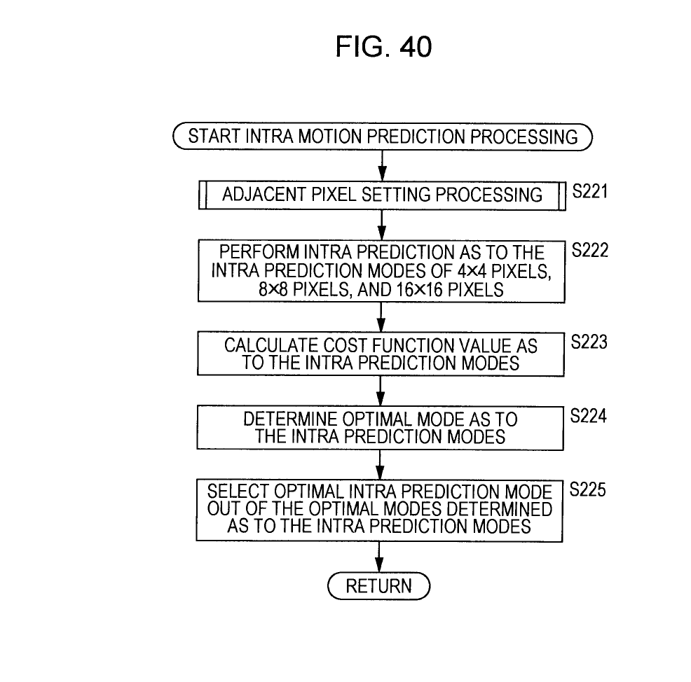

Details of the intra prediction processing in step S201 will be described later with reference to FIG. 40. Due to this processing, the adjacent pixels to be used for intra prediction are set, intra prediction processing is performed on all candidate intra prediction modes using the pixel values of the adjacent pixels that have been set, and cost function values are calculated. The optimal intra prediction mode is selected based on the calculated cost function values, and the prediction image of the optimal intra prediction mode generated by intra prediction is supplied to the prediction image selecting unit 29.

In the event that the image to be processing that is supplied from the screen rearranging buffer 12 is an image of a block regarding which inter processing is to be performed, an image to be referenced is read out from the frame memory 22, and supplied to the motion prediction/compensation unit 26 via the switch 23. Based on these images, the motion prediction/compensation unit 26 performs inter motion prediction processing in step S202. That is to say, the motion prediction/compensation unit 26 makes reference to the image supplied from the frame memory 22 and performs motion prediction processing for all candidate inter prediction modes.

The details of the inter motion prediction processing in step S202 have already been described above with reference to FIG. 29, so description thereof will be omitted. Due to this processing, motion prediction processing is performed in all candidate inter prediction modes, prediction images are generated, and cost function values are calculated for all candidate inter prediction modes.

In step S203, out of the cost function values as to the inter prediction modes calculated in step S203, the motion prediction/compensation unit 26 decides upon the prediction mode which provides the smallest value as the optimal inter prediction mode. The motion prediction compensation/prediction unit 75 then supplies the generated prediction image, and cost function value of the optimal inter prediction mode, to the prediction image selecting unit 29.

### [Description of Other Example of Intra Prediction Processing]

Next, the intra prediction in step S201 in FIG. 39 will be described with reference to the flowchart in FIG. 40.

The current block address buffer 41 of the intra prediction unit 161 stores the current block address. In step S221, the intra prediction unit 161 and adjacent pixel setting unit 162 perform adjacent pixel setting processing which is processing for setting adjacent pixels to be used for the intra prediction. Details of this adjacent pixel setting processing are basically the same processing as with the processing described above with reference to FIG. 32, so description thereof will be omitted.

Note that in the same as that description has been made with FIG. 32 dividing the template into the upper region, upper left region, and left region, the adjacent pixels used for intra prediction can also be divided into the upper adjacent pixels, upper left adjacent pixel, and left adjacent pixels.

Due to this processing, setting is performed regarding the current block for the intra prediction mode, whether the adjacent pixels to be used for the prediction thereof are the decoded image or prediction image.

In step S222, the prediction unit 171 of the intra prediction unit 161 performs intra prediction in each intra prediction mode of 4×4 pixels, 8×8 pixels, and 16×16 pixels for the luminance signals described above. That is to say, the prediction unit 171 reads out the adjacent pixels set by the adjacent pixel setting unit 162 from the unshown internal buffer if a prediction image, and from the frame memory 22 if a decoded image. The prediction unit 171 performs intra prediction of the block to be processed using the pixel values of the adjacent pixels that have been read out.

In step S223, the prediction unit 171 calculates the cost function values for each of the intra prediction modes of 4×4 pixels, 8×8 pixels, and 16×16 pixels, using the above-described Expressions (71) or (72).

In step S224, the prediction unit 171 decides the optimal mode for each of the intra prediction modes of 4×4 pixels, 8×8 pixels, and 16×16 pixels.

In step S225, the prediction unit 171 selects the optimal inter prediction mode from the optimal modes decided for each of the intra prediction modes of 4×4 pixels, 8×8 pixels, and 16×16 pixels, based on the cost function values calculated in step S223. The prediction image generated by intra prediction in the optimal intra prediction mode that has been selected is supplied to the prediction image selecting unit 29 with the cost function value thereof.

Also, the prediction image of this optimal intra prediction mode is stored in the internal buffer, and is used for prediction processing of the next current block, for example.

### [Another Configuration Example of Image Decoding Device]

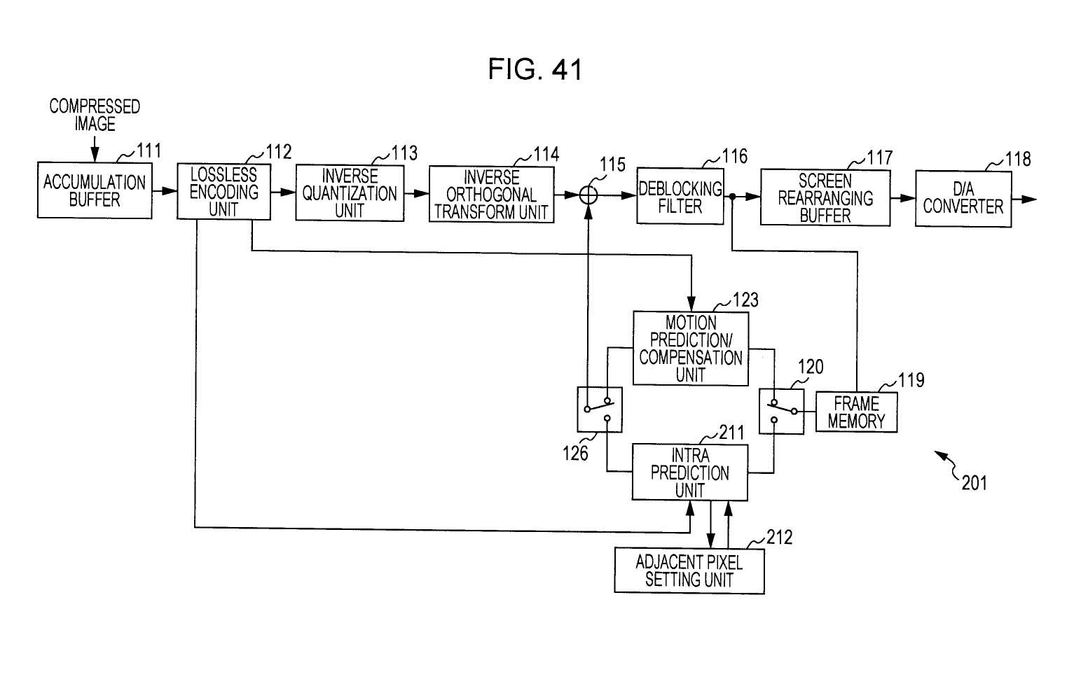

FIG. 41 illustrates the configuration of another embodiment of an image decoding device serving as an image processing device to which the present invention has been applied.

An image decoding device 201 is in common with the image decoding device 101 shown in FIG. 34 regarding the point of including an storage buffer 111, a lossless decoding unit 112, an inverse quantization unit 113, an inverse orthogonal transform unit 114, a computing unit 115, a deblocking filter 116, a screen rearranging buffer 117, a D/A converter 118, frame memory 119, a switch 120, a motion prediction/compensation unit 123, and a switch 126.

The image decoding device 201 differs from the image decoding device 101 shown in FIG. 34 with regard to the points that the intra prediction unit 121, intra template motion prediction/compensation unit 122, inter template motion prediction/compensation unit 124, and template pixel setting unit 125 have been removed, and that an intra prediction unit 211 and adjacent pixel setting unit 212 have been added.

That is to say, with the example in FIG. 41, the intra prediction unit 211 receives intra prediction mode information from the lossless decoding unit 112, and based on that information, calculates the address of adjacent pixels adjacent to the current block from the information (address) of the current block for intra prediction. The intra prediction unit 211 supplies this information to the adjacent pixel setting unit 212.

The intra prediction unit 211 reads out the pixel values of the adjacent pixels set by the adjacent pixel setting unit 212 from the frame memory 119 or an unshown internal buffer, via the switch 120. The intra prediction unit 211 uses these to perform intra prediction processing of the intra prediction mode which the information from the lossless decoding unit 112 indicates. The prediction image generated by this intra prediction processing is output to the switch 126.

The adjacent pixel setting unit 212 performs basically the same processing as the template pixel setting unit 125 in FIG. 34, the only difference being whether the set adjacent pixels are pixels used for intra prediction or pixels used for template matching prediction. That is to say, the adjacent pixel setting unit 212 sets using one of the decoded pixels of the adjacent pixels or the predicted pixels of the adjacent pixels as the adjacent pixels to be used for prediction of the current block. At the adjacent pixel setting unit 212, which adjacent pixels are to be used is set depending on whether or not the adjacent pixels of the current block belong within the macro block (or sub macro block). The information of the set adjacent pixels is supplied to the intra prediction unit 211.

Note that in FIG. 41, the intra prediction unit 211 is configured basically in the same way as the intra prediction unit 161 in FIG. 38. Accordingly, the functional block shown in FIG. 38 described above is also used for description of intra prediction unit 211.

That is to say, intra prediction unit 211 is also configured of the current block address buffer 171, adjacent pixel address calculating unit 172, and prediction unit 173, the same as with the intra prediction unit 161. Note that in this case, the intra prediction mode information from the lossless decoding unit 112 is supplied to the prediction unit 173.

### [Description of Other Example of Prediction Processing]

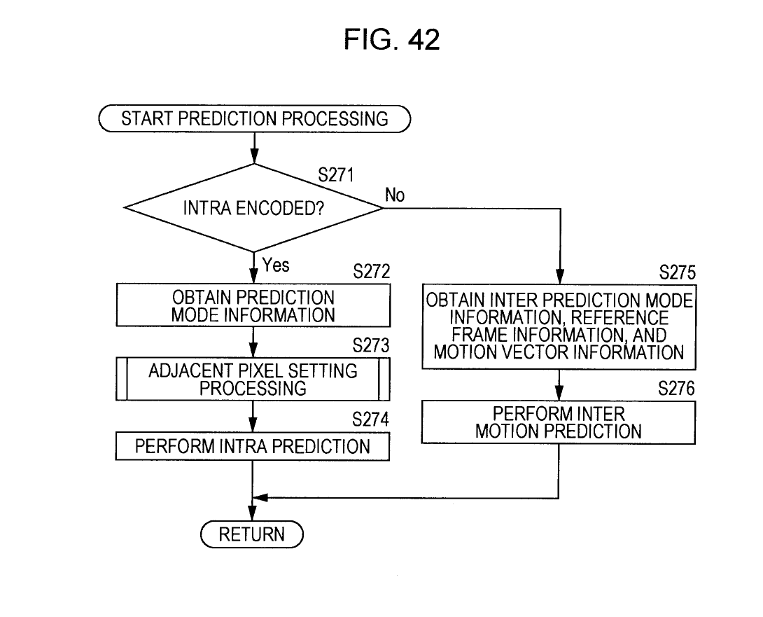

Next, the prediction processing of the image decoding device 201 will be described with reference to the flowchart in FIG. 42. Note that this prediction processing is another example of the prediction processing in FIG. 36 describing the prediction processing in step S138 in FIG. 35. That is to say, the prediction processing of the image decoding device 201 is basically the same as the decoding processing of the image decoding device 101 described above with reference to FIG. 35, so description thereof will be omitted.

In step S271, the prediction unit 173 of the intra prediction unit 211 determines whether the current block is intra encoded. Intra prediction information or intra template prediction mode information from the lossless decoding unit 112 is supplied to the prediction unit 173. Accordingly, in step S271 the prediction unit 173 determines that the current block has been intra encoded, and the processing advances to step S272.

In step S272, the prediction unit 173 obtains the intra prediction information or intra template prediction mode information. Also, the current block address buffer 171 of the intra prediction unit 211 stores the current block address.

In step S273, the adjacent pixel address calculating unit 172 and adjacent pixel setting unit 212 perform adjacent pixel setting processing which is processing for setting the adjacent pixels used for the intra prediction. The details of this adjacent pixel setting processing are basically the same processing as the processing described above with reference to FIG. 32, so description thereof will be omitted.

Note that in the same as that description has been made with FIG. 32 dividing the template into the upper region, upper left region, and left region, the adjacent pixels used for intra prediction can also be divided into the upper adjacent pixels, upper left adjacent pixel, and left adjacent pixels, as described above with the example in FIG. 40.

Due to this processing, setting is performed regarding the current block for the intra prediction mode, whether the adjacent pixels to be used for the prediction thereof are the decoded image or prediction image.

In step S274, the current block address buffer 171 performs intra prediction following the intra prediction mode information obtained in step S272, and generates a prediction image. At this time, the adjacent pixels of one of the decoded image or prediction image set in step S273 are read out from the internal buffer or frame memory 119 and used. The generated prediction image is stored in the internal buffer, and also output to the switch 126.

On the other hand, in the event that determination is made in step S271 that intra encoding has not been performed, the processing advances to step S275. In step S275 the motion prediction/compensation unit 123 obtains prediction mode information and the like from the lossless decoding unit 112.

In the event that the image to be processed is an image to be inter-processed, inter prediction mode information, reference frame information, and motion vector information, from the lossless decoding unit 112, is supplied to the motion prediction/compensation unit 123. In this case, in step S275 the motion prediction/compensation unit 123 obtains the inter prediction mode information, reference frame information, and motion vector information.

In step S276, the motion prediction/compensation unit 123 performs inter motion prediction. That is to say, in the event that the image to be processed is an image for inter prediction processing, the necessary image is read out from the frame memory 119, and supplied to the motion prediction/compensation unit 123 via the switch 120. In step S179, the motion prediction/compensation unit 123 performs motion prediction in the inter prediction mode, and generates a prediction image. The generated prediction image is output to the switch 126.

Thus, pixel values of a prediction image, rather than a decoded image, are used as pixel values of adjacent pixels to be sued for prediction of the current block of a macro block, in accordance to whether or not the adjacent pixels belong to the macro block. Thus, processing on the blocks within the macro block (sub macro block) can be realized by pipeline processing. Accordingly, the processing speed in the intra prediction mode can also be improved.

Note that with the present invention, application to intra 4×4 prediction and intra 8×8 prediction processing, where blocks of a size smaller than macro blocks are the increment of processing, can be performed.

Description has been made so far with the H.264/AVC format employed as a basic encoding format, but other encoding formats/decoding formats performing prediction processing using adjacent pixels, such as inter/intra template matching processing, intra prediction processing, and so forth, may be employed.

Also, the present invention is not restricted to a case of the macro block size being 16×16 pixels, and is applicable to an encoding device and decoding device based on an encoding format corresponding to macro block size of an optional size, such as described in NPL 3.

Further, description has been made above regarding an example where processing within macro blocks is performed in raster scan order, but the processing within macro blocks may be other than in raster scan order.

Note that the present invention may be applied to an image encoding device and an image decoding device used at the time of receiving image information (bit streams) compressed by orthogonal transform such as discrete cosine transform or the like and motion compensation via a network medium such as satellite broadcasting, a cable television, the Internet, a cellular phone, or the like, for example, as with MPEG, H.26x, or the like. Also, the present invention may be applied to an image encoding device and an image decoding device used at the time of processing image information on storage media such as an optical disc, a magnetic disk, and flash memory.

The above-described series of processing may be executed by hardware, or may be executed by software. In the event of executing the series of processing by software, a program making up the software thereof is installed in a computer. Here, examples of the computer include a computer built into dedicated hardware, and a general-purpose personal computer whereby various functions can be executed by various types of programs being installed thereto.

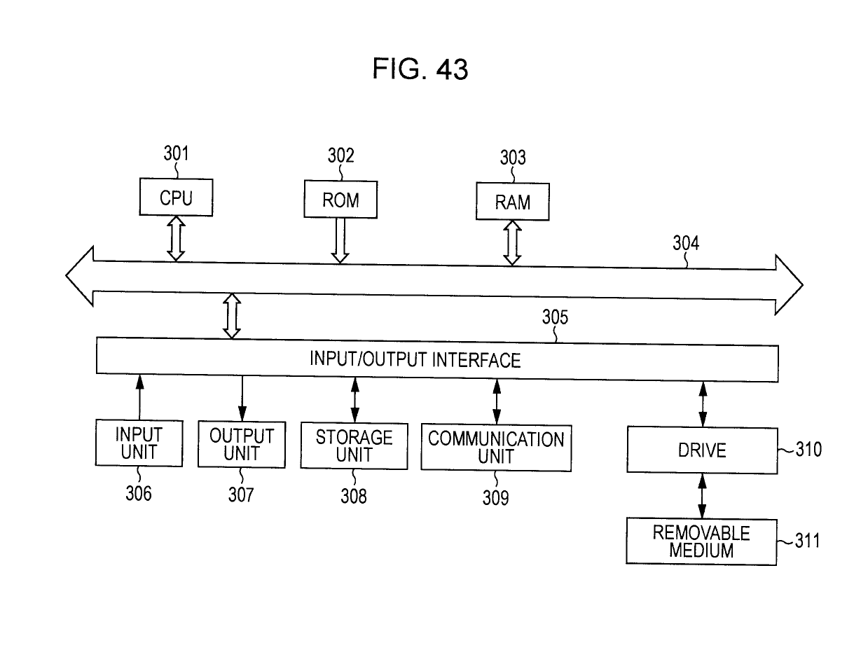

FIG. 43 is a block diagram illustrating a configuration example of the hardware of a computer which executes the above-described series of processing using a program.

With the computer, a CPU (Central Processing Unit) 301, ROM (Read Only Memory) 302, and RAM (Random Access Memory) 303 are mutually connected by a bus 304. Further, an input/output interface 305 is connected to the bus 304. An input unit 306, an output unit 307, a storage unit 308, a communication unit 309, and a drive 310 are connected to the input/output interface 305.

The input unit 306 is made up of a keyboard, a mouse, a microphone, and so forth. The output unit 307 is made up of a display, a speaker, and so forth. The storage unit 308 is made up of a hard disk, nonvolatile memory, and so forth. The communication unit 309 is made up of a network interface and so forth. The drive 310 drives a removable medium 311 such as a magnetic disk, an optical disc, a magneto-optical disk, semiconductor memory, or the like.

With the computer thus configured, for example, the CPU 301 loads a program stored in the storage unit 308 to the RAM 303 via the input/output interface 305 and bus 304, and executes the program, and accordingly, the above-described series of processing is performed.

The program that the computer (CPU 301) executes may be provided by being recorded in the removable medium 311 serving as a package medium or the like, for example. Also, the program may be provided via a cable or wireless transmission medium such as a local area network, the Internet, or digital broadcasting.

With the computer, the program may be installed in the storage unit 308 via the input/output interface 305 by mounting the removable medium 311 on the drive 310. Also, the program may be received by the communication unit 309 via a cable or wireless transmission medium, and installed in the storage unit 308. Additionally, the program may be installed in the ROM 302 or storage unit 308 beforehand.

Note that the program that the computer executes may be a program wherein the processing is performed in the time sequence along the sequence described in the present Specification, or may be a program wherein the processing is performed in parallel or at necessary timing such as when call-up is performed.

The embodiments of the present invention are not restricted to the above-described embodiment, and various modifications may be made without departing from the essence of the present invention.

### REFERENCE SIGNS LIST

1 image encoding device
16 lossless encoding unit
24 intra prediction unit
25 intra TP motion prediction/compensation unit
26 motion prediction/compensation unit
27 inter TP motion prediction/compensation unit
28 template pixel setting unit
41 current block address buffer
42 template address calculating unit
43 template matching prediction/compensation unit
101 image decoding device
112 lossless decoding unit
121 intra prediction unit
122 intra template motion prediction/compensation unit
123 motion prediction/compensation unit
124 inter template motion prediction/compensation unit
125 template pixel setting unit
126 switch
151 image encoding device
161 intra prediction unit
162 adjacent pixel setting unit
171 current block address buffer
172 adjacent pixel address calculating unit
173 prediction unit
201 image decoding device
211 intra prediction unit
212 adjacent pixel setting unit

1-16. (canceled)

17. An image processing device comprising:
prediction means configured to, using adjacent pixels adjacent to a block making up a predetermined block of an image, detect pixels with great correlation to said adjacent pixels from decoded pixels, and take an image including pixels adjacent to said pixels that have been detected, as a prediction image of said block; and
adjacent pixel setting means configured to, in the event that said adjacent pixels belong within said predetermined block, set a prediction image of said adjacent pixels as said adjacent pixels to be used for prediction.

18. The image processing device according to claim 17, wherein said prediction means prediction by inter screen prediction.

19. The image processing device according to claim 17, wherein, in the event that said adjacent pixels exist outside of said predetermined block, said adjacent pixel setting means set a decoded image of said adjacent pixels as said adjacent pixels to be used for said prediction.

20. The image processing device according to claim 19, wherein, in the event that the position of said block is at the upper left position within said predetermined block, of said adjacent pixels, a decoded image of all of adjacent pixels to the upper left portion, adjacent pixels above, and adjacent pixels to left, which exist outside of said predetermined block, is set as said adjacent pixels to be used for said prediction.

21. The image processing device according to claim 19, wherein, in the event that the position of said block is at the upper right position within said predetermined block, of said adjacent pixels, a decoded image of adjacent pixels to the upper left and adjacent pixels above that exist outside of said predetermined block, is set as said adjacent pixels to be used for said prediction, and of said adjacent pixels, a prediction image of adjacent pixels to the left that belong within said predetermined block, is set as said adjacent pixels to be used for said prediction.

22. The image processing device according to claim 19, wherein, in the event that the position of said block is at the lower left position within said predetermined block, of said adjacent pixels, a decoded image of adjacent pixels to the upper left and adjacent pixels to the left that exist outside of said predetermined block, is set as said adjacent pixels to be used for said prediction, and of said adjacent pixels, a prediction image of adjacent pixels above that belong within said predetermined block, is set as said adjacent pixels to be used for said prediction.

23. The image processing device according to claim 19, wherein, in the event that the position of said block is at the lower right position within said predetermined block, of said adjacent pixels, a prediction image of all of adjacent pixels to the upper left portion, adjacent pixels above, and adjacent pixels to the left portion, which belong within said predetermined block, is set as said adjacent pixels to be used for said prediction.

24. The image processing device according to claim 19, wherein, in said predetermined block configured of two of said blocks above and below, in the event that the position of said block is at the upper position within said predetermined block, of said adjacent pixels, a decoded image of all of adjacent pixels to the upper left portion, adjacent pixels above, and adjacent pixels to left, which exist outside of said predetermined block, is set as said adjacent pixels to be used for said prediction.

25. The image processing device according to claim 19, wherein, in said predetermined block configured of two of said blocks above and below, in the event that the position of said block is at the lower position within said predetermined block, of said adjacent pixels, a decoded image of adjacent pixels to the upper left and adjacent pixels to the left that exist outside of said predetermined block, is set as said adjacent pixels to be used for said prediction, and of said adjacent pixels, a prediction image of adjacent pixels above that belong within said predetermined block, is set as said adjacent pixels to be used for said prediction.

26. The image processing device according to claim 18, wherein, in said predetermined block configured of two of said blocks left and right, in the event that the position of said block is at the left position within said predetermined block, a decoded image of all of adjacent pixels to the upper left portion, adjacent pixels above, and adjacent pixels to left, which exist outside of said predetermined block, is set as said adjacent pixels to be used for said prediction.

27. The image processing device according to claim 19, wherein, in said predetermined block configured of two of said blocks left and right, in the event that the position of said block is at the right position within said predetermined block, of said adjacent pixels, a decoded image of adjacent pixels to the upper left and adjacent pixels above that exist outside of said predetermined block, is set as said adjacent pixels to be used for said prediction, and of said adjacent pixels, a prediction image of adjacent pixels to the left that belong within said predetermined block, is set as said adjacent pixels to be used for said prediction.

28. The image processing device according to claim 17, wherein said prediction means uses said adjacent pixels as a template to perform said prediction regarding said block by matching of said template.

29. The image processing device according to claim 17, wherein said prediction means uses said adjacent pixels as a template to perform said prediction regarding color difference signals of said block as well, by matching of said template.

30. The image processing device according to claim 17, wherein said prediction means uses said adjacent pixels to perform intra prediction as said prediction as to said block.

31. The image processing device according to claim 19, further comprising decoding means configured to decode an image of a block which is encoded;
wherein said decoding means decode an image of a block including a prediction image of said adjacent pixels, while said prediction means perform prediction processing of said predetermined block using a prediction image of said adjacent pixels.

32. An image processing method, comprising the steps of:
an image processing device which performs prediction of
a block, using adjacent pixels adjacent to said block making up a predetermined block of an image, performing processing so as to, in the event that said adjacent pixels exist within of said predetermined block, set a prediction image of said adjacent pixels as said adjacent pixels to be used for said prediction; and
using said adjacent pixels that have been set, to detect pixels with great correlation to said adjacent pixels from decoded pixels, and take an image including pixels adjacent to said pixels that have been detected, as a prediction image of said block.

33. A program for causing a computer of an image processing device which performs prediction of a block, using adjacent pixels adjacent to said block making up a predetermined block of an image, to execute processing comprising the steps of:
setting, in the event that said adjacent pixels exist within of said predetermined block, a prediction image of said adjacent pixels as said adjacent pixels to be used for said prediction; and
using said adjacent pixels that have been set, to detect pixels with great correlation to said adjacent pixels from decoded pixels, and take an image including pixels adjacent to said pixels that have been detected, as a prediction image of said block.
